(19) United States
(12) Patent Application Publication
(10) Pub. No.: US 2011/0066570 A1
(43) Pub. Date: Mar. 17, 2011

(54) METHODS AND SYSTEMS FOR RATIONALIZING A NON-FINANCIAL PORTFOLIO

(76) Inventors: Brian Kolo, Leesburg, VA (US); Aaron Winters, Reston, VA (US)

(21) Appl. No.: 12/560,365

(22) Filed: Sep. 15, 2009

(51) Int. Cl. G06Q 40/00

(52) U.S. Cl. 705/36 R

(57) ABSTRACT

The invention is to system and methods to rationalizing a portfolio.

### BACKGROUND

The present invention relates generally to systems, combinations and methods relating to portfolio rationalization. Portfolio rationalization is the process of analyzing the assets or investments in a portfolio to determine how the investments should be adjusted to better align the portfolio with the strategy of the organization. Rationalization quantifies the business value of each investment in order to create metrics that can be used to compare different investments. The analysis ranks the various assets and identifies opportunities to strengthen the portfolio by adjusting the portfolio components.

Portfolio rationalization was developed in response to a Congressional mandate from the Clinger-Cohen Act of 1996. The Clinger-Cohen Act was enacted to resolve several problems, including waste, fraud and abuse arising from ineffective information systems, outdated approaches to acquiring information technology, inadequate attention to business processes, inadequate planning for new information technology systems, and the like.

Clinger-Cohen requires Federal Executive branch Agencies to use portfolio management to handle their IT investments. Although this act is specifically directed toward IT related investments, Portfolio Rationalization may be effectively used in non-IT environments as well. The Clinger-Cohen Act of 1996 (“Act”) instructs the Director of the Office of Management and Budget (Director) to promote improvements in the use of information technology by the Federal Government. Specifically, this Act is directed toward improvements in the productivity, efficiency, and effectiveness of Federal programs. The Act instructs the Director to develop a process for analyzing, tracking, and evaluating the risks and results of all major capital investments made by an Executive agency of information systems. Thus, the Act requires that this process address the following information technology investment concerns:

Selection—A process for the selection, management, and evaluation of information technology investments.

Integration—A method to integrate the investment decision with budget, financial, and program management decisions.

Criteria—State specific criteria applied when considering whether to undertake a particular information technology investment. The criteria may be expressed quantitatively and address net and risk-adjusted return on investment as well as comparing and prioritizing alternative information technology investments.

Shared Investment Identification—A process for identifying information system investments that may result in benefits if shared between Federal agencies, State, or local governments.

Proposed Investment Benefits—A process for quantifiably measuring the benefits and risks of a proposed investment.

Progress Measurements—A process for senior leaders to obtain pertinent information for an investment, including progress, milestones, cost, capability, timeliness, and quality.

Although Clinger-Cohen was meant to streamline information technology acquisitions and reduce waste, others in the field have been unable to find clear-cut and cost effective ways to implement Clinger-Cohen, especially for non-financial assets.

The management of non-financial portfolios faces different challenges than their financial counterparts. Investments in non-financial portfolios are typically not liquid, have multiple dimensions to their valuation, and rely heavily on performance forecasts rather than real-time performance. Managers of non-financial portfolios do not have the flexibility to quickly remove a poorly performing asset and replace it with a different investment. This lack of liquidity makes it difficult for the Portfolio Manager to quickly react to changing conditions.

Financial portfolios are typically comprised of liquid assets. There are many standard, well known techniques used in financial portfolio management that rely on the liquidity of the assets in making investment selection. Because the techniques assume investment liquidity, they are not as useful when applied to non-financial portfolios.

In addition, the portfolio investments often have a multi-dimensional nature to their valuation. An investment may be measured in terms of its cost or its return-on-investment. But an investment may also bring regulatory or legal compliance, employee satisfaction, or strategic direction. In order to understand non-financial investments, one of skill in the art should incorporate these other value dimensions into our analysis.

It is essential to account for the multi-dimensional nature of the asset. Simply examining an asset against its return will not provide a true understanding of the value of the investment to the organization. There is a need to consider the purpose of the investment in addition to its cost, return, or other financial factors. Furthermore, the investments in non-financial portfolios usually rely on forecasts rather than actual results. Most projects are unique. The exact methodology, purpose, personnel, and technology used for a project are unique and different than all other projects in the organization. This makes it difficult to accurately predict how successful the project will be.

Managers typically rely heavily on forecasts when choosing to begin a new project. These forecasts may be quantitatively detailed, estimating the cost and return for the project, or the forecasts may simply be ‘I think this is a good direction.’ In either case, the selection of the project will rely heavily on forecasts of the benefits the project may bring rather than the actual performance of the project during execution.

These are a few of the common problems faced by managers of non-financial portfolios. These problems lead to questions of how investments should be valued, how investment selection is made, how to compare investments, and how to determine when an investment should be eliminated.

It is therefore desirable to have a formal process for understanding how each of these questions is answered and how to incorporate these answers into a system to manage an investment portfolio. The process should provide a roadmap for the various activities that need to be considered, how they fit together, and what they produce. The inventors are credited with finding novel methods, systems and combinations to implement the directives of the Clinger-Cohen Act.

### SUMMARY

The systems and methods of the illustrative embodiments described herein. In one embodiment, a method of rationalizing a portfolio is provided. The method comprises the steps of generating a valuation model as a result of one or more processes of the valuation phase, generating an investment model as a result of one or more processes of the investment phase; generating a system model as a result of one or more processes of the system phase; and generating a portfolio model as a result of one or more processes of the portfolio phase. Further, this embodiment includes using the valuation model, investment model, system model, rationalization model and portfolio model are used to produce a transformation plan report.

The valuation model may comprise one or more processes from the following process groups: Data Analysis, Category Analysis, Valuation Model Analysis, Valuation Risk Analysis and Mapping Analysis.

The investment model may comprise one or more processes from the following process groups: Investment Risk Analysis, Impact Analysis, Capability analysis, Maturity analysis and Model analysis.

The system model may comprise one or more processes from the following process groups: System Cost Analysis; System model analysis; System risk analysis and System return analysis.

The portfolio model may comprise one or more processes from the following process groups: Compliance analysis; Portfolio risk analysis; Cost analysis; Return analysis; and Portfolio model analysis.

The rationalization model may comprise one or more processes from the following process groups: Obsolescence Analysis; Redundancy Analysis; Merger Analysis; Reuse Analysis; Gap Analysis; Division Analysis; and Rationalization Model Analysis.

Other objects, features, and advantages of the illustrative embodiments will become apparent with reference to the drawings and detailed description that follow.

### BRIEF DESCRIPTION OF THE DRAWINGS

FIG. 1 is an illustration of the portfolio rationalization four phases demonstrating how the valuation, system and investment phases interact with the portfolio phase.

FIG. 2 is a chart illustrating the asset data point information in accordance with some embodiments.

FIG. 3 is a chart illustrating multi-valued asset information for each point.

FIG. 4 is a chart illustrating contour lines representing regions of similar prioritization values.

FIG. 5 shows the Portfolio Snapshot process inputs, outputs, and tools & techniques.

FIG. 6 shows the Category Definition process inputs, outputs, and tools & techniques.

FIG. 7 shows the Business Value Definition process inputs, outputs, and tools & techniques.

FIG. 8 is an illustration of the Valuation Model.

FIG. 9 shows the Category Valuation process inputs, outputs, and tools & techniques.

FIG. 10 shows the Investment Valuation process inputs, outputs, and tools & techniques.

FIG. 11 is an illustration of Investment Model.

FIG. 12 shows the Cluster Modeling process inputs, outputs, and tools & techniques.

FIG. 13 shows the Prioritization process inputs, outputs, and tools & techniques.

FIG. 14 shows the System Selection process inputs, outputs, and tools & techniques.

FIG. 15 shows the System Evaluation process inputs, outputs, and tools & techniques.

FIG. 16 is an example of a chart that represents assets as belonging to best practices or rationalization targets.

FIG. 17 is an illustration of a System Model.

FIG. 18 shows the Portfolio Value Definition process inputs, outputs, and tools & techniques.

FIG. 19 shows the Portfolio Valuation process inputs, outputs, and tools & techniques.

FIG. 20 shows the Strategic Alignment process inputs, outputs, and tools & techniques.

FIG. 21 shows the Strategic Direction process inputs, outputs, and tools & techniques.

FIG. 22 shows the Rationalization Selection process inputs, outputs, and tools & techniques.

FIG. 23 shows the Best Practices Identification process inputs, outputs, and tools & techniques.

FIG. 24 is an example of a chart that shows rationalization targets and best practices in a quad chart standard form.

FIG. 25 shows the Transformation process inputs, outputs, and tools & techniques.

FIG. 26 is an illustration of a Portfolio Model.

FIG. 27a-d is a diagram of the flow of process inputs and outputs, where inputs and outputs are displayed as hexagons and processes are shown as squares.

FIG. 27a is a diagram of the process flow for the Valuation Phase. Inputs and outputs are displayed as hexagons and processes are shown as squares.

FIG. 27b is a diagram of the process flow for the Investment Phase. Inputs and outputs are displayed as hexagons and processes are shown as squares.

FIG. 27c is a diagram of the process flow for the System Phase. Inputs and outputs are displayed as hexagons and processes are shown as squares.

FIG. 27d is a diagram of the process flow for the Portfolio Phase. Inputs and outputs are displayed as hexagons and processes are shown as squares.

FIG. 28 is a diagram of the portfolio rationalization process dependencies.

FIG. 29 is an illustration of the Investment Model.

FIG. 30 is an illustration of the processes involved in the Investment Model.

FIG. 31 shows the Data Quality Analysis inputs, outputs, and tools & techniques.

FIG. 32 shows the Data Consistency Analysis inputs, outputs, and tools & techniques.

FIG. 33 shows the Data Stability Analysis inputs, outputs, and tools & techniques.

FIG. 34 shows the Data Coverage Analysis inputs, outputs, and tools & techniques.

FIG. 35 shows the Data Cleansing inputs, outputs, and tools & techniques.

FIG. 36 shows the Benefit Risk inputs, outputs and tools & techniques.

FIG. 37 shows the Cost Risk inputs, outputs and tools & techniques.

FIG. 38 shows the Action Impact inputs, outputs and tools & techniques.

FIG. 39 shows the Inaction Impact, outputs and tools & techniques.

FIG. 40 shows the Technical Capability inputs, outputs and tools & techniques.

FIG. 41 shows the Feasibility inputs, outputs and tools & techniques.

FIG. 42 shows the Current Maturity impact, outputs and tools & techniques.

FIG. 43 shows the Future Maturity inputs, outputs and tools & techniques.

FIG. 44 shows the Investment Regression Analysis inputs, outputs and tools & techniques.

FIG. 45 shows the Investment Variation Analysis inputs, outputs and tools & techniques.

FIG. 46 shows the Investment Model Definition inputs, outputs and tools & techniques.

FIG. 47 is an illustration of the Portfolio Model.

FIG. 48 is an illustration of the processes that support the Portfolio Model.

FIG. 49 shows the Performance Compliance impact, outputs and tools & techniques.

FIG. 50 shows the Governance inputs, outputs and tools & techniques.

FIG. 51 shows the Regulatory Compliance inputs, outputs and tools & techniques.

FIG. 52 shows the Portfolio Risk inputs, outputs and tools & techniques.

FIG. 53 shows the Portfolio Sensitivity inputs, outputs and tools & techniques.

FIG. 54 shows the Portfolio Present Cost inputs, outputs and tools & techniques.

FIG. 55 shows the Portfolio Future Cost inputs, outputs and tools & techniques.

FIG. 56 shows the Portfolio Benefits inputs, outputs and tools & techniques.

FIG. 57 shows the Portfolio Expense Avoidance inputs, outputs and tools & techniques.

FIG. 58 shows the Projected Portfolio Return inputs, outputs and tools & techniques.

FIG. 59 shows the Portfolio Regression Analysis inputs, outputs and tools & techniques.

FIG. 60 shows the Portfolio Variation Analysis inputs, outputs and tools & techniques.

FIG. 61 shows the Portfolio Valuation Analysis inputs, outputs and tools & techniques.

FIG. 62 shows the Portfolio Model Definition inputs, outputs and tools & techniques.

FIG. 63 is an illustration of the Rationalization Model.

FIG. 64 is an illustration of the processes supporting the Rationalization Model.

FIG. 65 is an diagram of the Rationalization Maturity Model with general guidelines to the main items of each level.

FIG. 66 shows the Investment Obsolescence inputs, outputs and tools & techniques.

FIG. 67 shows the Resource Obsolescence inputs, outputs and tools & techniques.

FIG. 68 shows the Investment Reuse inputs, outputs and tools & techniques.

FIG. 69 shows the Resource Reuse inputs, outputs and tools & techniques.

FIG. 70 shows the Investment Redundancy inputs, outputs and tools & techniques.

FIG. 71 shows the Resource Redundancy inputs, outputs and tools & techniques.

FIG. 72 shows the Investment Gap inputs, outputs and tools & techniques.

FIG. 73 shows the Resource Gap inputs, outputs and tools & techniques.

FIG. 74 shows the Investment Merger inputs, outputs and tools & techniques.

FIG. 75 shows the Resource Merger inputs, outputs and tools & techniques.

FIG. 76 shows the Investment Division inputs, outputs and tools & techniques.

FIG. 77 shows the Resource Division inputs, outputs and tools & techniques.

FIG. 78 shows the Requirements Analysis inputs, outputs and tools & techniques.

FIG. 79 shows the Architecture Analysis inputs, outputs and tools & techniques.

FIG. 80 shows the Performance Analysis inputs, outputs and tools & techniques.

FIG. 81 shows the Compliance Analysis inputs, outputs and tools & techniques.

FIG. 82 shows the Capability Analysis inputs, outputs and tools & techniques.

FIG. 83 shows the Rationalization model Definition inputs, outputs and tools & techniques.

FIG. 84 is a diagram of the levels in the Rationalization Maturity Model.

FIG. 85 shows the Identify Strategy & Vision inputs, outputs and tools & techniques.

FIG. 86 shows the Identify Statutes and Regulations inputs, outputs and tools & techniques.

FIG. 87 shows the Assess Organizational Needs inputs, outputs and tools & techniques.

FIG. 88 shows the Program Approval inputs, outputs and tools & techniques.

FIG. 89 shows the Identify Portfolio Investments inputs, outputs and tools & techniques.

FIG. 90 shows the Formulate Performance Expectations inputs, outputs and tools & techniques.

FIG. 91 shows the Asset Information Procedure inputs, outputs and tools & techniques.

FIG. 92 shows the Tailor the Process inputs, outputs and tools & techniques.

FIG. 93 shows the Gather Asset Information inputs, outputs and tools & techniques.

FIG. 94 shows the Monitor & Control inputs, outputs and tools & techniques.

FIG. 95 shows the Category Identification inputs, outputs and tools & techniques.

FIG. 96 shows the Category Coverage inputs, outputs and tools & techniques.

FIG. 97 shows the Dilation Mappings inputs, outputs and tools & techniques.

FIG. 98 shows the Linear Mappings inputs, outputs and tools & techniques.

FIG. 99 shows the Nonlinear Mappings inputs, outputs and tools & techniques.

FIG. 100 shows the Category Risk inputs, outputs and tools & techniques.

FIG. 101 shows the Mapping Risk inputs, outputs and tools & techniques.

FIG. 102 shows the Category Data Requirements inputs, outputs and tools & techniques.

FIG. 103 shows the Valuation Model Definition inputs, outputs and tools & techniques.

FIG. 104 shows the System Present Cost inputs, outputs and tools & techniques.

FIG. 105 shows the System Future Cost inputs, outputs and tools & techniques.

FIG. 106 shows the System Risk inputs, outputs and tools & techniques.

FIG. 107 shows the System Sensitivity inputs, outputs and tools & techniques.

FIG. 108 shows the System Benefits inputs, outputs and tools & techniques.

FIG. 109 shows the System Expense Avoidance inputs, outputs and tools & techniques.

FIG. 110 shows the Projected System Returns inputs, outputs and tools & techniques.

FIG. 111 shows the System Regression Analysis inputs, outputs and tools & techniques.

FIG. 112 shows the System Variation Analysis inputs, outputs and tools & techniques.

FIG. 113 shows the System Valuation Analysis inputs, outputs and tools & techniques.

FIG. 114 shows the System Model Definition inputs, outputs and tools & techniques.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

The invention generally is to methods and systems for portfolio rationalization. Fundamentally, portfolio rationalization is the process of eliminating wasteful spending by analyzing the investment properties and restructuring the portfolio to better align with the organizational strategy. The portfolio rationalization process described here details individual processes that may be used to perform portfolio rationalization.

To better clarify the invention, the following definitions are provided:

Portfolio Rationalization is a multistep method, and systems that perform the method, used to examine a group of investments. Generally, the first step of portfolio rationalization is defining a business value that allows comparison of investments. The business value is then used to determine the performance of the investments as well as the portfolio. In addition, the requirements of the investments are analyzed to identify how each investment fits into the portfolio and aligns with the organizational strategy. Business value and requirements analysis are used to determine how the portfolio may be restructured to achieve better performance. Portfolio rationalization system and methods can be used tailored to an individual organization's portfolio. In some embodiments, the portfolio rationalization comprises financial portfolios. In other embodiments, the portfolio rationalization comprises non-financial portfolios.

Action Impact—The Action Impact attempts to quantify how a specific investment action may affect the investment value, portfolio value, investment uncertainty, and portfolio uncertainty.

Action Impact Document—Documents how a specific investment action may affect the investment value, portfolio value, investment uncertainty, and portfolio uncertainty

Alignment Models—Mathematical model used to measure and evaluate the alignment of an investment or group of investments with the Strategic Alignment of the organization.

Architecture Analysis—Specific to IT portfolios, this process reviews the structure and design of software, databases, networks, and deployment in IT systems.

Architecture Rules—Rationalization rules based on the IT architecture of systems.

Army Information Technology Portfolio Management Guidance—Additional guidance for interpretation of the DODI 8115.02 instruction as issued by the Army.

Assess Organizational Needs—Uses the Business Strategy, Business Vision, Statutes & Regulations, and Legal Opinions to create a business case for implementing Portfolio Rationalization.

Asset—See Investment.

Asset Category Coverage—Computes the coverage for both the Investment and Relational Categories.

Asset Category Data—Detailed data for an investment specifying the values for the Investment Categories and Relational Categories for a particular investment.

Asset Information—Asset Information is a collection of data specifying details about a particular investment.

Asset Information Procedure—The Asset Information Procedure process specifies how Asset Information and System Requirements are identified.

Asset Information Process—The process for obtaining asset information.

Autoconvolution—Convolution of a function with itself.

Autocorrelation Function—Correlation of a sequence with itself as a function of varying time intervals.

Backpropagation—Backward propagation of the output result through the layers of an artificial neural network.

Benefit Risk—The Benefit Risk is a measure of uncertainty of the value of the benefit of the investment.

Benefit Risk Document—Document detailing the uncertainty in the value of the benefit of the investment.

Best Practice Identification—Identifies investments that are performing well and determines the reasons for their good performance.

Best Practices—Practices that are recognized by the industry or organization as effective.

Best-fit—The optimal fitting in regression where the distance is a minimum.

Business Strategy—Document specifying the organization's mission, vision, and objectives and direction for achieving the objectives.

Business Value—A defined quantifiable, comparable metric unit and measure assigning value an investment brings to an organization.

Business Value Definition—Process specifies the Mathematical Models and Numerical Methods that will be used to quantify the business value of an asset and the associated uncertainty.

Business Vision—Document specifying the core values, purpose, and goals of the organization.

Capability Analysis—Examines the capabilities of the portfolio investments and identifies potential rules to identify rationalization targets based on investment capabilities.

Capability Rules—Rationalization rules based on the system capabilities.

Category—A defined characteristic that can be identified with all investments within a portfolio.

Category Analysis—Category Analysis analyzes the available raw data and determines which categories are suitable for used in computing business value.

Category Coverage—Category Coverage determines how many investments have information available for a given Relational Category.

Category Data Requirements—Minimal quality requirements that must be met in order to consider an Investment or Relational Category as having sufficient quality for consideration.

Category Definition—Process of identifying the high-level investment categories. Investments are grouped by category and a particular investment may be placed in more than one category.

Category Identification—Category Identification examines the list of all available categories, determines how the categories relate, normalizes the information, and compiles the information together into a list of Relational Categories.

Category Quality Standard—Document specifying the quality standard for the Relational Categories.

Category Risk—Computes the uncertainty in the Investment Category values due to uncertainties in the raw data.

Category Risk Assessment—Specifies the uncertainty associated with each Investment Category.

Category Valuation—Categorization Valuation is the process of determining the value of each category for every investment.

Change Recommendations—Recommendations for modifying a portfolio of investments.

Clinger-Cohen Act of 1996—A Congressional mandate instructing the Director of the Office of Management and Budget to promote improvements in the use of information technology by the Federal Government.

Cluster—A grouping of investments based on a similar identified characteristic.

Cluster Modeling—Cluster modeling groups investments together using their category values or other characteristics that may be used to group the investments.

Compliance Analysis—Compliance Analysis examines how well the portfolio is conforming to expectations.

Compliance Rules—Rationalization rules based on the system compliance.

Computational Intelligence—Intelligent computer systems designed to learn and evolve over time specifically designed to adapt to new situations or information.

Conditional Expectation—Expectation of a result given conditional information.

Conditional Probability—Probability of a result occurring given conditional information.

Conditional Probability Density—Probability density given conditional information.

Corrective Actions—Actions under consideration to correct an identified issue.

Cost Analysis—Examines the present and anticipated cost of the portfolio investments.

Cost Risk—The Cost Risk is a measure of uncertainty of the value of the cost of the investment.

Cost Risk Document—Document detailing the uncertainty in the value of the cost of the investment.

Current Maturity—The Current Maturity measured the current maturity state of the asset and incorporates this information into the Investment Model.

Current Maturity Document—Document describing the current level of maturity for an investment.

Data Analysis—The Data Analysis category is concerned with measuring the quality of the data used to create the Portfolio Snapshot.

Data Analysis—Data Analysis is the process of gathering, modifying, transforming, and/or modeling data in order to better understand the data information.

Data Cleansing—Identifies and corrects faulty data from the Portfolio Snapshot

Data Consistency Analysis—Data Consistency Analysis compared two simultaneous measurements of the same data field.

Data Consistency Document—Details the results of the Data Consistency Analysis.

Data Coverage—Data Coverage is the ratio of the number of instances where a data field contains useful information to the total number of instances of the data field.

Data Coverage Analysis—Data Coverage Analysis measures the percent of investments that have useful information for a specific data field.

Data Coverage Document—Specifies the data coverage for the fields of interest.

Data Manager—Data Managers are responsible for the acquisition, maintenance, storage, and retrieval of investment information.

Data Quality Analysis—The Data Quality Analysis subarea is a quantitative quality control process with respect to the Portfolio Snapshot.

Data Quality Document—Documents the data quality for the investment data.

Data Quality Standard—The specific standard expected for data quality for a particular set of data.

Data Repositories—Data Repositories are collections of investment data such as databases, data warehouses, or project archives.

Data Stability Analysis—Data Stability Analysis compares successive Portfolio Snapshots taken over time to estimate the extent and variance of the data.

Data Stability Document—Documents how the values of the data fields change over time.

Dilation Mappings—Identifies Relational Category Mappings that are simple scaling and translations of the Investment Categories.

Dimension—The physical or logical character of a measurement.

Division Analysis—Analyzes investment requirements, purpose, and function to identify investments that may benefit from dividing them into smaller investments.

DODI 8115.02—Provides interpretation of the OMB Circular A-130 for information technology portfolio management as issued by the Department of Defense.

Error Propagation—Error analysis technique used to determine the error in a function given the errors in the variables of the function.

Executive—Executives are organizational leaders responsible for the strategic direction of the organization as well as approving project and programs.

Expense Avoidance (Process)—Identifies potential cost savings from the portfolio investments. These coast savings may be viewed as a return on the investment.

Expense Avoidance (Document)—Determines the value of the savings to the portfolio by avoiding some expense.

Feasibility—Feasibility examines the future capability of the investment.

Feasibility Document—Documents the future capabilities of the investments.

Feedback Information—One process feeds another process.

Feed-forward Information—One process feeds a subsequent process.

Field Investigations—Field Investigations are onsite inspection of individual investments such as a facilities tour.

Financial Portfolio—Investments in stocks, bonds, mutual funds, or other securities.

Fitness—A computed value that reflects the overall asset performance based on all quantifiable valuation factors for an investment.

Fitness Models—Numerical or mathematical models used to measure an investment's fitness according to a set of pre-defined criteria.

Formulate Performance Expectations—Determines and documents the performance expectations for the portfolio.

Gap Analysis—Analyzes investment requirements, purpose, and function to identify gaps.

Gather Asset Information—The Gather Asset Information implements all or part of the Asset Information Procedure to obtain a specific set of data.

Governance—Measures how the portfolio has performed as compared to the governance expectations of the organization.

Governance Document—Describes the compliance of the portfolio with the organizational governance procedures.

Identify Portfolio Investments—Specifies the particular investments for a portfolio.

Identify Statutes and Regulations—Identify Statutes and Regulations determines how the portfolio is affected by Federal, State, and Local laws.

Identify Strategy & Vision—Identify Strategy & Vision identifies the Business Strategy and Business Vision documentation.

Impact Analysis—Impact Analysis attempts to quantify the impact the investment has on the overall portfolio, and what impact changes to the investment may have.

Inaction Impact—The Inaction Action Impact attempts to quantify how inaction may affect the investment value, portfolio value, investment uncertainty, and portfolio uncertainty.

Inaction Impact Document—Documents how a specific investment inaction may affect the investment value, portfolio value, investment uncertainty, and portfolio uncertainty.

Interviews—Interviews are discussions with investment owners used to collect data for a particular investment.

Investment—An investment is a project, program, portfolio, system or other intangible asset present in a non-financial portfolio. Investments are also called Assets or Systems. IT Systems are considered Investments.

Investment Categories—Investment Categories are data fields or combinations of data fields that are used to identify the characteristics of an investment.

Investment Clusters—Investment Clusters are groupings of investments with similar values.

Investment Division—Reviews requirements, purpose, and functionality of the investments to identify projects, programs, processes, services, products, vendors, or contracts that may be divided over multiple investments.

Investment Division Rules—Rationalization rules based on opportunities for investment division.

Investment Gap—Reviews requirements, purpose, and functionality of the investments to identify projects, programs, processes, services, products, vendors, or contracts that may have gaps.

Investment Gap Rules—Rationalization rules based on requirements gaps.

Investment Merger—Reviews requirements, purpose, and functionality of the investments to identify projects, programs, processes, services, products, vendors, or contracts that may be merged.

Investment Merger Rules—Rationalization rules based on opportunities for investment merger.

Investment Model—The Investment model is a mathematical model used to compute the business value(s) for the investments.

Investment Model Analysis—Investment Model Analysis identifies potential investment models and selects the particular Investment Model used to compute Business Value.

Investment Model Definition—Investment Model Definition is the determination and specification of a particular model or models to assess the Business Value of an Investment based on the data available.

Investment Obsolescence—Reviews requirements, purpose, and functionality of the investments to identify projects, programs, processes, services, products, vendors, or contracts that may be obsolete.

Investment Obsolescence Rules—Rationalization rules based on identification of obsolete investments.

Investment Owner—An Investment Owner is a person, such as a project manager, who is responsible for an investment.

Investment Phase—The Investment Phase categorizes the Investments and assigns Business Value(s) to each Investment.

Investment Redundancy—Reviews requirements, purpose, and functionality of the investments to identify projects, programs, processes, services, products, vendors, or contracts that may be redundant.

Investment Redundancy Rules—Rationalization rules based on identification of redundant investments.

Investment Regression Analysis—Regression Analysis is a common technique used to analyze multi-dimensional data sets. Regression Analysis can readily incorporate both values and uncertainties.

Investment Regression Document—Details the results of the regression analysis for an investment.

Investment Requirements—Specifies the requirements, purpose, and functionality of an investment.

Investment Reuse—Reviews requirements, purpose, and functionality of the investments to identify projects, programs, processes, services, products, vendors, or contracts that may be reused.

Investment Reuse Rules—Rationalization rules based on opportunities for reuse.

Investment Risk Analysis—Evaluates risks related to the investments specifically for benefits and costs.

Investment Valuation—Investment Valuation is the process of computing the overall business value(s) for each investment.

Investment Values—The values assigned to the investments by applying the Investment Model to the Asset Category Data.

Investment Variation Analysis—Variation Analysis is used to compute the uncertainty of the Investment Value.

Investment Variation Document—Computes the uncertainty in the value of an investment.

Investments for Rationalization—A list of investments identified as targets for rationalization.

IR Category Maps—Maps that associate which raw categories (from the Investment Categories list) to Relational Categories.

Issue Identification—Identification of issues relating to investments in a portfolio.

Least-Squares—Technique for fitting a curve to a set of measured data.

Legacy—An outdated or obsolete investment.

Legal Expert—Lawyers and other legal staff that provide legal opinions.

Legal Opinion—A written opinion from a lawyer or qualified legal professional detailing the application of law to a specific situation.

Legal Research—Research on statutes, regulations, cases, and opinions.

Linear Mappings—Identifies Relational Category Mappings that are linear combinations of Investment Categories.

Linear Regression—A common regression technique to fit measured data to a straight line.

Mapping Risk—Computes the uncertainty in the Relational Category value arising from the mapping between the Investment Categories and the Relational Category.

Mapping Risk Assessment—Computes the uncertainty in the Relational Category based on the IR Category Map.

Mappings Analysis—Examines potential mappings between Relational Categories to formulate business value.

Mathematical Models—Mathematical Models are models of a system or investment based in one or more mathematical expressions.

Maturity Analysis—Maturity Analysis quantifies an investments level of maturity.

Measured Value—A particular observation of a value at some instant in time.

Merger Analysis—Analyzes investment requirements, purpose, and function to identify investments that may be merged.

Monitor & Control—Functions as process improvement, quality control, and quality assurance for the Portfolio Rationalization process.

Monte Carlo Simulation—Computerized simulation of events where the simulation is run multiple times using random variables to generate various initial conditions.

Non-Financial Portfolio—Investments in projects, programs, equipment, or other intangible assets.

Nonlinear Mappings—Identifies Relational Category Mappings that are nonlinear in the Investment Category(ies).

Normal Distribution—Used to describe data that is clustered about an average.

Numerical Methods—Numerical Methods are the application of computers to estimate the value or risk for an investment.

Obsolescence Analysis—Analyzes investment requirements, purpose, and function to identify obsolete investments.

OMB Circular A-130—Implements the requirements of the Clinger-Cohen Act of 1996 by providing a specific policy for implementation by the heads of Government agencies as issued by the Director of the Office of Management and Budget.

Passed Relational Categories—Relational Categories that are found to meet the Category Quality Standard requirements.

Performance Analysis—Examines the contribution of each investment to the overall performance of the portfolio.

Performance Compliance (Process)—Measures how the portfolio has performed as compared to prior expectations.

Performance Compliance (Document)—Measures how the portfolio has performed with respect to an expected or projected value.

Performance Expectations—Objective measures of future portfolio performance.

Performance Models—Mathematical models used to measure the performance of a portfolio.

Performance Rules—Rationalization rules based on portfolio performance.

Portfolio—A collection of investments grouped together to achieve a collective purpose.

Portfolio Benefits (Process)—Examines the benefits that each investment brings to the portfolio.

Portfolio Benefits (Document)—Document examining the benefits that each investment brings to the portfolio.

Portfolio Future Cost—Estimates the present value of the future cost of the investments.

Portfolio Future Cost Analysis—Determines the expected future cost of the investments.

Portfolio Future Maturity—The Future Maturity measured the future maturity state of the asset and incorporates this information into the Investment Model.

Portfolio Future Maturity Document—Estimates the future maturity level of an investment.

Portfolio Governance—Executive rules and regulations for a portfolio.

Portfolio Manager—Person responsible for the overall management of the portfolio.

Portfolio Model—A mathematical model used to measure and evaluate the performance of a portfolio including both portfolio valuation and portfolio variation.

Portfolio Model Analysis—Identifies the Portfolio Model used to measure the performance model for the overall portfolio.

Portfolio Model Definition—Identifies the set of values used to quantify portfolio performance.

Portfolio Performance—A measure of the performance of a portfolio relative to objective criteria.

Portfolio Phase—The Portfolio Phase determines the Portfolio and Rationalization Models, and identifies Best Practices and Rationalization Targets.

Portfolio Present Cost—Reviews the present and past cost of the investments.

Portfolio Present Cost Analysis—Determines the present and past cost of the investments.

Portfolio Rationalization—The process of analyzing the assets or investments in a portfolio to determine how the investments should be adjusted to better align the portfolio with the strategy of the organization.

Portfolio Rationalization Business Case—Business case submitted to executive management specifying the recommendation to implement or not implement a portfolio rationalization process.

Portfolio Rationalization Charter—Formal approval to begin a portfolio rationalization process.

Portfolio Rationalization Lifecycle—A continuous, ongoing operation, not a linear procedure used to implement the Portfolio Rationalization process.

Portfolio Rationalization Process—A specific process tailored to the needs of an organization that implements portfolio rationalization.

Portfolio Regression Analysis (Process)—Examines the portfolio investment data and creates one or more models to extrapolate the data characteristics.

Portfolio Regression Analysis (Document)—Results of regression analysis applied to the portfolio.

Portfolio Requirements Rules—Rationalization rules based on the requirements, purpose and functionality of the investments in the portfolio.

Portfolio Risk (Process)—Quantifies the uncertainties in the portfolio values.

Portfolio Risk (Document)—Documents the uncertainties and sensitivities of the portfolio values.

Portfolio Risk Analysis—Examines the uncertainties and sensitivities for the portfolio values.

Portfolio Sensitivity—Examines how sensitive the values and predictions are with respect to perturbations in their values.

Portfolio Snapshot (Process)—Process of constructing a portfolio snapshot from investment data taken at a particular instant.

Portfolio Snapshot (Document)—The portfolio snapshot is a collection of investment data taken at a particular instant.

Portfolio Valuation (Process)—Implements the Portfolio Model and quantifies the performance and uncertainty of the portfolio.

Portfolio Valuation (Document)—The value(s) and risk(s) associated with a portfolio of investments.

Portfolio Valuation Analysis—Examines the regression models and variations to identify potential values that may be used to measure portfolio performance.

Portfolio Value—A defined quantifiable metric unit that helps to measure the overall performance of a portfolio.

Portfolio Value Definition—Determines the Portfolio Model used to measure the performance and uncertainty of the portfolio.

Portfolio Variation—Examines sensitivity concerns of the models produced from the Portfolio Regression Analysis.

Portfolio Variation Analysis—Examines how sensitive the regression models are to perturbations in the investment values.

Prioritization—Prioritization is the process of rank ordering the current portfolio assets according to their overall performance, and rank ordering potential new investments.

Prioritized Investments—List of investments in rank order.

Process Performance—Observations of the performance of a particular portfolio rationalization process.

Process Updates—Modifications to a portfolio rationalization process.

Program Approval—Formal approval of the implementation of Portfolio Rationalization.

Projected Portfolio Returns—Estimates the present value of potential future returns for the portfolio investments.

Projected Returns Analysis—Estimates the present value of potential future returns for the portfolio investments.

Projected System Returns (Process)—Estimates the expected future returns for the system of investments.

Projected System Returns (Document)—Document estimating the expected future returns for the system.

Quad Charts—Quad Charts are two-dimensional graphs divided into four regions. Typically, the regions designate areas of good performance, bad performance, and mixed performance.

Questionnaires—Questionnaires are written questions submitted to investment owners to obtain information about an investment.

Rationalization Manager—Person responsible for the management of the rationalization process.

Rationalization Model—Set of rules used to determine which investments will be rationalized.

Rationalization Model Analysis—Identifies a model used to select particular investments for rationalization.

Rationalization Model Definition—Formalizes the rules from Requirements Analysis, Architecture Analysis, Performance Analysis, Compliance Analysis, and Capability Analysis to create a comprehensive set of rules used to identify rationalization targets.

Rationalization Selection—Identifies specific investments targeted for rationalization.

Rationalization Target—Identified investments that, when analyzed individually or according to their clusters, appear to be likely candidates for rationalization.

Redundancy Analysis—Analyzes investment requirements, purpose, and function to identify redundant investments.

Regression—A technique used for fitting a set of measured data to a curve.

Regulatory Compliance—Measures how the portfolio has performed as compared to Federal, State, and Local regulations.

Regulatory Compliance—Evaluates how well the portfolio has complied with specific statutes and regulations.

Relational Categories—Categories based on Investment Categories that combine, dissect, or parse Investment Category information to create new Categories.

Requirements Analysis (Process)—Reviews and compiles the requirements, purpose, and functionality of the portfolio investments.

Requirements Analysis (Document)—Reviewing, understanding, and documenting the requirements for a system.

Requirements Gathering—Eliciting system requirements using interviews, questionnaires, field investigations, user observation, or other information gathering techniques.

Requirements Matrices—Matrices specifying individual requirements on the rows (columns) and systems on the columns (rows) with an indication of which systems implement which requirements.

Resource Division—Reviews requirements, purpose, and functionality of resources to identify personnel, equipment, infrastructure, facilities, or licenses that may be used on multiple investments.

Resource Division Rules—Rationalization rules based on opportunities for resource division.

Resource Gap—Reviews requirements, purpose, and functionality of resources to identify personnel, equipment, infrastructure, facilities, or licenses that may have gaps.

Resource Gap Rules—Rationalization rules based on gaps in resources.

Resource Merger—Reviews requirements, purpose, and functionality of resources to identify personnel, equipment, infrastructure, facilities, or licenses that may be placed together on an investment.

Resource Merger Rules—Rationalization rules based on opportunities for resource consolidation.

Resource Obsolescence—Reviews requirements, purpose, and functionality of resources to identify personnel, equipment, infrastructure, facilities, or licenses that may be obsolete.

Resource Obsolescence Rules—Rationalization rules based on identification of obsolete resources.

Resource Redundancy—Reviews requirements, purpose, and functionality of resources to identify personnel, equipment, infrastructure, facilities, or licenses that may be redundant.

Resource Redundancy Rules—Rationalization rules based on identification of redundant resources.

Resource Requirements—Requirements related to personnel, equipment, infrastructure, licenses, facilities, or other resources.

Resource Reuse—Reviews requirements, purpose, and functionality of resources to identify personnel, equipment, infrastructure, facilities, or licenses that may be reused.

Resource Reuse Rules—Rationalization rules based on opportunities for resource reuse.

Return—The return, either financial or non-financial, an investment offers to an organization.

Return Analysis—Examines the potential returns that the portfolio may receive from the investments.

Reuse Analysis—Analyzes investment requirements, purpose, and function to identify reusable investments.

Risk—A measure of uncertainty in a value such as probability, vulnerability, and impact. Risk is a numerical value, not a conceptual statement of potential issues.

Risk Analysis—Risk Analysis is the process of identifying and quantifying factors, both positive and negative, which may influence the value of an investment or portfolio.

Risk Models—Mathematical models used to measure the uncertainty in the valuation of an investment or portfolio.

RMM Level 0—No Portfolio Rationalization.

RMM Level 1—Portfolio Rationalization accomplished via manual operations.

RMM Level 2—Portfolio Rationalization is accomplished using some automated mechanisms.

RMM Level 3—Portfolio Rationalization uses the information collected from automated processes to affect a formal rationalization process.

RMM Level 4—Portfolio Rationalization uses external information to determine how well predictions correspond to actual results.

RMM Level 5—Portfolio Rationalization uses predictive analysis based on actual results to make rationalization recommendations.

ROI—Return on Investment.

Selected Systems—Systems selected for detailed evaluation.

Sensitivity—Analyzes how sensitive the portfolio values are with respect to perturbations in their values.

Stakeholder—Person who has a vested interest and is affected by the outcome of a system's status.

Statistical Techniques—Techniques such as error propagation and stochastic analysis that rely heavily on statistics.

Status Reports—Status Reports are reports detailing the current status of a project or program.

Statutes and Regulations—Laws applicable to the portfolio rationalization process.

Stochastic Process—A process that incorporates a random element.

Strategic Alignment (Process)—The Strategic Alignment process analyzes the portfolio investments to identify areas that are aligned with the Business Vision and areas that are not.

Strategic Alignments (Document)—A measure of an investment or group of investments in relation to the Business Strategy.

Strategic Direction—The Strategic Direction process reviews the cluster model, investment prioritization, and investments selected for rationalization to evaluate which investments are performing well and identify problem assets.

Strategic Recommendations—Recommendations to better align investments in a portfolio with the Business Strategy or Business Vision.

Strategic Value—See Business Value.

System—See Investment.

System Benefits (Process)—Reviews the benefits that each investment brings to the overall system.

System Benefits (Document)—The value of the system over and above the sum of the constituent investments.

System Cost Analysis—Analyzes the present and anticipated future costs of the investments. The costs are used to quantify the return during System Return Analysis.

System Diagrams—A diagram for a collection of systems showing how the systems influence each other.

System Evaluation—Examines the investments selected from the System Selection process and details the investment requirements, purpose, and functionality.

System Evaluations—Detailed evaluations of particular systems or investments.

System Expense Avoidance (Process)—Quantifies the savings the investments bring to the system.

System Expense Avoidance (Document)—Document detailing cost savings arising from the system investments.

System Expert—System Experts are individuals who are familiar with the technical details of a system and can provide information as subject matter experts.

System Future Cost (Process)—Computes the present value of anticipated future costs of an investment.

System Future Cost (Document)—Document providing the present value of anticipated future costs of an investment.

System Model—Mathematical model used to compute the value of a system. The system here is a collection of investments, not a simple IT system.

System Model Analysis—Combines the System Cost Analysis, System Risk Analysis, and System Return Analysis to formulate the System Model.

System Model Definition—Reviews the mathematical models from System Valuation to determine the overall models used to compute the system values.

System Phase—The System Phase examines groups of investments and identifies Business Value that a group of investments has above or below the Business Value of the constituent investments. The collection of investments for a system should be more that a simple IT system: an typical IT system is considered an ordinary investment.

System Present Cost (Process)—Examines the current and prior cost of the investments in a system.

System Present Cost (Document)—Document examining the current and prior cost of the investments in a system.

System Regression Analysis (Process)—Process using statistical techniques to create models from data in a scatter-plot format.

System Regression Analysis (Document)—Document detailing the results of the regression analysis.

System Requirements—Raw requirements specifying the technical details for a system.

System Return Analysis—Examines the potential returns that the system may incur.

System Risk—Document specifying the uncertainty in the value of a system.

System Risk Analysis (Process)—Quantifies the uncertainties in the system values.

System Risk Analysis (Document)—Process quantifying the uncertainties in the System Values.

System Selection—The Selection process determines a list of investments The Selection process determines a list of investments for deeper investigation based on the rankings from Prioritization Rationalization.

System Selection Criteria—Criteria used to selected systems from the rank ordered prioritization list(s).

System Sensitivity (Process)—Examines how sensitive the system values are with respect to perturbations in the underlying investment values.

System Sensitivity (Document)—Document examining the predicted performance of the system based on perturbations in the underlying investments.

System Valuation Analysis (Process)—Identifies potential mathematical expressions for quantifying system value.

System Valuation Analysis (Document)—Document Specifying potential mathematical expressions for quantifying system value.

System Variation Analysis (Process)—Examines the sensitivity and uncertainty in the System Regression Analysis.

System Variation Analysis (Document)—Document examining the sensitivity and uncertainty in the System Regression Analysis.

Tailor the Process—Tailor the Process identifies the processes and techniques that are implemented in the Portfolio Rationalization process.

Taxation Issues—Tax Issues considers the tax related consequences of an investment.

Technical Capability—Technical Capability examines the technical aspects of the investment capability.

Technical Capability Document—Examines the technical aspects of the investment capability.

Transformation Plan (Process)—The transformation plan documents specific actions that should be performed to affect the Strategic Direction Document.

Transformation Plan (Document)—A document detailing what investments should be rationalized, what actions should be taken, and how to proceed enacting the rationalization process.

Use Case Models—A method of documenting the requirements of a system.

Valuation Model—Base mathematical model describing the fundamental categories that may contribute to the Investment Model.

Valuation Model Analysis—Determines the Valuation Model based on the information obtained during Valuation Model Analysis.

Valuation Model Definition—Specifies the mathematical model used to compute the values associated with the Investment and Relational Categories.

Valuation Phase—Analysis to determine the methodologies used to quantify Business Value for the portfolio investments.

Valuation Risk Analysis—Examines the uncertainties in the Relational Categories due to inherent uncertainties in the data as well as uncertainties from the mappings that produce the Relational Categories.

Worst-fit—The fitting in regression where the distance is a maximum.

The terms ‘asset’ and ‘investment’ are used interchangeably.

The Process of Portfolio Rationalization

Generally, portfolio rationalization is carried out in a series of steps starting with a snapshot of the investments and culminating with recommendations for rationalization. Portfolio rationalization process generally is designed to achieve cost savings by identifying and correcting inefficiencies in the portfolio. The rationalization process achieves cost savings by recommending project/program elimination, consolidation, and identifying redundancies.

Once an investment (project/program) is targeted for rationalization, a Transformation Plan is created detailing how the recommended action is carried out. The Transformation Plan is the final output of the rationalization process incorporating the results from the previous processes together into a single plan for action for modifying the portfolio. Portfolio Rationalization also identifies investments that are performing well. Examining these investments creates an opportunity to identify the Best Practices in place within the organization.

There are four high-level phases in the process of portfolio rationalization. However, it should be understood that these phases do not need to be strictly sequential. Rather, they may be performed in parallel and potentially in different orders. The four phases are valuation, system, investment and portfolio.

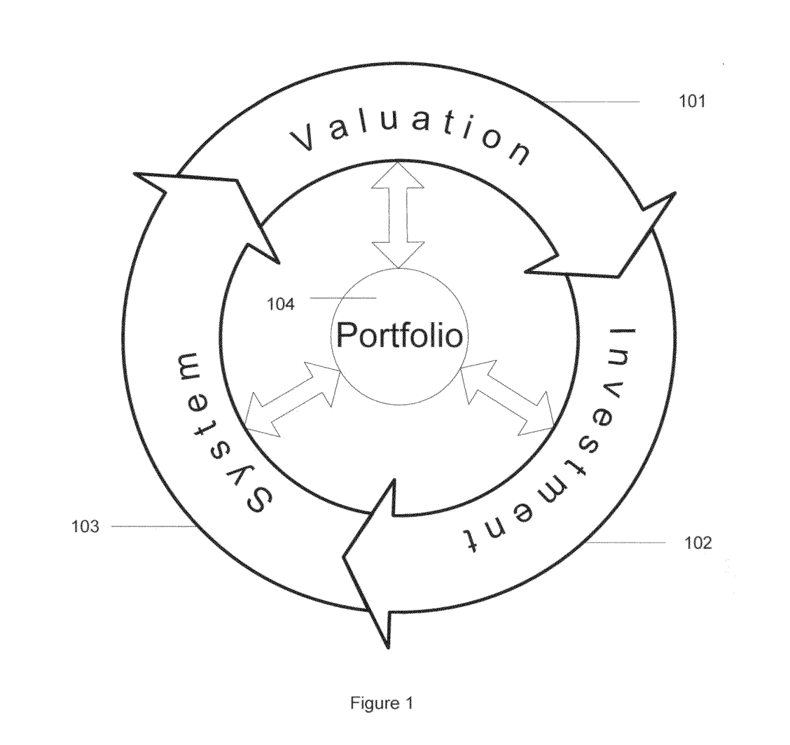

FIG. 1 represents the lifecycle of the portfolio rationalization process. The process is a continuous, ongoing operation, not a linear procedure. Information enters the lifecycle as raw data in the Valuation phase (101), then proceeds to the Investment phase (102), then the System (103) phase, and finally the Portfolio phase (104). Each of these phases has its own lifecycles, as discussed later, including one or more processes and flows. The process and flows vary depending upon the individual rationalization effort required. Tailoring the rationalization process means choosing a particular set of processes for use in a given rationalization effort. Further, one of skill in the art may alter the process as the project continues, identify and adding processes that have the greatest impact on the performance of the portfolio. In addition, one or more parts of the process may be automated.

More importantly, the Portfolio Rationalization Process may require one or more of the discussed phases, but may not necessarily require all phases. The phases and processes used depend upon the needs of the practitioner. Further, for each phase, one or more processes are discussed. If the phase is used in the Portfolio Rationalization Process, the process may require one or more of the processes within the phases. In other embodiments, the process may require all of the processes within a phase.

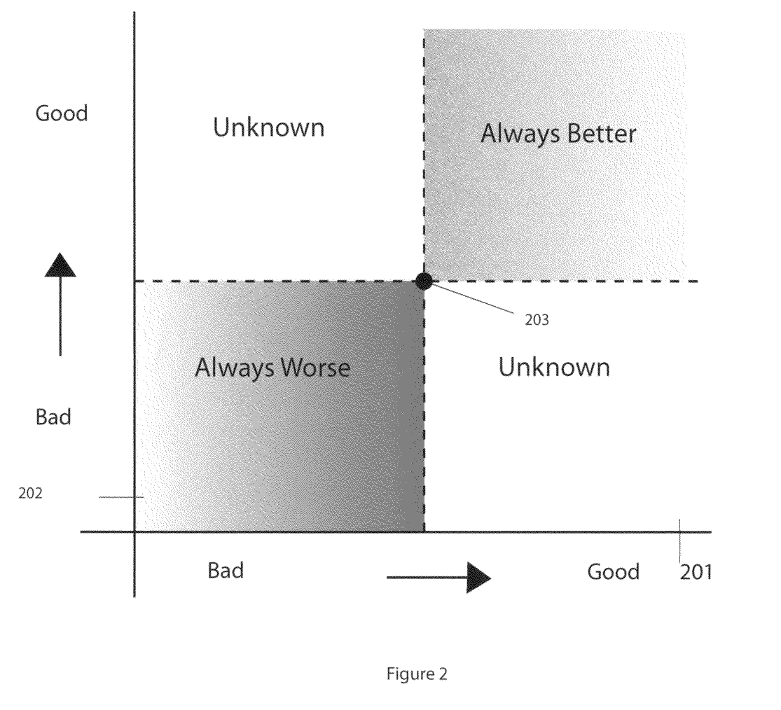

To achieve this goal, the technique must combine multi-valued asset information to make a prioritized list. Preferably, the information includes subjective information. In one embodiment, the technique includes making a chart to demonstrate the asset data point information. FIG. 2 illustrates an embodiment of this invention. Here, the axes (201, 202) demonstrate information such as cost, number of users, and any measure of value to the user. Both axes go from bad number or value to a good number or value. The black dot (203) represents a particular point of data. Based on this one embodiment, a data value that has two higher “good” information rates is therefore better, or more ranked higher, than an asset having a less good information rating.

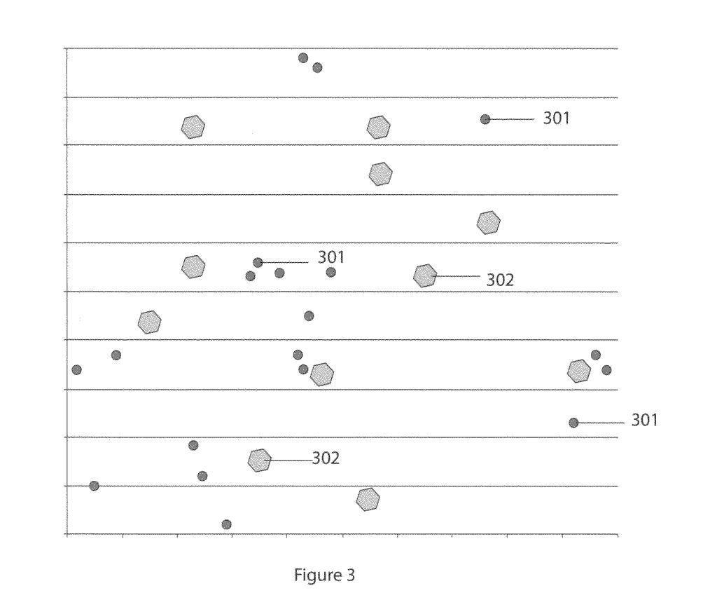

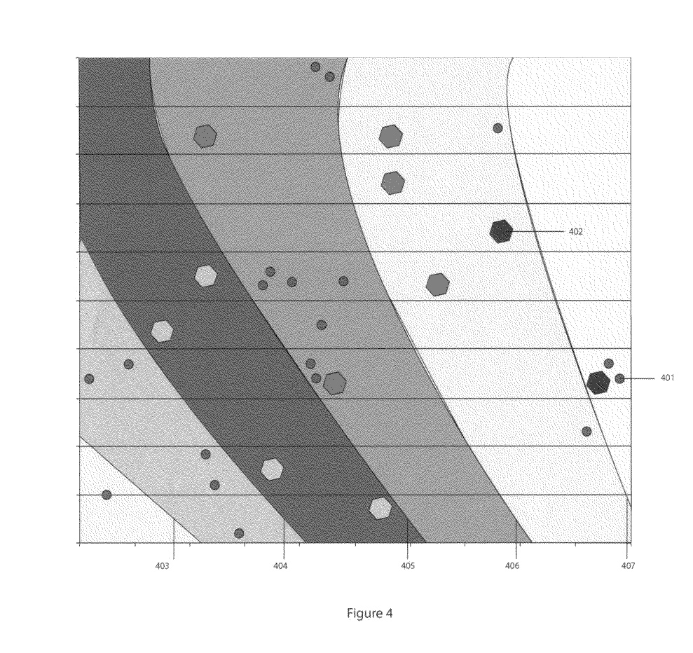

As a result of the rationalization process, a graph may be generated showing the multi-valued asset information for each point. See, for example, FIG. 3. The circles and hexagons (301, 302) all represent asset data points, where the hexagons represent data points that are matched by subjective rules. Thus, contour from the fitting data can be used to create curves representing regions of similar prioritization values. See, for example, FIG. 4. Here, the circles (401) and hexagons (402) represent data points, where the hexagons represent data points matched by subjective rules. Contour lines (403-407) are generated to divide the data points into bins, shown by the different shaded regions.

Valuation Phase

The Valuation phase is the beginning of the Portfolio Rationalization Lifecycle. This phase identifies the methodologies used to value the portfolio investments. The culmination of this phase is the Valuation Model, which is used for the valuation of the portfolio investments. The Investment Model is comprised of a set of technical guidelines and data that provide a means to relatively value each asset. The methodology enables each asset to be ranked with respect to the other assets. This partially ordered ranking structure will continue throughout the rationalization lifecycle.

There are three processes in the Valuation Phase of portfolio rationalization: Portfolio Snapshot, Category Definition and Business Value Definition. One or more of these three processes may be used to generate the Valuation Model. Further, these processes may be used sequentially, concurrently, or the like.

A) Portfolio Snapshot

The Portfolio Snapshot is a collection of investment data taken at a particular instant. This data provides a basis for understanding what information is available for the asset and the quality of the data. The quality of the data is important to the valuation of the investment because data quality helps measure the uncertainty in the business valuation. For example, if the data supporting a particular investment is changing rapidly, there is a high uncertainty in the measurement of the business value. This uncertainty must be incorporated into our analysis in order to produce reliable results.

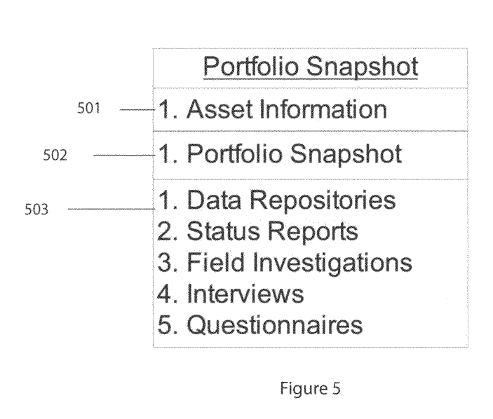

FIG. 5 depicts the process inputs (501), process outputs (502) and tools and techniques (503) used to transform the inputs into the outputs for the Portfolio Snapshot process. The process input (501) is Asset Information. This data may come from a data repository, status reports, field investigations, management interviews, questionnaires, etc. Regardless of the data source, the Portfolio Snapshot compiles all of this information together at a single location. This data repository will be used by other processes in portfolio rationalization.

The main output (502) of the Portfolio Snapshot process is the Portfolio Snapshot. This data set is used throughout portfolio rationalization and plays a key role in all of the other processes and phases. Typically, the Portfolio Snapshot process is regularly repeated in order to keep the data up-to-date during the life cycle of portfolio rationalization.

B) Category Definition

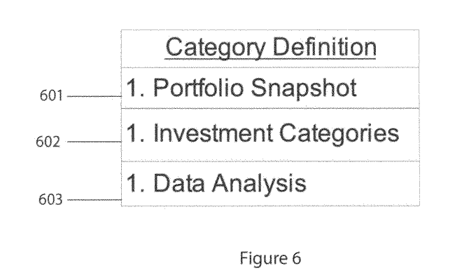

For Category Definition, a set of categories that cover all investments is defined. FIG. 6 depicts the process inputs (601), process outputs (602) and tools and techniques (603) of the Category Definition process. The process input is the Portfolio Snapshot, output is Investment Categories, and tools and techniques is data analysis.

Category Definition depends on the Portfolio Snapshot process. A list of potential data fields is created when making the Portfolio Snapshot. Moreover, the snapshot data will provide insight into which fields are and are not reliably populated. This information can be used during the Category Definition process to evaluate the utility used to create a category from a specific field or combination of fields.

The category is dependent upon the particular valuation desired. For instance, on one embodiment a category has a continuous value. In another category, a selected category may be divided into one or more bins, therefore the category may have more than one bin or value. This allows every investment to be given a specific value for this category, making it into a discrete variable, the category value, by setting a series of thresholds. This is useful because the category values for each investment will later be used to perform cluster modeling on the investments. The cluster modeling process does work with continuous variables; however, it is often easier to work with discrete variables.

The main output of the Category Definition process is the Investment Categories. The selection of categories is accomplished by analyzing the data found in the Portfolio Snapshot. These categories are a fundamental input to the Investment Model and are part of the basis of Business Value.

C) Business Value Definition

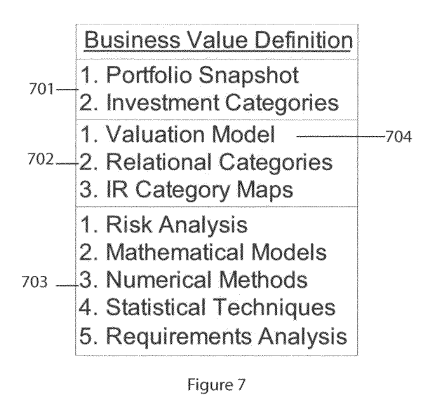

FIG. 7 shows the Business Value Definition Process. Business Value Definition specifies the mathematical models and formulae used to quantify the business value of an asset and the associated uncertainty (risk). The Business Value Definition Process has the following inputs (701): Portfolio Snapshot, Investment Categories. It also has the following outputs (702): Investment Model. The tools and techniques associated (703) with this process are Risk Analysis, Mathematical Models, Numerical Methods, Statistical Techniques, and Requirements Analysis. The Business Valuation Definition process is dependent on the output of the Category Definition process. The business value is typically a mathematical function combining some set of categories. As such, this process needs to know what categories are available for use in determining the business value.

In one embodiment, the category values is used for the asset and create a weighted sum to obtain the business value:

B=Σᵢwᵢcᵢ

In the above expression, B is the business value, wᵢ is the weight associated with the i^{th} category, and cᵢ is the value of the i^{th} category. The weights wᵢ may be simply set by hand, or may be computed through a regression analysis on the data. The regression analysis may be performed by creating a partially ordered relative ranking of the investments, then performing a least-squares regression to fit the specified values to a linear model.

In addition to specifying a model for the value of an investment, the uncertainty in the value must be evaluated. These uncertainties can be used for relative ranking of the investments. For instance, business values with high uncertainties may be less favorable and given a less relative ranking than business values with a small uncertainty, or vice versa.

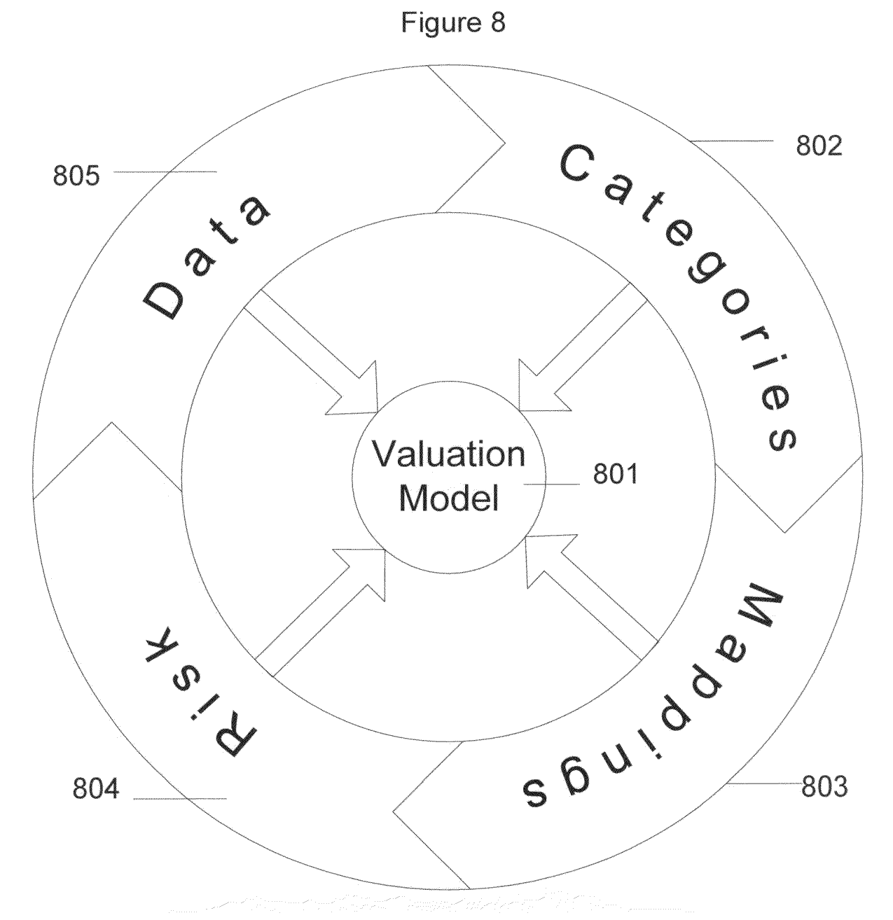

One particular output is the Valuation Model (FIG. 8). The Valuation Model (508) Valuation Model is used to identify categories that may be useful in assessing business value. The Valuation Model examines the raw data available for the portfolio investments and determines which data has sufficient quality to be useful in computing business value. The outputs from the Portfolio Snapshot (502), Category Definition (503) and Business Value Definition (504) are the used to determine the Category Valuation and/or Investment Valuation.

Valuation Model

The Valuation Model does not compute the business value for the investments. The Investment Model is responsible for assigning business value to each investment. The Valuation Model identifies the categories that may be used as a basis for the business value. The Valuation Model includes analysis of the categories (802), mappings (803), risk (804) and data (805).

A) Data Analysis

The Data Analysis category is primarily concerned with measuring the quality of the data used to create the Portfolio Snapshot. The Data Analysis category is divided into five sub-areas: Data Quality Analysis, Data Consistency Analysis, Data Stability Analysis, Data Coverage Analysis, and Data Cleansing. The first of these five sub-areas contributes to the uncertainty of the value computed by the model. As discussed earlier, the uncertainty in the value is as important as the value itself. One or more of these processes may be used at one time.

i) Data Quality Analysis

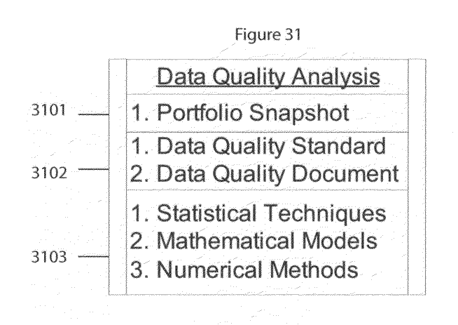

FIG. 31 shows the Data Quality Analysis Process. The Data Quality Analysis subarea is a quantitative quality control process with respect to the Portfolio Snapshot. The Data Quality Analysis sub-area focuses on measuring how well the data gathered conforms to requirements. If the data does not have sufficient coverage, or if the type of data is unexpected, the data may not be useful for the model.

After an initial Portfolio Snapshot is obtained, the data is examined and a set of quality standards is constructed. This initial information is used to specify the data quality standard that is expected for future Portfolio Snapshots. The Data Quality Analysis Process has the following input: Portfolio Snapshot (3101). It also has the following outputs: Data Quality Standard and Data Quality Document (3102). The tools and techniques associated with this process are Statistical Techniques, Mathematical Models and Numerical Methods (3103).

The Data Quality Standard is a document specifying what fields are present in the Portfolio Snapshot, the data type of each field, and a minimum coverage. Each individual specification as to the nature of a part of the Portfolio Snapshot is called a Quality Rule.

A checklist is created with an entry for every Quality Rule. Every time a new Portfolio Snapshot is created, a Data Quality Analysis is performed and a quality checklist is completed. The completed checklist evaluates every Quality Rule and documents whether the snapshot obeys the rule.

The checklist may be computed automatically via a computer program. Many of the rules in a checklist can be evaluated by software tools. In these cases, it may be efficient to automatically compute a checklist every time a new snapshot is compiled. A compliance report may be prepared as new checklists are compiled.

Data Quality Analysis examines several aspects of the data to determine the overall quality. The list below details some of the more common elements that are reviewed:

Correctness—Evaluates whether the data in the snapshot is correct. The Portfolio Rationalization Process fundamentally relies on the information in the Portfolio Snapshot. If this data is incorrect, the rationalization decisions may be incorrect.

Accuracy—Examines groups of data elements to verify that they are correct in combination. For example, if a recordset has a zip code and a city name, accuracy evaluates if the zip code is correct for the city.

Integrity—Datasets in relational databases often have keys referring to records in other tables. Integrity verifies that these referred records are in fact present. If the data does not have integrity, then all of the necessary information may not be present for proper analysis.

Completeness—Determines if groups of fields are presented together when required. Some fields require that other fields have defined values. If these other values are not specified, we can end up with inconsistent results.

Validity—Examines the data to assure that every field has a valid value. Invalid values can lead to unpredictable results because these values were not anticipated when defining the methods of computing Business Value.

Consistency—Identifies inconsistent data in the data set. This typically requires some set of predetermined rules in order to effectively identify inconsistent data. Inconsistent data can lead to inconsistent analysis results and should be corrected whenever possible.

Coverage—Data Coverage is the percent of data present for a given field. Data Coverage is useful in determining which fields present opportunities to relatively compare investments. Two investments may be compared when both a value present for the same field.

Uniqueness—Examines the data set to identify duplicate records in the data. Duplicate records cause problems because statistical analysis of the data counts the individual records without understanding that some are duplicates. This biases the results and can lead to rationalization errors.

ii) Data Consistency Analysis

The Data Consistency Analysis sub-area addresses questions about the consistency of the data when different measurements are made. For example, a specific data field may be measured in different ways. If more than one method is used, one can end up with different values for the field depending on which measurement is examined. Problems such as this also contribute to the uncertainty of the model value.

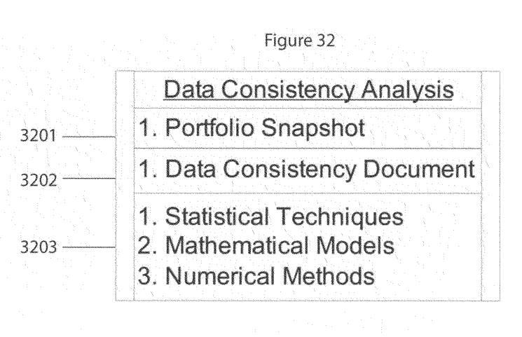

FIG. 32 shows the Data Consistency Analysis Process. Data Consistency Analysis compares two simultaneous measurements of the same data field. The Data Consistency Analysis Process has the following input: Portfolio Snapshot (3201). It also has the following output: Data Consistency Document (3202). The tools and techniques associated with this process are Statistical Techniques, Mathematical Models, and Numerical Methods (3203).

Data Consistency Analysis compares two different measurements of the same data field. For example, a value for the field can be obtained via interview, and get another value from a questionnaire. These values can be different, and this difference can be statistically analyzed. Data Consistency Analysis measures the statistical variation of the measurement of the field value.

Data Consistency Analysis faces similar challenges as Data Stability Analysis, and similar techniques may be employed. The variance of the different measurements may be quantified, and this can be done in a variety of ways depending on the underlying data type.

Data consistency may also be addressed during Data Quality Analysis. However, data consistency is a common problem in portfolio rationalization. Because of this, this particular element is defined as a separate process.

iii) Data Stability Analysis

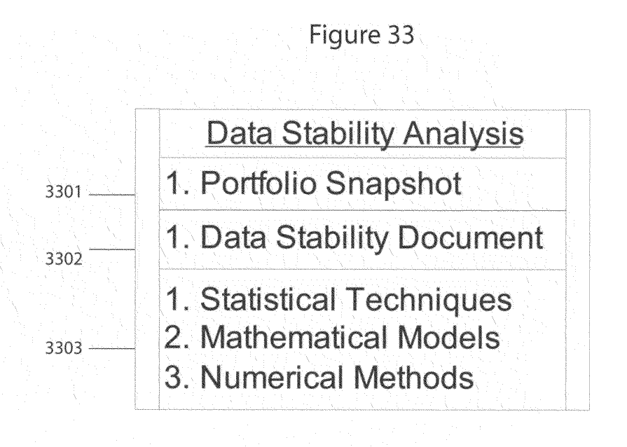

FIG. 33 shows the Data Stability Analysis Process. Data Stability Analysis compares successive Portfolio Snapshots taken over time to estimate the extent and variance of the data. The Data Stability Analysis Process has the following input: Portfolio Snapshot (3301). It also has the following output: Data Stability Document (3302). The tools and techniques associated with this process are Statistical Techniques, Mathematical Models, and Numerical Methods (3303).

Data Stability Analysis compares successive Portfolio Snapshots taken over time to estimate the extent and variance of the data. The data changes may be evaluated over the entire dataset, for a field over the dataset, for a particular investment, or for a field for each investment. Data Stability Analysis is the statistical variation of the data values over time.

The first step is to quantify the changes to a field. The quantification should account for the difference between the old value and new value. If the data is a numeric field, this may simply be the difference. If the field is character based, an appropriate measure should be constructed depending on the information in the field. At a minimum, we may simply take a Boolean value of 0 to indicate no change or 1 to indicate that the data has been modified.

If the degree of variance can be computed, we can use this as the measure of uncertainty of the value of each data field. In this respect, every field f can be associated with an error Δf. When we use the field data in formulas, we can propagate the error through standard error propagation analysis. Specifically, if we have f±Δf and some function g(x), then

$$Δ {g}^{2} = {( \frac{\partial f}{\partial x} )}^{2} {( Δ x )}^{2}$$

Data Consistency Analysis compares two different measurements of the same data field. For example, we may obtain a value for the field via interview, and get another value from a questionnaire. These values can be different, and this difference can be statistically analyzed. Data Consistency Analysis measures the statistical variation of the measurement of the field value.

Data Consistency Analysis faces similar challenges as Data Stability Analysis, and similar techniques may be employed. We need to quantify the variance of the different measurements, and this can be done in a variety of ways depending on the underlying data type.

Data consistency is also addressed during Data Quality Analysis. However, data consistency is a common problem in portfolio rationalization. Because of this, this particular element is defined as a separate process.

iv) Data Coverage Analysis

Data Coverage Analysis examines the field-level coverage of the data. This information is essential in identifying data fields that can be used to compare investments. Fields with low Data Coverage have a narrow use for comparing investments. However, these can be useful when analyzing a highly specific group of investments. Alternatively, fields with high Data Coverage may present opportunities to compare a wide range of investments.

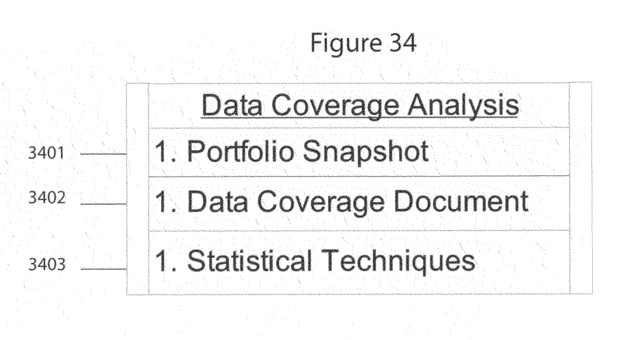

FIG. 34 shows the Data Coverage Analysis Process. Data Coverage Analysis measures the percent of investments that have useful information for a specific data field. The Data Coverage Analysis Process has the following input: Portfolio Snapshot (3401). It also has the following output: Data Coverage Document (3402). The tool and technique associated with this process is Statistical Techniques (3403).

Data Coverage is a measure of the percent of investments that have useful information for a specific data field. In particular, if there are n total investments in the portfolio and d of these have data available for this field, the Data Coverage is

C=d/n.

As an example, assume there are 10 investments in the portfolio. Let ‘Number of Users’ be one of the fields. If only 80 of the investments have a value for this field, then the Data Coverage for this field is

$$C = \frac{80}{100} = 0.80 = 80 \% .$$

The Data Coverage is a measure of how useful a particular data field is for evaluating investments. Fields that have low Data Coverage have a more narrow use than fields with a high Data Coverage. The Category Definition process accounts for this information when choosing categories.

Data Coverage may also examine the variance in the field data. A field may have coverage of 10%, but this is useless as a comparator if every investment has the same value for the field. Data Coverage computes how many different values are present. This may be computed by taking the total number of distinct values and dividing by the total number of investments, or by examining the standard deviation. Data Coverage is also addressed in Data Quality Analysis. Similar to Data Consistency Analysis, Data Coverage is particularly important in portfolio rationalization, so it is defined as a distinct process.

v) Data Cleansing Analysis

The Data Cleansing process aims to identify and/or correct faulty data in the Portfolio Snapshot. The process examines the Data Coverage, Data Quality Analysis, Data Consistency Analysis, and Data Stability Analysis to assess several aspects of the data.

These factors are analyzed to determine the overall quality of the data. Deficiencies are marked and corrected if possible. The deficiencies should be noted and accounted for in the Business Valuation Model.

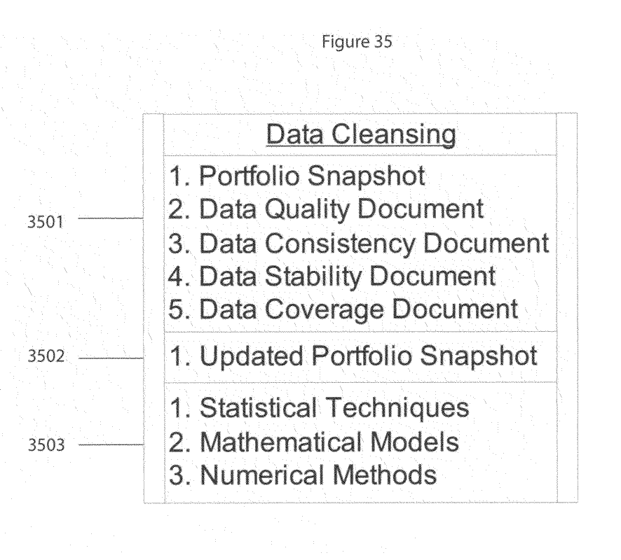

FIG. 35 shows the Data Cleansing Process. Data Cleansing identifies and corrects faulty data from the Portfolio Snapshot. The Data Cleansing Process has the following inputs: Portfolio Snapshot, Data Quality Document, Data Consistency Document, Data Stability Document, and Data Coverage Document (3501). It also has the following output: Updated Portfolio Snapshot (3502). The tools and techniques associated with this process are Statistical Techniques, Mathematical Models, and Numerical Methods (3503).

B) Category Analysis

Category Analysis analyzes the available raw data and determines which categories are suitable for used in computing business value. The purpose is not to identify which categories are important measures of value. Instead, these processes examine the quality of the underlying data set minimum quality standards for the data. Datasets that do not meet the minimum quality standards are discarded as unreliable.

i) Category Identification

Category Identification examines the raw data and relates the various data categories. This analysis is done using the Portfolio Snapshot and Investment Categories. This process is different in purpose from the Category Definition process. The Category Definition process aims to identify all available categories. Category Identification examines the list of all available categories, determines how the categories relate, normalizes the information, and compiles the information together into a list of Relational Categories.

In a sense, the Relational Categories form a database schema for the category information. In addition, this process identifies the IR Category Maps. These maps identify which raw categories (from the Investment Categories list) map to the Relational Categories.

Individual Investment Categories may be combined together, dissected, or parsed to form individual Relational Categories. For example, a ‘Point of Contact’ field for ‘IT Hardware’ and a different ‘Point of Contact’ field for ‘IT Software’. Each of these ‘Point of Contact’ fields may be an Investment Category. Here, one must decide to combine these two sets of data into a single ‘Point of Contact’ field and setup relations between this final dataset and the ‘IT Hardware’ and ‘IT Software’ categories. The Mapping Analysis that follows identifies specific mappings from the Investment Categories to the Relational Categories.

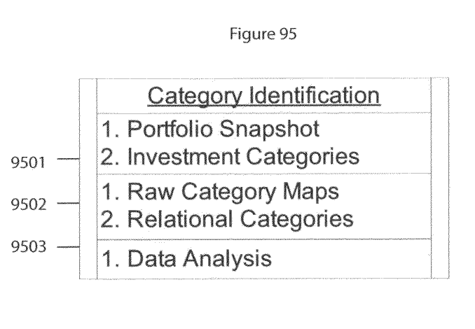

FIG. 95 shows the Category Identification process. The Category Identification Process has the following inputs: Portfolio Snapshot and Investment Categories (9501). It also has the following output: IR Category Maps and Relational Categories (9502). The tools and techniques associated with this process are Data Analysis (9503).

ii) Category Coverage

Category Coverage is a standard data coverage analysis applied to the Relational Categories. This process identifies the field-level coverage of the Relational Categories which is used during Investment Model Analysis to assist with the specification of the Investment Model.

The output of Category Coverage is the Asset Category Coverage. This document computes the coverage for both the Investment and Relational Categories. The Asset Category Coverage is used during the Category Data Requirements process to assist in the specification of the Category Quality Standard as well as identifying the Passed Relational Categories.

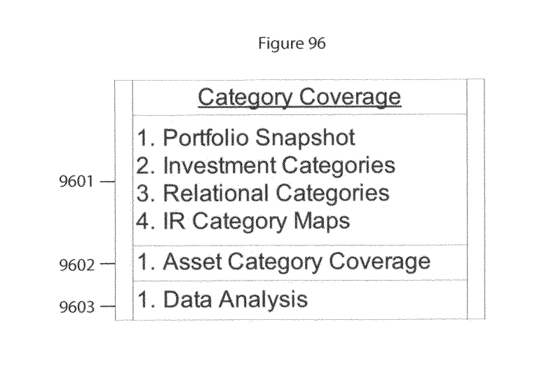

FIG. 96 shows the Category Identification process. The Category Identification Process has the following inputs: Portfolio Snapshot, Investment Categories, Relational Categories and IR Category Maps (9601). It also has the following output: Asset Category Coverage (9602). The tools and techniques associated with this process are Data Analysis (9603).

C) Mappings Analysis

Mappings Analysis examines potential mappings between Relational Categories to formulate business value. The analysis is broken into Dilation Mappings, Linear Mappings, Nonlinear Mappings. These are handled separately because the Dilation Mappings are very common, Linear Mappings are typically common, and the Nonlinear Mappings are typically more complex.

Dilation Mappings are simple scaling and translations of the Investment Categories. Dilation Mappings are linear transformations that only involve a single Investment Category. For example, we may have an Investment Category for ‘Employee Satisfaction’ taken from a survey. The raw data is on the range from 0 to 5. We desire a Relational Category on the range from 1 to 10. Let I be the Investment Category data and R be the Relational Category data. The dilation transformation relating these is

$$R = \frac{9}{5} I + 1$$

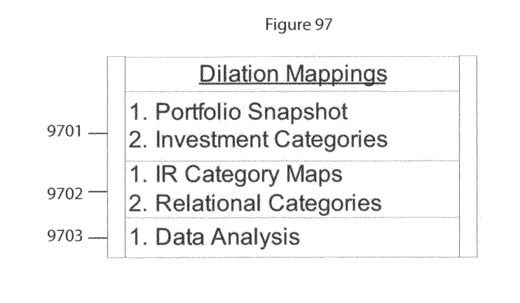

FIG. 97 shows the Dilation Mapping process. The Dilation Mapping Process has the following inputs: Portfolio Snapshot and Investment Categories (9701). It also has the following output: IR Category Maps and Relational Categories (9702). The tools and techniques associated with this process are Data Analysis (9703).

Linear Mappings are mappings of Investment Categories to Relational Categories that are linear transformations but involve more than one category. For example, suppose we have two employee satisfactions surveys taken six months apart. Each of these surveys is an independent Investment Category. We may want to compute a Relational Category that is the average of the two:

$$R = \frac{{I}_{1} + {I}_{2}}{2}$$

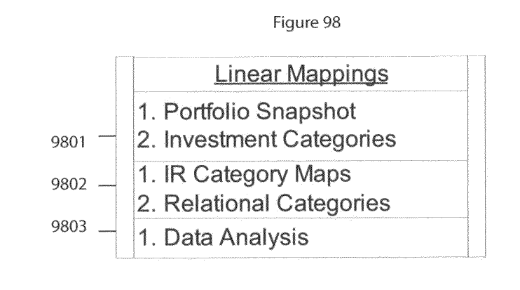

FIG. 98 shows the Linear Mapping process. The Linear Mapping Process has the following inputs: Portfolio Snapshot and Investment Categories (9801). It also has the following output: IR Category Maps and Relational Categories (9802). The tools and techniques associated with this process are Data Analysis (9803).

Nonlinear Mappings are mappings of Investment Categories in a nonlinear way. For example, if an investment has a category for ‘Number of Users’ and another category for ‘Cost’, we may want to compute the ‘Cost per User’ Relational Category as:

$$R = \frac{N}{C}$$

Alternatively, if there is data that covers a wide range and wish to scale this according to standard data analysis techniques. For example, there may be an Investment Category with a field of ‘User Clicks’. Because some applications may have only a few clicks per month while others have several clicks per second, the data in this category may vary over a wide range. To scale this, one of skill can use the natural logarithm of the Investment Category:

R=lnClicks

This is also a nonlinear map. Although the map only involves one Investment Category, this is not a Dilation Mapping because the transformation is nonlinear.

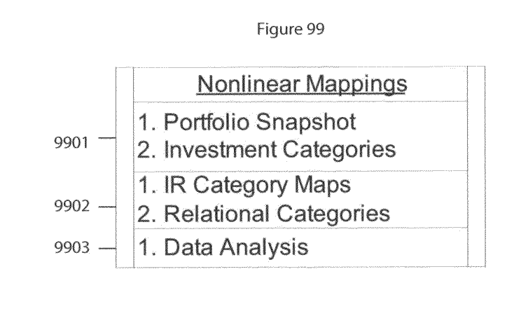

FIG. 99 shows the Nonlinear Mapping process. The Nonlinear Mappings Process has the following inputs: Portfolio Snapshot and Investment Categories (9901). It also has the following output: IR Category Maps and Relational Categories (9902). The tools and techniques associated with this process are Data Analysis (9903).

C) Valuation Risk Analysis

Valuation Risk Analysis examines the uncertainties in the Relational Categories due to inherent uncertainties in the data as well as uncertainties from the mappings that produce the Relational Categories.

i) Category Risk

Category Risk is the uncertainty in the Investment Category values due to uncertainties in the raw data. This risk quantifies the measurement uncertainty in the data.

There is always some uncertainty in the measured value. Even when a category is as simple as a yes/no field, there is still some uncertainty associated with the value. For example, some of the data may be incorrect because of typographical errors during data entry, corruption during data transmission, or misunderstanding on the part of the evaluator. In any case, there will be some finite, non-zero uncertainty associated with every Relational and Investment Category.

The output of Category Risk is the Category Risk Assessment. This document specifies the uncertainty associated with each Investment Category. These uncertainties provide the basis for computing the Relational Category uncertainties in the Mapping Risk process.

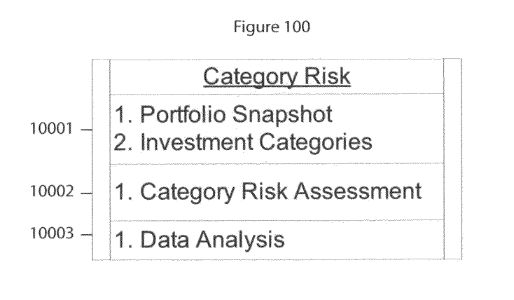

FIG. 100 shows the Category Identification process. The Category Identification Process has the following inputs: Portfolio Snapshot and Investment Categories (10001). It also has the following output: Category Risk Assessment (10002). The tools and techniques associated with this process are Data Analysis (10003).

ii) Mapping Risk

Mapping Risk is the uncertainty in the Relational Category value arising from the mapping between the Investment Categories and the Relational Category. This uncertainty may be computed using standard error propagation techniques.

To compute the Mapping Risk, we begin with the Category Risk Assessment from the Category Risk process and the IR Category Maps from the Mapping Analysis. We apply error propagation to the IR Category Maps to determine the formulae for expressing the uncertainties in the Relational Categories. We can evaluate these expressions using the Category Risk Assessment, Investment Categories, and the Portfolio Snapshot.

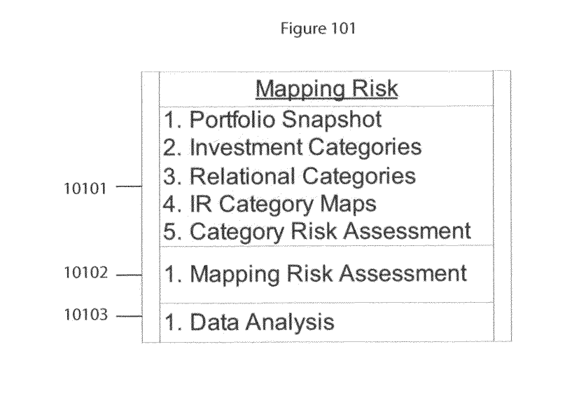

FIG. 101 shows the Mapping Risk process. The Mapping Risk Process has the following inputs: Portfolio Snapshot, Investment Categories, Relational Categories, IR Category Maps and Category Risk Assessment (10101). It also has the following output: Mapping Risk Assessment (10102). The tools and techniques associated with this process are Data Analysis (10103).

D) Valuation Model Analysis

Valuation Model Analysis compiles the results from the previous processes to formulate the Valuation Model. The Valuation Model is the mathematical method used to specify the valuation of the Relational and Investment Categories.

i) Category Data Requirements

Category Data Requirements are minimal quality requirements that must be met in order to consider an Investment or Relational Category as having sufficient quality for consideration. Categories that do not meet this minimum threshold should be discarded and not used for computing business value.

This process outputs the Category Quality Standard and the Passed Relational Categories. The Category Quality Standard is a document specifying the quality standard for the Relational Categories. This quality standard is applied to the Relational Categories to determine the set of Passed Relational Categories. These are the categories that are determined to be sufficient to pass the Category Quality Standard.

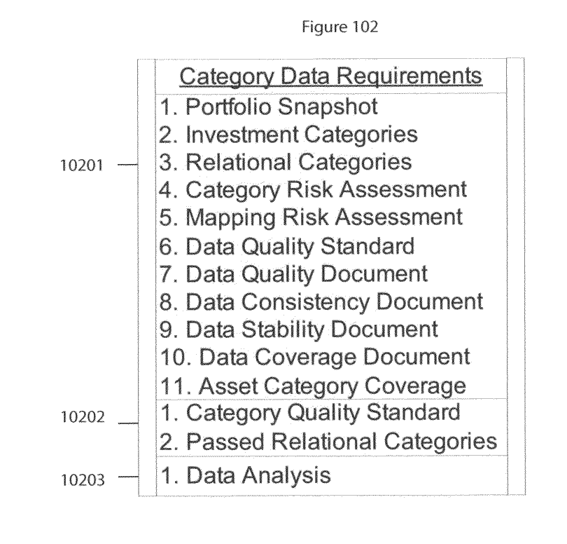

FIG. 102 shows the Category Data Requirements process. The Category Data Requirements Process has the following inputs: Portfolio Snapshot, Investment Categories, Relational Categories, Category Risk Assessment, Mapping Risk Assessment, Data Quality Standard, Data Quality Document, Data Consistency Document, Data Stability Document, Data coverage Document and Asset Category Coverage (10201). It also has the following output: Category Quality Standard and Passed Relational Categories (10202). The tools and techniques associated with this process are Data Analysis (10203).

ii) Valuation Model Definition

Valuation Model Definition specifies the mathematical model used to compute the values associated with the Investment and Relational Categories. This process produces the Valuation Model which is one of the critical portfolio rationalization models.

This process examines the results of Data Analysis, Category Analysis, Mappings Analysis, and Valuation Risk Analysis to produce a mathematical specification of how values are constructed from the field data in the Investment and Relational Categories. The Valuation Model is used by the Investment Phase in order to assign values to the categories and to compute the business value for the investments.

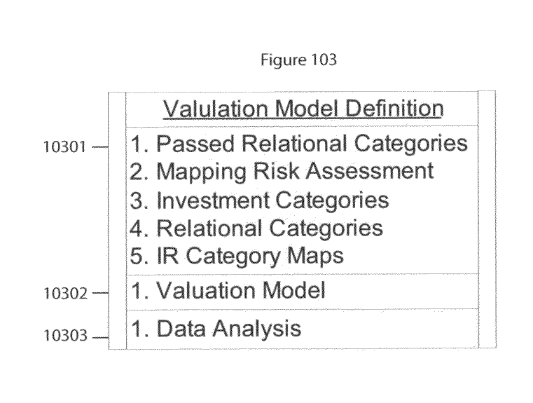

FIG. 103 shows the Valuation Model Definition process. The Valuation Model Definition Process has the following inputs: Passed Relational Categories, Mapping Risk Assessment, Investment Categories, Relational Categories and IR Category Maps (10301). It also has the following output: Valuation Model (10302). The tools and techniques associated with this process are Data Analysis (10303).

Investment Phase

The Investment phase examines each asset, determines the asset category values, and computes the business value. This process is used to determine a business value for each asset. Later phases will use the results of the Investment phase to create Investment Clusters and examine the performance of the portfolio as a whole. The Investment phase has two main processes: Category Valuation and Investment Valuation. Category Valuation specifies the values for the asset categories, while Investment Valuation computes the business value. This phase is dependent on the Valuation Phase, as that phase determines what the categories are, the allowed category values, and how the business value is computed. One or more of these processes may be used at one time.

A) Category Valuation

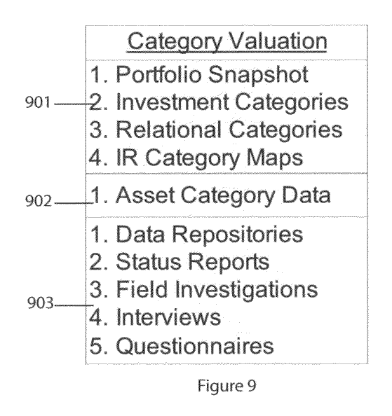

FIG. 9 shows the Category Valuation Process. Category Valuation is the process of determining the value of each category for every investment. For example, an investment may be categorized as: ‘Program Budget’=$1M-$10M, ‘Criticality’=High, ‘Number of Users’≦50, etc. This process examines each investment and determines the value for each of the categories.

The Category Valuation Process has the following inputs: Portfolio Snapshot, Investment Categories (901). It also has the following output: Asset Category Data (902). The tools and techniques associated with this process are Data Repositories, Status Reports, Field Investigations, Interviews, and Questionnaires (903).

The list of categories and allowed values is determined in the Category Definition process of the Valuation phase. The Category Valuation process is the point where the category values are actually specified for every asset. The actual values for each investment are determined by examining the data in the Portfolio Snapshot. In this respect, the Category Valuation process is dependent on both the Portfolio Snapshot and Category Definition processes.

The Category Valuation process may be completed using a variety of methods. Optimally, the Category Valuation process uses the information from the Portfolio Snapshot to compute the values using a database repository that is reliably kept up-to-date. Alternatively, the Category Valuation process may use status reports, field investigations, interviews, or questionnaires to determine the category value for a specific investment.

The Category Valuation process computes the values for both the Investment Categories as well as the Relational Categories. This combined set of category data makes up the Asset Category Data that is the output of this process.

B) Investment Valuation

Investment Valuation is the process of computing the business value for every investment. The business value is computed from the Investment Model. The business value of the assets is an essential measurement that is used throughout portfolio rationalization. The business value is computed using the results of the Category Valuation process as well as the Business Valuation Definition. The Category Valuation process provides the raw data required, while the Business Valuation Definition provides the Investment Model which specifies the Numerical Methods and Mathematical Models used to compute the business value. Because of these relationships, the Investment Valuation process is dependent on the Category Valuation and Business Valuation Definition processes.

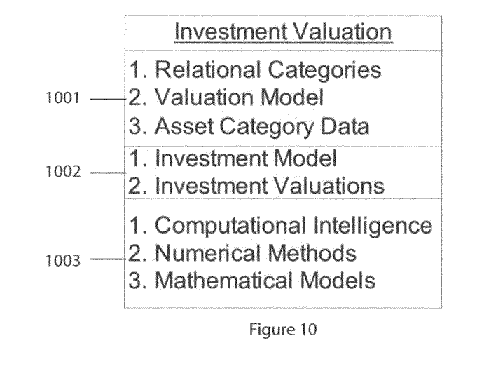

FIG. 10 shows the Investment Valuation Process. Investment Valuation is the process of computing the overall business value(s) for each investment. The Investment Valuation Process has the following inputs: Investment Categories, Investment Model, and Asset Category Data (1001). It also has the following output: Investment Values (1002). The tools and techniques associated with this process are Computational Intelligence, Numerical Methods, and Mathematical Models (1003).

Further, the business value has two components: a measurement and an uncertainty. For example, the value $1M±$0.1M has measured value $1M and uncertainty $0.1M. Furthermore, there may be more than one business value for each investment. For example, a portfolio may have the majority of assets with an assigned ROI. However, there may be a few compliance assets that do not have a ROI because these investments are related to mandatory compliance issues.

In one embodiment, an extremely high business value is assigned to the compliance investments in order to guarantee that their value is higher than all other investments. In another embodiment, there are two business values: one related to ROI and another related to mandatory compliance. In this case the ROI assets will have a low or zero value for mandatory compliance, but a measureable ROI. Moreover, the compliance investments will have a low ROI but a high compliance value. In this respect the investments may be analyzed differently but using the same overall methodology.

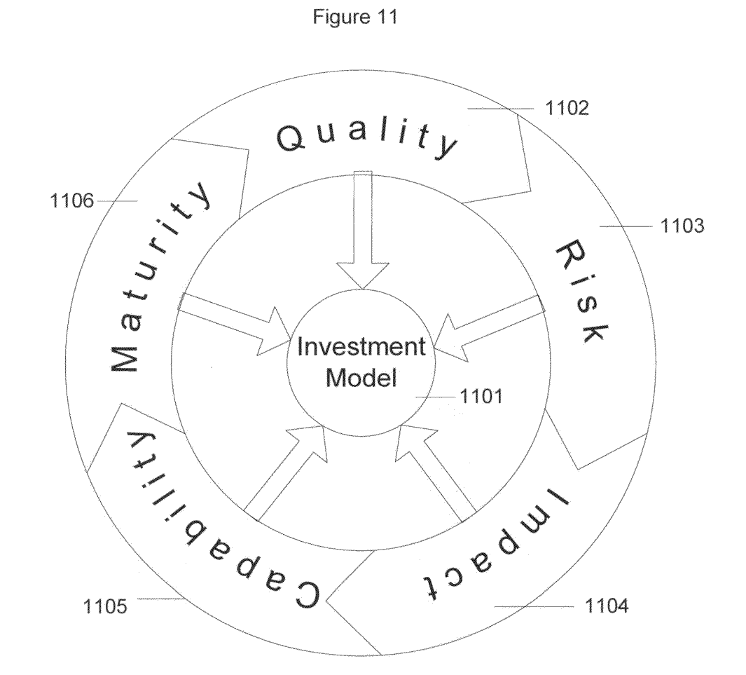

One of the outputs of the Investment Valuation is the Investment Model. The Investment Model uses the results from the Valuation Model to compute the business value for each of the investments. The Investment Model provides a mathematical relationship to compute every identified business value for each of the investments. As shown in FIG. 11, the Investment Model (1101) is dependent upon the quality (1102), risk (1103), impact (1104), capability (1105) and maturity (1106) of the Valuation Model information.

System Phase

The System phase of portfolio rationalization examines groupings or clusters of investments. This phase identifies groups of assets with similar properties in order to facilitate the rapid identification of high-performing investments as well as problem areas. The System Phase has four processes: Cluster Modeling, Prioritization, System Selection, and System Evaluation. These processes group similar investments, identify systems of interest, and gather detailed information on the systems of interest. Each System Phase has one or more processes used for one portfolio rationalization project.

This phase begins with Cluster Modeling, which is the process of grouping together investments that have similar properties. Then the Prioritization Process is used to rank order the performance of the assets so that problem investments may be addressed in more detail. System Selection is used to choose specific systems for detailed examination. Finally, the System Evaluation process is used to examine the system in detail and obtain specific System Requirements. One or more of these processes may be used at one time.

A) Cluster Modeling

The Cluster Modeling process groups investments together using their category values or other characteristics that may be used to identify similar investments. The specific category values for each investment are determined in the Category Valuation process during the Investment phase.

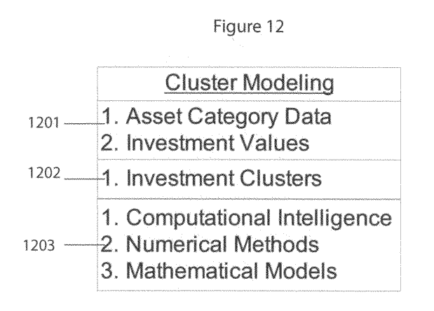

FIG. 12 shows the Cluster Modeling Process. The Cluster Modeling groups investments together using their category values or other characteristics that may be used to group the investments. The Cluster Modeling Process has the following inputs: Investment Values and Asset Category Data (1201). It also has the following output: Investment Clusters (1202). The tools and techniques associated with this process are Computational Intelligence, Numerical Methods, and Mathematical Models (1203).

The Asset Category Data input is a result of the Categorization Process. The categories may be analyzed simultaneously or in a sequence. For instance, standard charts to analyze up to three categories at a time: a single category can be plotted on a line, two categories can be graphed in a plane, and three categories may be plotted in space. However, if there are more than three dimensions, there is no efficient method to represent all of the data at the same time. Thus, cluster modeling problems often are a multi-dimensional Data Analysis problem.

In one preferred embodiment, an automated computer analysis using special software systems is designed to analyze multi-dimensional data. Other tools and techniques include numerical analysis software and algorithms. These software systems may be able to analyze this multi-dimensional data quickly and accurately and arrive at clusters that are difficult to determine using a manual process.

The product of the Cluster Modeling process is a grouping of investments into clusters. The clusters represent groups of assets that have similar properties. This grouping allows quick identification of entire groups of investments that are performing effectively and groups that are problematic.

B) Prioritization

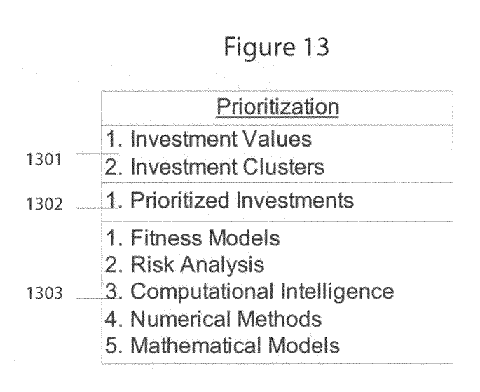

FIG. 13 shows the Prioritization Process. Prioritization is the process of rank ordering the current portfolio assets according to their overall performance, and rank ordering potential new investments. The Prioritization Process has the following inputs: Investment Values and Investment Clusters (1301). It also has the following output: Prioritized Investments (1302). The tools and techniques associated with this process are Fitness Models, Risk Analysis, Computational Intelligence, Numerical Methods, and Mathematical Models (1303).

The Prioritization process is dependent on the Cluster Modeling process in order to identify groups of investments that are collectively underperforming. In addition, Prioritization is also dependent on the Valuation process as the investment value may be used to assist in the rank ordering of the investments.

A fitness score is computed for each investment in question. For the current portfolio investments, the fitness score should reflect the overall asset performance based on the business value and risk as determined in the Investment Valuation process. Fitness is also computed for potential new investments. The fitness should reflect both the estimated business value of an investment as well as the associated risk.

The output of the Prioritization process is a rank ordering of the current assets according to their overall performance, and a rank ordering of potential portfolio additions according to their fitness. In each case, fitness is determined by a combination of the business value, the identification of the asset into a particular cluster, and the associated investment risk.

C) System Selection

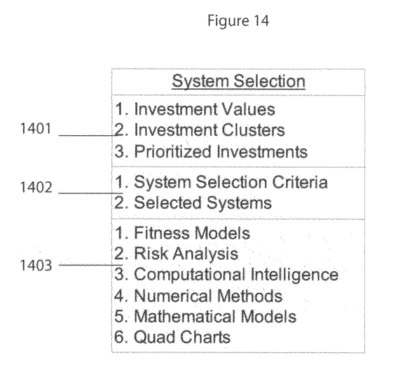

FIG. 14 shows the System Selection Process. The System Selection process determines a list of investments for deeper investigation based on the rankings from Prioritization Rationalization. The System Selection Process has the following inputs: Investment Values, Investment Clusters, and Prioritized Investments (1401). It also has the following outputs: System Selection Criteria, Selected Systems, and Organizational Best Practices (1402). The tools and techniques associated with this process are Fitness Models, Risk Analysis, Computational Intelligence, Numerical Methods, Mathematical Models, and Quad Charts (1403).

The System Selection process determines a list of investments for deeper investigation based on the rankings from Prioritization. This process examines the Investment Values and Investment Clusters, along with the lists of prioritized assets, to identify potential selection criteria for rationalization. The selection of investments as candidates for rationalization narrows the focus from the entire portfolio of investments to a selected set of investments. These selected investments are investigated further in the Portfolio phase.

The System Selection process does not produce a list of investments that should be rationalized. Rather, this process identifies the investments, when analyzed individually or according to their clusters, that appear to be potential Rationalization Targets. However, the Portfolio phase will make a final determination of investments for rationalization.

The output of the System Selection process is a set of System Selection Criteria and Selected Systems. The System Selection Criteria is determined by reviewing the Investment Values and Clusters with the Prioritized Assets. Each Investment Cluster is examined and ranked by the Investment Value. Typically, a cutoff value is determined by weighing the grouping of the Investment Values, the number of investments above/below the cutoff, and the amount of time required to analyze the selected investments. The investments on one side of the cutoff (above/below) make up the Selected Systems, while the remaining investments are considered weak rationalization targets.

A given investment may be in more than one Cluster. It may be the case that a specific investment is a weak rationalization target in one Cluster but a strong rationalization target in another Cluster. This demonstrates the multi-dimensional nature of non-financial investments and the utility of multiple Business Values. Assets demonstrating these characteristics should be carefully examined to assure that a rationalization of the investment does not do more harm where the portfolio is strong than good from rationalization where the portfolio is weak.

D) System Evaluation

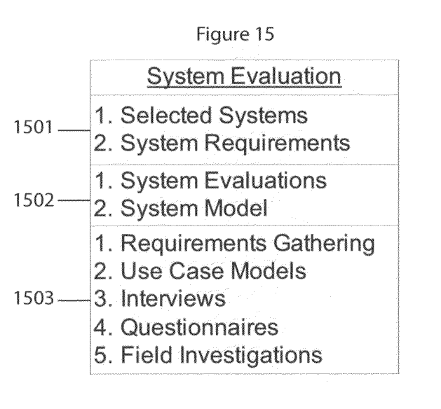

FIG. 15 shows the System Evaluation Process. System Evaluation examines the investments selected from the System Selection process and details the investment requirements, purpose, and functionality. The System Evaluation Process has the following inputs: Selected Systems and System Requirements (1501). It also has the following output: System Evaluations (1502). The tools and techniques associated with this process are Requirements Gathering, Use Case Models, Interviews, Questionnaires, and Field Investigations (1503).

The System Evaluation process examines the selected investments from the System Selection process. System Requirements, purpose, and functionality are detailed and documented. Requirements documentation may be completed by utilizing use cases to specify the various requirements. The use cases may then be diagrammed in a use case model.

The first output of the System Evaluation process is the System Model. This model analyzes groups of related assets and identifies the value of the system as a whole. The composite value may be different that the sum of the values of the individual investments. This value may be greater than the sum of the individuals, indicating that the investments work coherently together as a group to produce a greater value. Alternatively, the value may be less than the sum of the constituents, indicating that the system has redundant or overlapping components.

The second output of this process is the detailed System Evaluations. These requirements are examined during the Portfolio phase to identify redundancy, obsolescence, investment merger and division opportunities, opportunities for reuse, and requirements gaps. Detailed analysis of these requirements provides the means for identifying assets that are good candidates for rationalization.

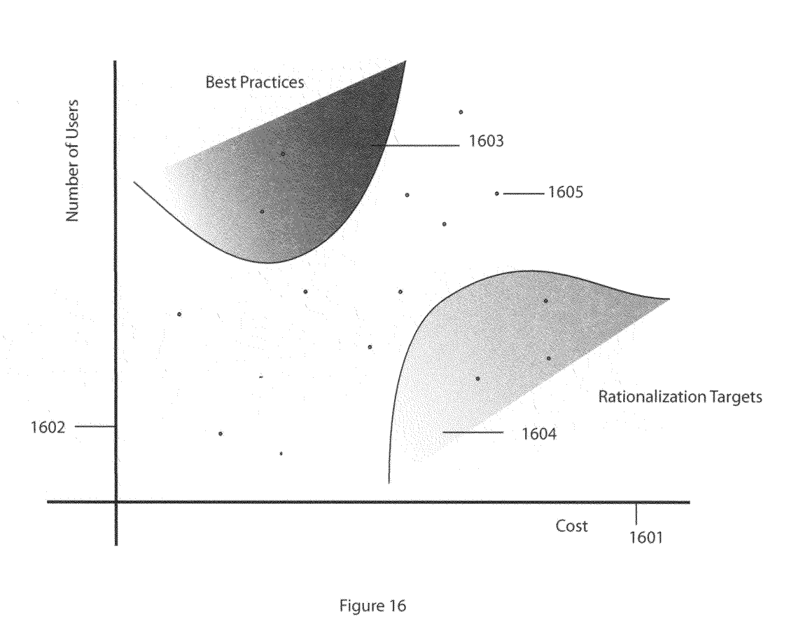

In one embodiment, System Selection uses quad charts to graphically present assets according to a two-variable valuation. Two asset valuation values are chosen and a group of investments are plotted accordingly. FIG. 16 is an example of a chart that represents assets as belonging to best practices or rationalization targets. Here, ‘cost’ is plotted on the x-axis (1601) and ‘number of users’ on the y-axis (1602). Here, assets in the upper left region are high ‘cost’ and low ‘number of users’. This region would be of interest to examine as these assets appear to provide little bang-for-the-buck. However, the assets in the lower right region are low ‘cost’ and high ‘number of users’. These assets generally provide high impact with little cost. Investments can also be separated into organizational Best Practices (1603) and Rationalization Targets (1604) contours. Additional assets, however, may be outside of these contours (1605).

System Model

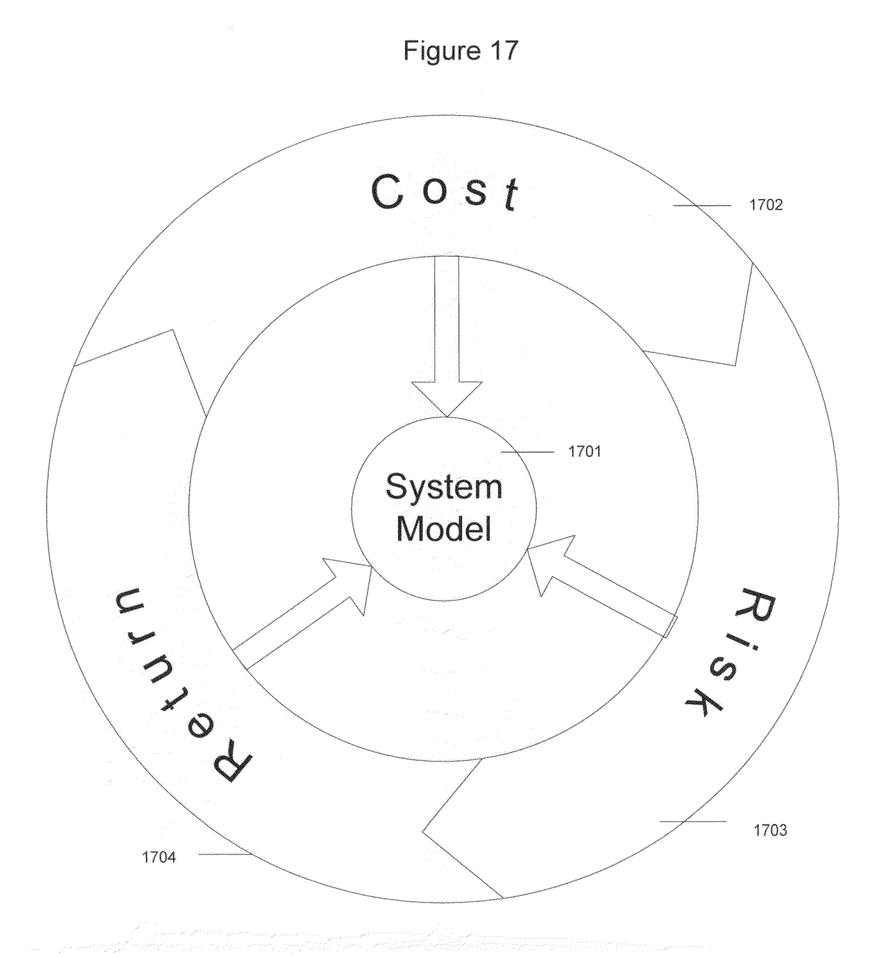

One of the outputs of the System Evaluation is the System Model. See FIG. 17. The System Model (1701) examines the investments at a system level. The System Model provides mathematical models to identify the additional benefits the system of investment obtains in excess of the sum of the constituent investments. The System Model (1701) is dependent upon the cost (1702), risk (1703) and return (1704).

The System Model is a model used to quantify the value, uncertainty, and performance of systems of investments grouped together. Systems are groups of investments that should be analyzed together because the value of the group may differ from the sum of the constituent parts.

In many cases, the value of the system is thought to be greater than the sum of the constituent investments. This additional value represents a value achieved from investments cooperating together to produce more efficient results than the individual investments would achieve in isolation. Alternatively, some systems may have a lower value that the sum of the constituent investments. This may be due to situations such as inefficiencies, overlapping functions, and inconsistencies between investments.

The System Model is the result of System Cost Analysis, System Risk Analysis, System Return Analysis, and System Model Analysis. This is in many ways similar to the structure around the Portfolio Model. This is due to the fact that both Systems and Portfolios are fundamentally groups of investments. However, Portfolios may contain entire Systems as components.

System Cost Analysis reviews the present and future costs for a system of investments. These processes incorporate the time value of money as a principal ingredient of their analysis.

System Risk Analysis examines uncertainties in the values computed from the System Model. These processes examine system risk as well as system sensitivity.

System Return Analysis quantifies the system return. In particular, the system benefits are quantified. The system benefits are the additional (or reduced) value associated with the system of investments above the sum of the constituent investments.

A) System Cost Analysis

System Cost Analysis in the System Model analyzes the present and anticipated future costs of the investments. The costs are used to quantify the return during System Return Analysis.

i) System Present Cost

System Present Cost examines the current and prior cost of the investments in the system. This analysis includes both fixed and variable costs to evaluate the present cost of the investment. The present cost is useful to the System Model for later computations of ROI. System Present Cost uses Performance and Risk Models to assist with the identification and quantification of current and past costs. In addition, this process examines potential Taxation Issues to effectively determine the cost.

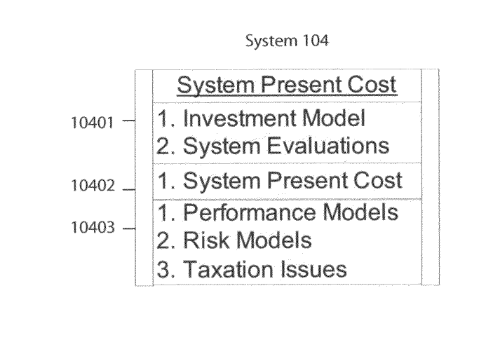

FIG. 104 shows the System Present Cost process. The System Present Cost Process has the following inputs: Investment Model and System Evaluation (10401). It also has the following output: System Present cost (10402). The tools and techniques associated with this process are Performance Models, Risk Models and Taxation Issues (10403).

ii) System Future Cost

System Future Cost addresses the present value of anticipated future costs of an investment. Future costs are typically discounted when computing their present value because of the time vale of money. System Future Cost examines known costs, potential costs, and estimates unknown costs.

Similar to System Present Cost, this processes used Performance and Risk Models and examines Taxation Issues. These issues are all evaluated in the light of the time value of money to determine the present value of the system.

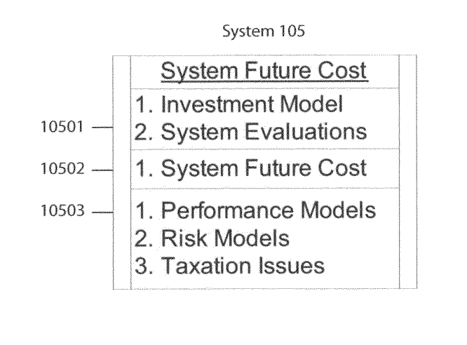

FIG. 105 shows the System Future Cost process. The System Future Cost Process has the following inputs: Investment Model and System Evaluations (10501). It also has the following output: System Future Cost (10502). The tools and techniques associated with this process are Performance Models, Risk Models and Taxation Issues (10503).

B) System Risk Analysis

System Risk Analysis quantifies the uncertainties in the system values. The values are the values associated with the composite system of investments, taken as a whole. The risk is the uncertainty in this composite value.

i) System Risk

The System Risk process quantifies the uncertainties in the System Values. These uncertainties are computed using similar error propagation models as in the Investment Model. The value for a system is often expressed as

$$S = Δ + {\sum }_{k} {I}_{k}$$

where Iₖ is the value of the k^{th} investment in the system and Δ is the additional value associated with the system as a whole. Δ is computed during the System Benefits process.

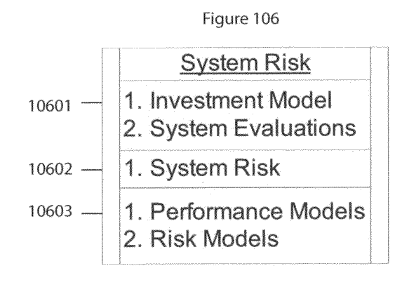

FIG. 106 shows the System Risk process. The System Risk Process has the following inputs: Investment Model and System Evaluations (10601). It also has the following output: System Risk (10602). The tools and techniques associated with this process are Performance Models and Risk Models (10603).

ii) System Sensitivity

System Sensitivity Analysis examines how sensitive the system values are with respect to perturbations in the underlying investment values. Sensitivity analysis attempts to discern how sensitive the future value of the system is due to the uncertainties in the underlying investment values.

Linear system valuation models similar to the one above typically do not exhibit a great deal of sensitivity. However, nonlinear models can provide a great deal of sensitivity, especially in the vicinity of singular points.

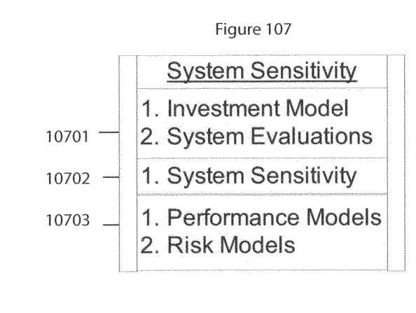

FIG. 107 shows the System Risk process. The System Risk Process has the following inputs: Investment Model and System Evaluations (10701). It also has the following output: System Sensitivity (10702). The tools and techniques associated with this process are Performance Models and Risk Models (10703).

C) System Return Analysis

System Return Analysis examines the potential returns that the system may incur. The returns may be in the form of System Benefits, System Expense Avoidance, or Projected System Returns. The processes in this group examine and attempt to quantify system returns.

i) System Benefits

System Benefits reviews the benefits that each investment brings to the overall system. The benefit is often quantified a value over and above the sum of the values of the constituent systems.

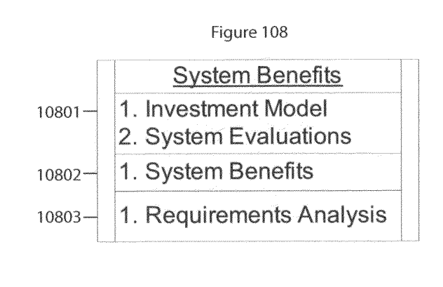

FIG. 108 shows the System Risk process. The System Risk Process has the following inputs: Investment Model and System Evaluations (10801). It also has the following output: System Benefits (10802). The tools and techniques associated with this process are Requirements Analysis (10803).

ii) System Expense Avoidance

System Expense Avoidance quantifies the savings the investments bring to the system. For example, a system of investments targeted toward regulatory compliance avoids the expense of costly fines that would have been levied but for the investments. This expense avoidance is a system benefit and is quantified in this process.

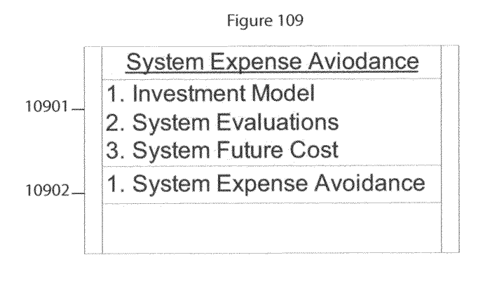

FIG. 109 shows the System Risk process. The System Risk Process has the following inputs: Investment Model, System Evaluations and System Future Cost (10901). It also has the following output: System Expense Avoidance (10902).

iii) Projected System Returns

Projected System Returns estimates the expected future returns for the system of investments. Estimating future returns is important as these may be measured against actual returns. This process allows for continual improvement of the estimating models.

This is important as portfolio rationalization may recommend new systems or investment be created in order to increase portfolio efficiency. The better the predictive models, the more reliable the results, and the more efficient the portfolio rationalization process becomes.

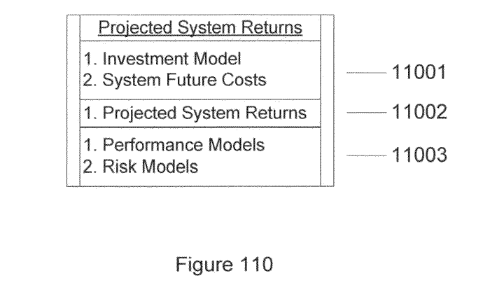

FIG. 110 shows the Projected System Returns process. The Projected System Returns Process has the following inputs: Investment Model and System Future Costs (11001). It also has the following output: Projected System Returns (11002). The tools and techniques associated with this process are Performance Models and Risk Models (11003).

D) System Model Analysis

The System Model Analysis combines the System Cost Analysis, System Risk Analysis, and System Return Analysis to formulate the System Model. The System Model is a mathematical representation of the value of the system. The model specifies, mathematically, how to compute the value of the system based on the values of the constituent investments and the system benefits.

i) System Regression Analysis

System Regression analysis is a statistical technique for creating models from data in a scatter-plot format. We may perform a least-squares best-fit of the scatter-plot data, and then use this fit to attempt to predict the future values of the system. Alternatively, we may interpolate how the value of the system benefits may change as the values of the underlying investments vary.

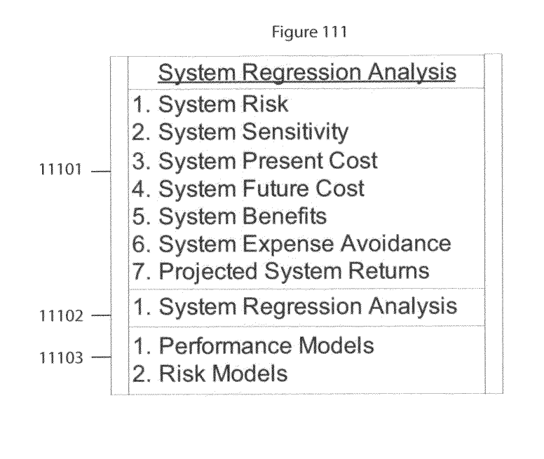

FIG. 111 shows the System Regression Analysis process. The System Regression Analysis Process has the following inputs: System Risk, System Sensitivity, System Present cost, System Future cost, System Benefits, System Expense Avoidance, and Projected System Returns (11101). It also has the following output: System Regression Analysis (11102). The tools and techniques associated with this process are Performance Models and Risk Models (11103).

ii) System Variation Analysis

System Variation Analysis examines the sensitivity and uncertainty in the regression analysis. These factors contribute to the overall uncertainty in the values produced from the System Model.

System Variation Analysis uses Performance and Risk models to estimate the uncertainty from the System Regression Analysis. This process reviews a wide range of system related information to conduct the uncertainty analysis.

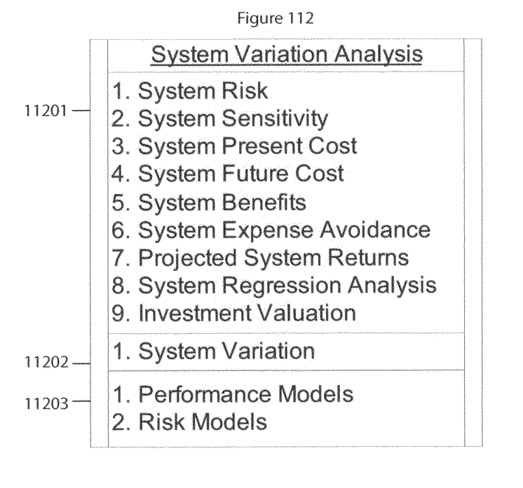

FIG. 112 shows the System Regression Analysis process. The System Regression Analysis Process has the following inputs: System Risk, System Sensitivity, System Present Cost, System Future Cost, System Benefits, System Expense Avoidance, Projected System Returns, System Regression Analysis and Investment Valuation (11201). It also has the following output: System Variation (11202). The tools and techniques associated with this process are Performance Models and Risk Models (11203).

iii) System Valuation

System Valuation identifies potential mathematical expressions for quantifying system value. In particular, this process examines the regression analysis from the System Regression Analysis along with the System Variation Analysis. Taken in conjunction, these represent potential system valuation models along with the error analysis for the model.

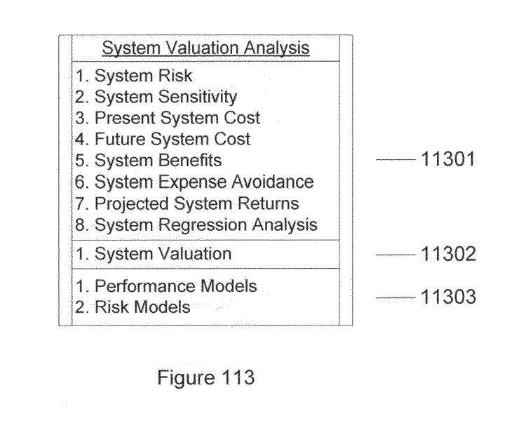

FIG. 113 shows the System Valuation Analysis process. The System Valuation Analysis Process has the following inputs: System Risk, System Sensitivity, System Present Cost, System Future Cost, System Benefits, System Expense Avoidance, Projected System Returns, and System Regression Analysis (11201). It also has the following output: System Valuation (11202). The tools and techniques associated with this process are Performance Models and Risk Models (11203).

iv) System Model Definition

System Model Definition reviews the mathematical models from System Valuation to determine the overall models used to compute the system values. This culminates in mathematical models used to compute the values of the system.

System Model Definition reviews many system related information including System Risk, System Sensitivity, Present System Cost, Future System Cost, System benefits, System Expense Avoidance, Projected System Returns, System Regression Analysis, System Variation, and System Valuation. All of this information can contribute to formulating a System Model appropriate for the system of investments under consideration.

Furthermore, we can have a System Model for every system of investments in the portfolio. The System Phase may be repeated for each system in the portfolio producing a unique System Model for each. When we discuss the System Model in the Portfolio Phase, we are referring to the collection of all System Models.

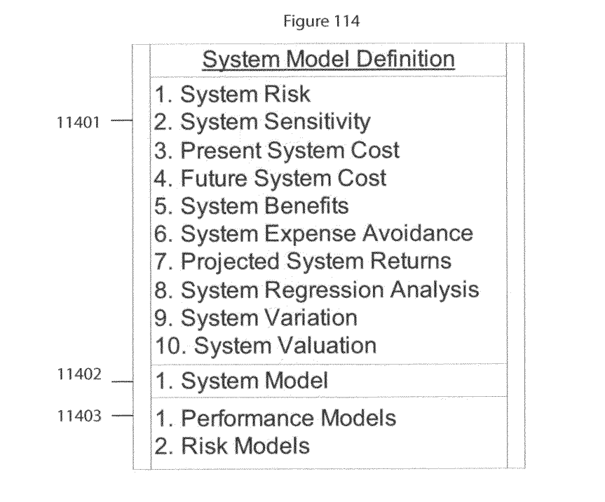

FIG. 114 shows the System Model Definition process. The System Model Definition Process has the following inputs: System Risk, System Sensitivity, Present System Cost, Future System Cost, System Benefits, System Expense Avoidance, Projected System Returns, System Variation and System Valuation (11401). It also has the following output: System Model (11402). The tools and techniques associated with this process are Performance Models and Risk Models (11r03).

Portfolio

The Portfolio phase focuses on analyzing the portfolio as a whole and makes recommendations for investment rationalization. This is distinct from the System phase because although the System phase examines groups of investments, it does not analyze the portfolio as a whole. The Portfolio phase represents the culmination of portfolio rationalization and results in specific recommendations for investment action.

This phase is divided into seven processes: Portfolio Value Definition, Portfolio Valuation, Strategic Alignment, Strategic Direction, Rationalization Selection, Best Practice Identification, and Transformation. Essentially, these processes assess where the portfolio currently stands, where one of skill in the art would want it to be, and how to get there. One or more of these processes may be used at one time.

The Portfolio Value Definition process is similar to the Business Valuation Definition process but applies to the portfolio as a whole rather than the individual investments. The Portfolio Value Definition process creates a Portfolio Model similar to the Investment Model from the Business Valuation Definition process.

Portfolio Valuation is similar to Investment Valuation. In this process, the portfolio is assigned one or more values which are used to measure the overall performance of the portfolio. This process may implement Computational Intelligence, Numerical Methods, or Mathematical Models to value and measure the portfolio.

The Strategic Alignment process analyzes the portfolio investments and clusters to determine how well each is aligned to the Business Strategy and Business Vision. The Strategic Alignment process determines the current state of the portfolio and how well the overall portfolio is aligned with the business goals, which areas are well aligned, and which areas are misaligned.

The Strategic Direction process examines the portfolio investments and identifies specific target goals and future directions for the portfolio. Specifically, the Strategic Direction specifies the desired future state for the portfolio.

The Rationalization Selection process identifies specific investments as rationalization targets. Rationalization Selection examines the Business Strategy and Vision, the Portfolio Valuation and Performance, System Evaluations, and Strategic Alignments and Recommendations to determine the appropriate investments for rationalization.

Best Practice Identification discovers the investments that are performing well and determines the fundamental reasons for their performance. This leads to the identification of organizational Best Practices. These Best Practices may be applied to other investments to improve the overall performance of the portfolio.

The Transformation process develops a detailed plan for how the portfolio will reach the desired future state. This is an action plan providing specific recommendations for changes to particular investments. Moreover, this plan demonstrates how these recommendations will help to achieve the desired future portfolio state.

A) Portfolio Value Definition

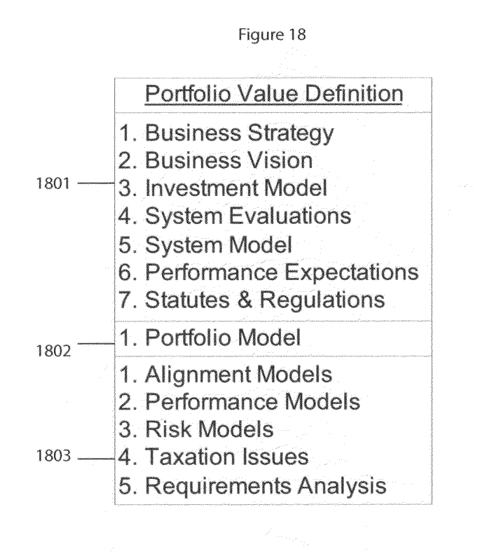

FIG. 18 shows the Portfolio Value Definition Process. Portfolio Value Definition determines the Portfolio Model used to measure the performance and uncertainty of the portfolio. The Portfolio Value Definition Process has the following inputs: Business Strategy, Business Vision, Investment Model, System Evaluations, Performance Expectations, and Statutes and Regulations (1801). It also has the following output: Portfolio Model (1802). The tools and techniques associated with this process are Alignment Models, Performance Models, Risk Models, Taxation Issues, and Requirements Analysis (1803).

The Portfolio Value Definition process specifies the Mathematical Models, Numerical Methods, and/or Computational Intelligence techniques used to measure the performance and uncertainty of the portfolio. The portfolio value(s) are specified as one or more numbers with their associated uncertainties.

The Portfolio Value Definition uses the Business Strategy and Vision along with the Investment Model and System Evaluations to determine the Portfolio Model. The Business Strategy and Vision are used as a guide to identify which aspects of the portfolio are most important to quantify. As the portfolio value is based on the business values of the investments in the portfolio, the portfolio value requires an understanding of the Investment Model. Finally, the System Evaluations are used to determine the potential areas of interest for quantifying the values with respect to the requirements.

Based on these inputs, the Portfolio Value Definition process specifies the Portfolio Model. The Portfolio Model is chosen to reflect the various measures that may be used to compute the performance of the portfolio as a whole based on the individual Investment Values.

B) Portfolio Valuation

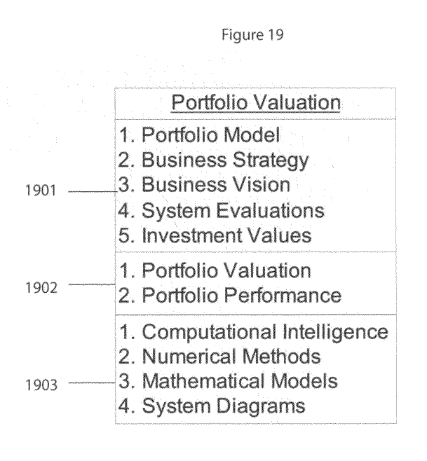

FIG. 19 shows the Portfolio Valuation Process. Portfolio Valuation Analysis examines the regression models and variations to identify potential values that may be used to measure portfolio performance. The Portfolio Valuation Process has the following inputs: Portfolio Model, Business Strategy, Business Vision, System Evaluations, and Investment Values (1901). It also has the following outputs: Portfolio Valuation and Portfolio Performance (1902). The tools and techniques associated with this process are Computational Intelligence, Numerical Methods, Mathematical Models, and System Diagrams (1903).

Portfolio Valuation is the process of quantifying the value of the portfolio and determining the Portfolio Performance. This process computes the portfolio value(s) by applying the Portfolio Model to the Investment Values, taking into account the Business Strategy, Business Vision, and Investment Values.

Portfolio Valuation may use analysis techniques such as Computational Intelligence, Numerical Methods, and Mathematical Models. These are valuable techniques for understanding the complex interactions between the investments that comprise the portfolio. The outputs of the Portfolio Valuation process are the actual Portfolio Valuation and the Portfolio Performance. A wide variety non limiting techniques may be used to compute the values, uncertainties, and performance of the investment portfolio. The Portfolio Model specifies the particular set of valuation techniques to compute.

C) Strategic Alignment

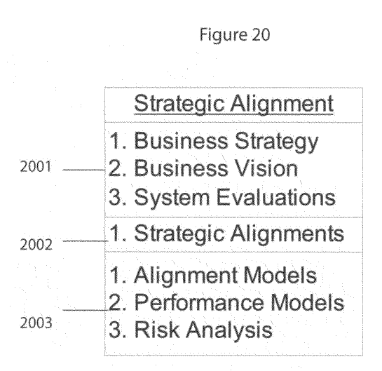

FIG. 20 shows the Strategic Alignment Process. The Strategic Alignment process analyzes the portfolio investments to identify areas that are aligned with the Business Vision and areas that are not. The Strategic Alignment Process has the following inputs: Business Strategy, Business Vision, and System Evaluations (2001). It also has the following output: Strategic Alignments (2002). The tools and techniques associated with this process are Alignment Models, Performance Models, and Risk Analysis (2003).

The Strategic Alignment process analyzes the portfolio investments to identify areas that are aligned with the Business Vision and areas that are not. The Business Strategy is a statement of the business mission, vision, and objectives. The Business Vision is a particular portion of the Business Strategy specifically targeted toward the desired future state of the business. The Strategic Alignment process evaluates the current and potential new investments to determine how well these investments are aligned with the Business Strategy and Vision.

The Strategic Alignment process depends on the Cluster Modeling process of the System Analysis phase. The investment groupings identified by the Cluster Modeling process are used to evaluate how well groups of investments are aligned with the overall Business Strategy. Moreover, these groupings can be used to determine how well asset groups are aligned with the Business Vision.

This process also determines the overall performance of the portfolio as a whole. The performance measure may be as simple as profit or ROI, or it may be a more complicated model accounting for the strategic value of individual assets. In any case, one main output of the Strategic Alignment process is an evaluation of the overall Portfolio Performance, the performance of asset clusters, and the performance of individual investments. In this manner, the Strategic Alignment process is able to assess how well the portfolio is currently performing. The performance may be measured simply on the basis of overall ROI, or the performance may be evaluated in more complicated terms, weighing the Strategic Alignment of the investments.

D) Strategic Direction

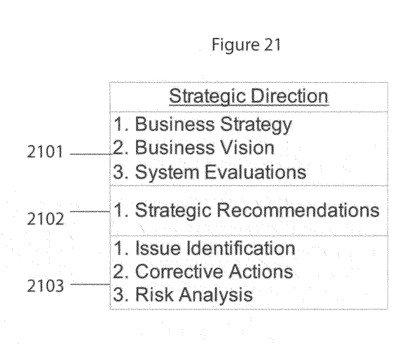

FIG. 21 shows the Strategic Direction Process. The Strategic Direction process reviews the cluster model, investment prioritization, and investments selected for rationalization to evaluate which investments are performing well and identify problem assets. The Strategic Direction Process has the following inputs: Business Strategy, Business Vision, and System Evaluations (2101). It also has the following output: Strategic Recommendations (2102). The tools and techniques associated with this process are Issue Identification, Corrective Actions, and Risk Analysis (2103).

The Strategic Direction process reviews the cluster model, investment prioritization, and investments selected for rationalization to evaluate which investments are performing well and identify problem assets. In addition, the Strategic Direction process also incorporates the Business Strategy and Vision into its analysis to determine what changes should be made to the portfolio in order to achieve the vision.

The Strategic Direction process depends on the Cluster Modeling process and the Prioritization process. The Cluster Modeling process is important because the cluster model identifies groups of investments with similar properties. This grouping is useful to quickly identify problem areas within the portfolio. Prioritization is important because the prioritized lists of current and potential assets may be used to measure how well these assets are conforming to the Strategic Direction.

The Strategic Direction process analyzes these problem groups and prioritization lists to determine if there is a more general issue affecting the investments. If a general issue is identified, Portfolio Performance may be substantially enhanced by correcting the more general issue. In this manner, several investments may be simultaneously improved by a single corrective action.

In addition, the Strategic Direction process is dependent on the Prioritization process of the System phase. The Prioritization process results in an investment priority list that is used by the Strategic Direction process to identify the immediate areas for improvement. The assets that have a high priority for rationalization are analyzed first as these investments are predicted to have the most potential for improvement. The prioritization list is the keystone for the efficient and effective administration of the Strategic Direction process.

Finally, the most important input for the Strategic Direction process is the Business Vision. The Business Vision is a document from the business owners specifying how they would like to see the business evolve over time. This statement provides the basis for understanding the overall direction of the organization.

The main result of this process is the Strategic Direction document. This document details recommendations for changes to the portfolio investments in order to achieve the desired Business Vision. These recommendations are directed toward what needs to be done in order to align the portfolio with the Business Vision.

E) Rationalization Selection

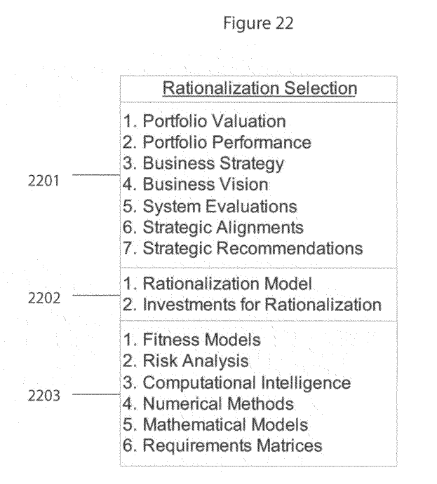

FIG. 22 shows the Rationalization Selection Process. Rationalization Selection identifies specific investments targeted for rationalization. The Rationalization Selection Process has the following inputs: Portfolio Valuation, Portfolio Performance, Business Strategy, Business Vision, System Evaluations, Strategic Alignments, and Strategic Recommendations (2201). It also has the following outputs: Rationalization Model and Investments for Rationalization (2202). The tools and techniques associated with this process are Fitness Models, Risk Analysis, Computational Intelligence, Numerical Methods, Mathematical Models, and Requirements Matrices (2203).

The Rationalization Selection process identifies the particular investments that are targeted for rationalization. This process examines the Portfolio Performance/Valuation, Business Strategy/Vision, Investment Values, and System Evaluations to determine the optimal mix of investments for rationalization.

The Portfolio Performance and Valuation is used to identify particular areas of the portfolio that are performing well and areas that need improvement. This information is combined with the Business Vision and Strategy to evaluate the performance of the portfolio in the light of the business goals and strategy. The Investment Values further identify individual investments that may need rationalization.

All of this information may be combined with the System Evaluations to construct the Rationalization Model. These requirement details allow for the specification of requirement matrices. The requirement matrices are used to quickly identify redundancies and gaps in the requirements. Furthermore, the individual requirements may be examined to identify obsolete systems and systems/resources that may be reused.

Finally, based on the portfolio and investment performances, opportunities for investment merger or division may be identified. Some investments may benefit from economies of scale by merging two or more investments into a single system. This is often the case when the investment portfolio is the result of a corporate merger or acquisition. Alternatively, some large investments may benefit by being divided into smaller components. For example, many large projects suffer from a large number of communications lines. If there are isolated components within the project, it may be better to spin the isolated components off into their own independent project to reduce the communication lines and create a more efficient portfolio.

All of this information may be combined to create the Rationalization Model. The purpose of this model is to evaluate and select specific investments for rationalization. The Rationalization Model may be a mathematical model, or this may be a manual process of evaluating and selecting appropriate investments.

F) Best Practice Identification

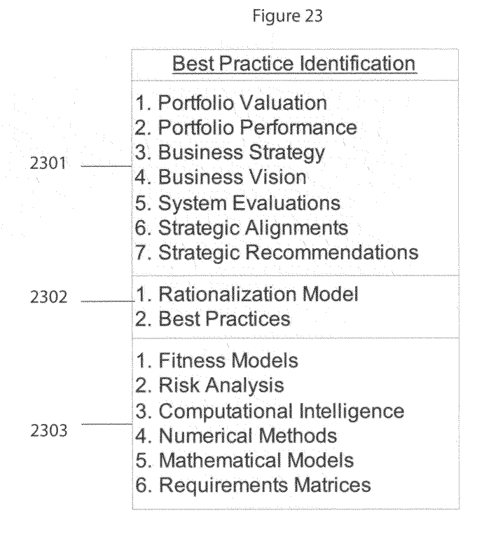

FIG. 23 shows the Best Practice Identification Process. Best Practice Identification identifies the investments that are performing well and investigates the reasons for their good performance. The Best Practice Identification Process has the following inputs: Portfolio Valuation, Portfolio Performance, Business Strategy, Business Vision, System Evaluations, Strategic Alignments, and Strategic Recommendations (2301). It also has the following outputs: Rationalization Model and Best Practices (2302). The tools and techniques associated with this process are Fitness Models, Risk Analysis, Computational Intelligence, Numerical Methods, Mathematical Models, and Requirements Matrices (2303).

For this process, the investments that are performing well are reviewed and investigate the reasons for their good performance. This information is captured in the Rationalization Model so that it may be applied to other investments in the portfolio during Transformation.

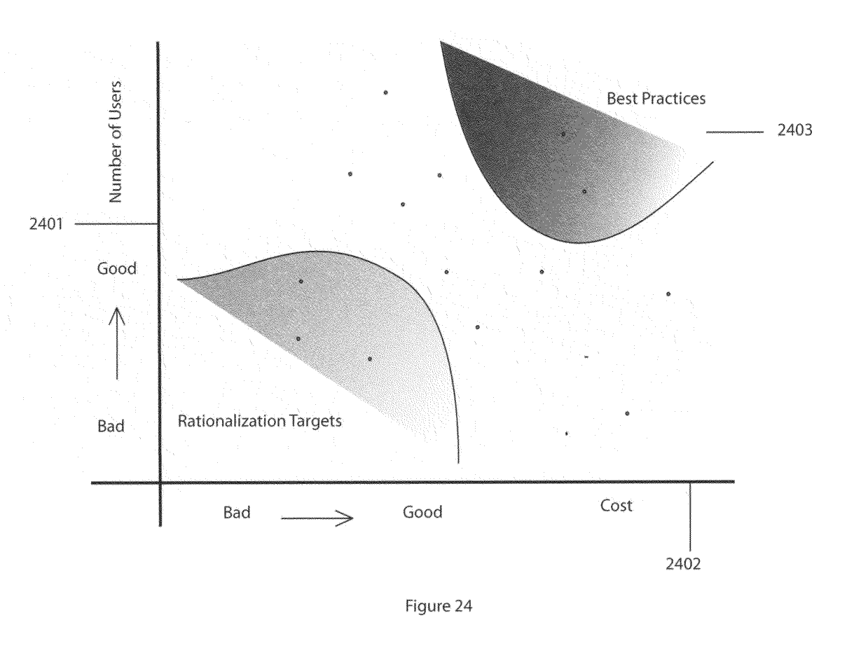

FIG. 24 is an example of Best Practices and Rationalization Targets. Here, investments are values according to ‘Number of Users’ (2401) and ‘Cost’ (2402). A diagram is created plotting each asset for this two-dimensional valuation. Investments that have high ‘Cost’ and low ‘Number of Users’ are targets for rationalization. Alternatively, assets that have a low ‘Cost’ and a high ‘Number of Users’ are Best Practices (2403).

Similar to Rationalization Selection, Best Practice Identification examines the Portfolio Performance/Valuation, Business Strategy/Vision, Investment Values, and System Evaluations to determine the investments which are performing well. This information is combined with the System Evaluations to determine the fundamental reasons that underlie their performance.

Understanding the reasons for the better performance of these investments leads to identification of organizational Best Practices. The Best Practices may align with Best Practices recognized in the industry. In this case, guidance from industry standards may be used to further improve the performance. Alternatively, the identified Best Practices may be unique to the organization. In this case, it is important to conduct a detailed examination to identify why these investments work so well within the organization. These practices are of particular importance as they may not be generally known to the Investment Owners or other Rationalization Managers within the organization.

These Best Practices are also incorporated into the Rationalization Model. By incorporating this information, the Rationalization Model can identify investments that represent the portfolio ideal and direct the rationalization effort to enhancing other investments by incorporating Best Practices.

G) Transformation

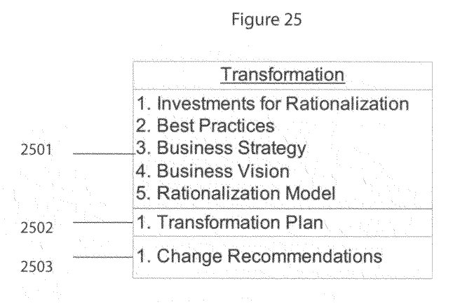

FIG. 25 shows the Transformation Process. The Transformation Plan details what investments should be rationalized, what actions should be taken, and how to proceed enacting the rationalization process. The Transformation Process has the following inputs: Investments for Rationalization, Best Practices, Business Strategy, and Business Vision (2501). It also has the following output: Transformation Plan (2502). The tool and technique associated with this process is Change Recommendations (2503).

The Transformation process documents specific actions that should be performed to affect the Strategic Direction Document. The Transformation is an action plan detailing specific actions that need to be carried out in order to move the portfolio from its current state to the desired future state.

The Transformation process depends on both the Strategic Alignment and Strategic Direction processes. The Strategic Alignment documents where the portfolio currently stands, whereas the Strategic Direction process determines where it needs to go. The Transformation process is used to figure out how to get from here to there.

The Transformation process also depends on the Rationalization Selection and Best Practice Identification processes. These processes identify the investments that need rationalization as well as the organizational Best Practices. The Best Practices may be applied to the Rationalization Targets to improve their performance.

The main output of the Transformation process is the Transformation Plan. The Transformation Plan is a report providing details on what steps need to be taken in order to achieve the desired goals. This report is the main output of portfolio rationalization and provides the fundamental rationale for making changes to the portfolio investments. The Transformation Plan report may be any tangible form suitable for one of skill in the art to view and manipulate, including by not limited to, printed on paper, produced as a graphical representation on a computer monitor, and the like.

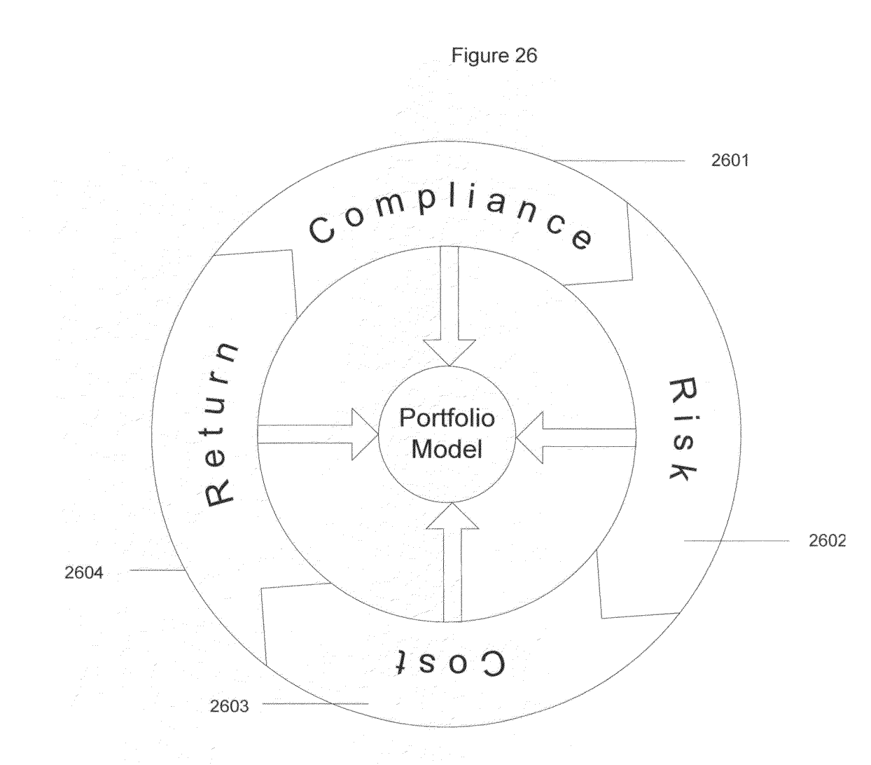

The output of the Portfolio Value Definition (FIG. 18) is the Portfolio Model (see FIG. 26). The Portfolio Model reviews the portfolio as a whole and identifies additional value from the alignment of the individual investments and systems with the strategic direction of the portfolio. The alignment of the investments with the strategic direction can produce additional value for the portfolio. The Portfolio Model is dependent upon compliance (2601), risk (2602), cost (2603) and return (2504).

Process Dependencies

The processes may be interdependent because inputs to some processes are the outputs from other processes. The dependencies should be interpreted as a requirement to begin a process. For example, the Category Definition process cannot be initiated the first time until the Portfolio Snapshot process is complete. Once these processes are each initialized, they may continue to operate without requiring a dependent process to be executed. For instance, once the entire process has initiated, one of skill in the art may want to include an additional category as part of the Investment Categories. In this case, the Category Definition process is updated without first updating the Portfolio Snapshot. Once the Category Definition is rerun, the remaining processes can be executed and eventually obtain an updated Transformation Plan even though Portfolio Snapshot was not rerun. In this respect the processes may be considered to be running independently and parallel to one another. This is useful as portfolio rationalization should be considered a continuous, ongoing process rather than a one-time project.

Furthermore, the processes do not need to run in a strictly linear fashion. The processes may run continually and even incorporate feedback from downstream processes. For example, the Portfolio Valuation process may identify the need for a new category and notify the Category Definition process to update. In this case, the Portfolio Valuation process may choose to wait until this update is processed through the entire stream of rationalization. Alternatively, the Portfolio Valuation process may finish executing and proceed to the next steps, and allow the new category to take effect in future executions of the rationalization process.

Further, the life cycle for portfolio rationalization is an initiation phase followed by an auto-iterative cycle. After the rationalization process is initially executed, the auto-iterative cycle takes over and each of the processes can be triggered by the results of any other process. Thus, the final output of portfolio rationalization may prompt an update to the Investment Categories, Business Value Definition, Cluster Modeling, etc. If an update is indicated, the governing process is rerun incorporating the updated information. This may be modifying an Investment Category, a Numerical Method, or the process itself. In any case, once the governing process is rerun, the processes that follow in the dependency chain are also rerun. This eventually terminates in a new, updated Transformation Plan.

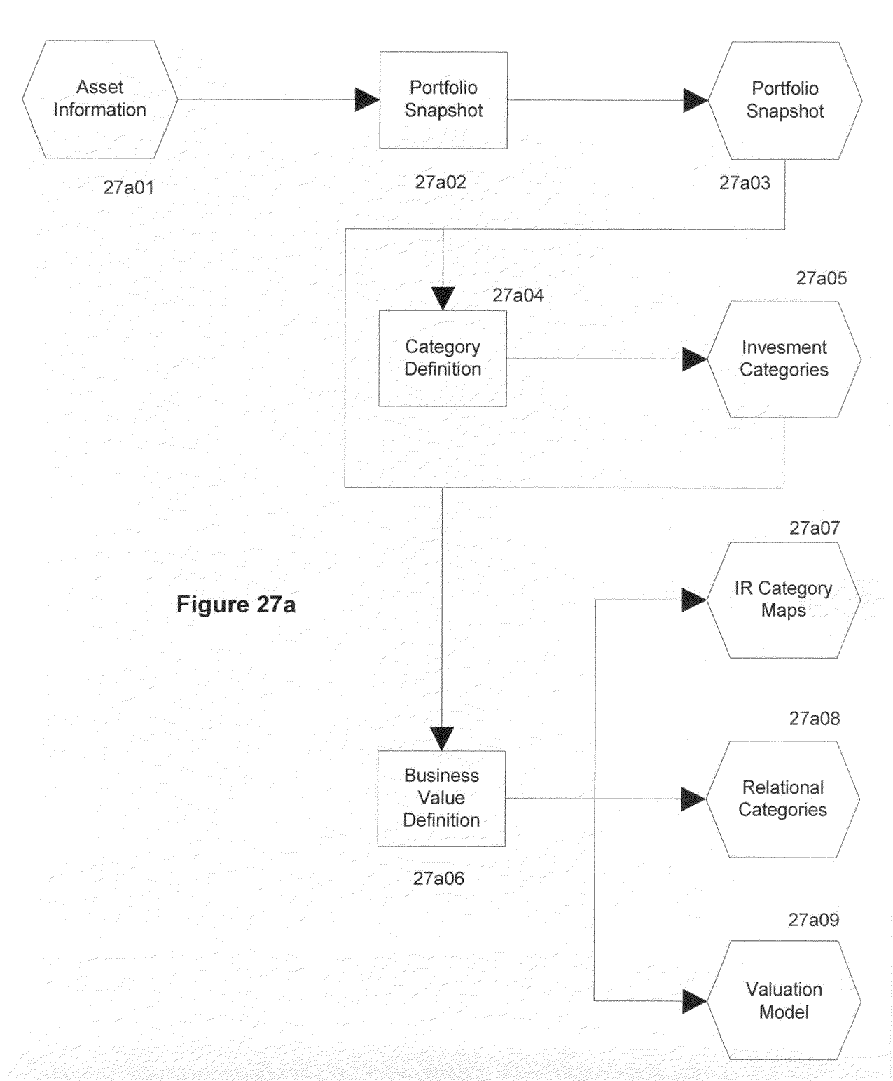

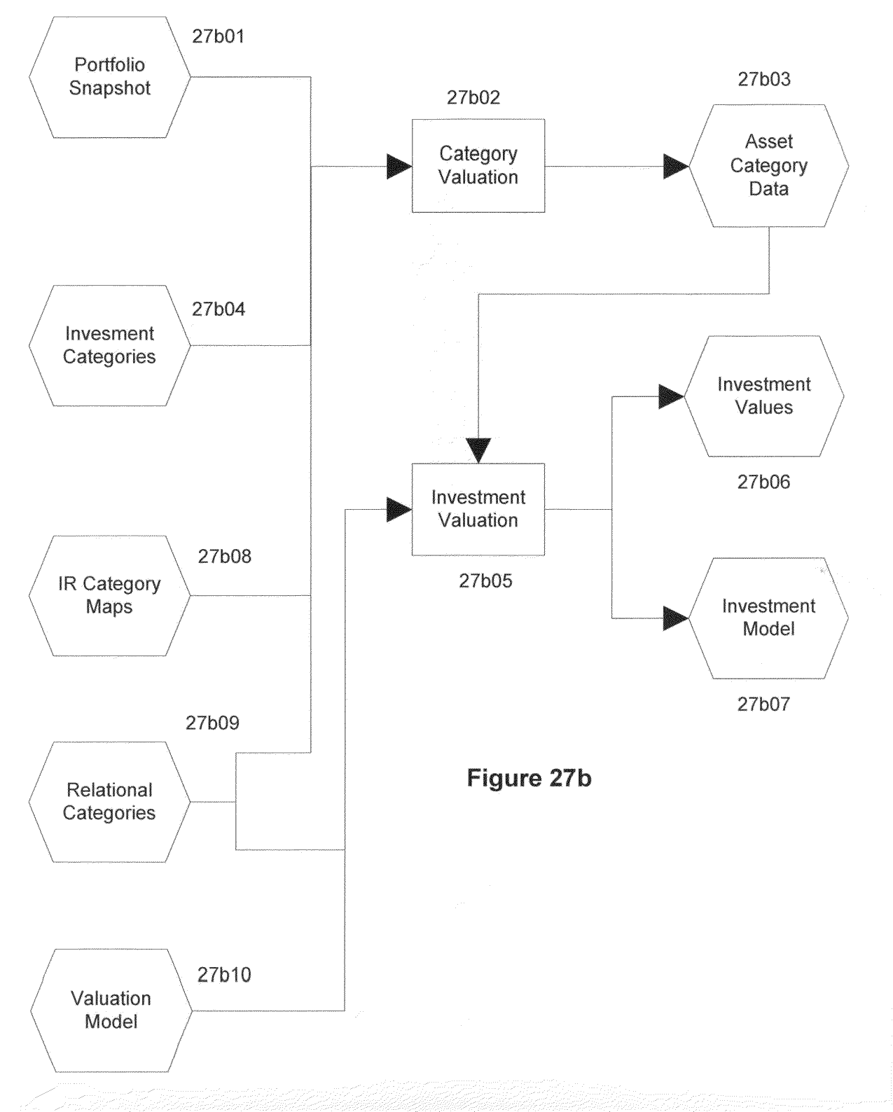

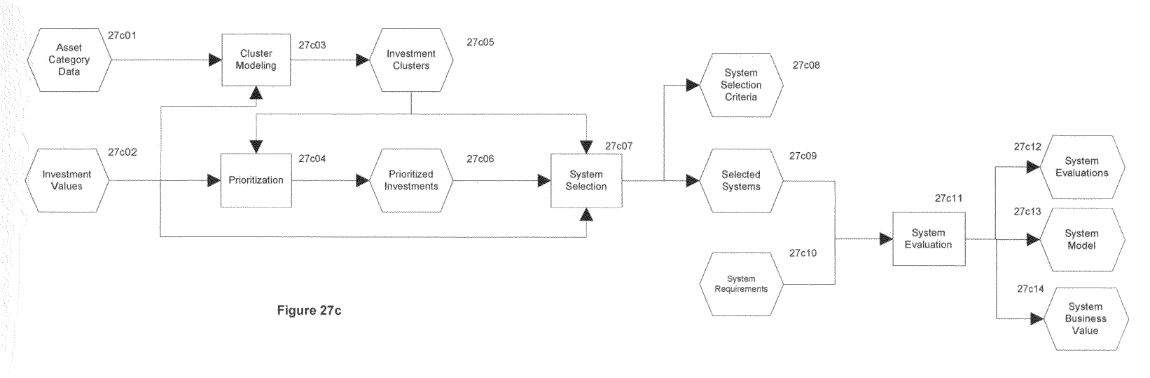

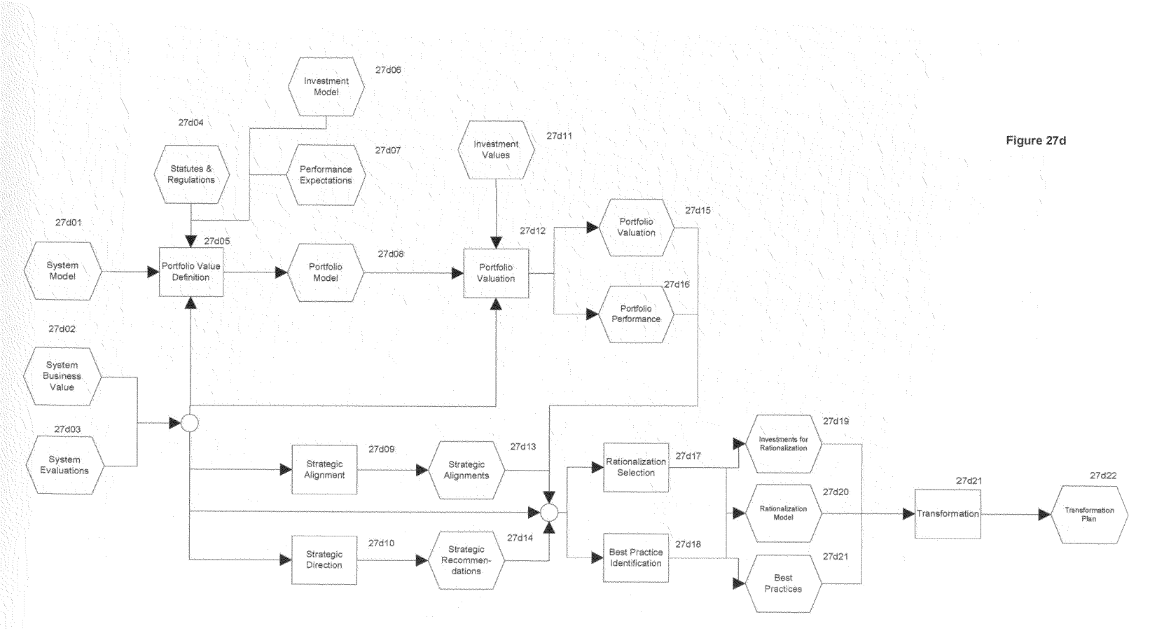

FIG. 27a-d diagrams the flow of process inputs and outputs. Inputs and outputs are displayed as hexagons, while processes are shown as squares. FIG. 27a-d indicates a linear process starting from the Portfolio Snapshot, continuing through various processes, and ending with the Transformation Plan. For instance, in FIG. 27a, the input asset information 27a01 is used in the process Portfolio Snapshot27a02 to generate a Portfolio Snapshot output 27a03. This Portfolio Snapshot output 27a03 serves as an input to the Category Definition 27a04 process, which outputs Investment Categories 27a05. The Portfolio Snapshot output 27a03 and Investment Categories 27a05 also serve as inputs to the Business Value Definition process 27a06, which outputs the IR Category Maps 27a07, Relational Categories 27a08 and Valuation Model 27a09.

As shown in FIG. 27b, the Portfolio Snapshot, Investment Categories, IR Category Maps, Relational Categories and Valuation Model (27b01, 04, 08, 09 and 10, respectively) of FIG. 27a also serve as inputs to the Category Valuation 27b02 and Investment Valuation 27b05 processes. Further, the output of the Category Valuation 27b02 process, Asset Category Data 27b03, also serves as an input to the Investment Valuation 27b05 process. The Investment Valuation 27b05 processes outputs Investment Values 27b06 and Investment Model 27b07.

As shown in FIG. 27c, the Asset Category Data 27c01 output serves as an input for Cluster Modeling 27c03, which outputs Investment Clusters 27c05. The Investment Clusters 27c05 can serve as inputs to two different processes: Prioritization 27c04 and System Selection 27c07. Further, the Investment Values 27c02 serves as inputs for three processes: Cluster Modeling 27c03, Prioritization 27c04, and System Selection 27c07. Further, the Prioritization 27c04 output, Prioritized Investments 27c06, also serves as an input for System Selection 27c07. The process of System Selection 27c07 has two outputs: System Selection Criteria 27c08 and Selected Systems 27c09. The Selected Systems 27c09 and System Requirements 27c10 serve as inputs for the System Evaluation process 27c11, which outputs three things: System Evaluation 27c12, System Model 27c13 and System Business Value 27c14.

As shown in 27d, System Model 27c13 and System Business Value 27c14 serve as inputs to six different processes: Portfolio Value Definition 27d05, Portfolio Valuation 27d12, Strategic Alignment 27d09, Strategic Direction 27d10, Rationalization Selection 27d17 and Best Practice Identification 27d18. System Model 27d01, Statutes & Regulations 27d04, Investment Model 27d06 and Performance Expectations 27d07 also serve as inputs to the Portfolio Value Definition 27d05 process, which outputs the Portfolio Model 27d08. The Portfolio Model 27d08 and Investment Values 27d11 also serve as inputs to the Portfolio Valuation process 27d12, which outputs two things: Portfolio Valuation 27d15 and Portfolio Performance 27d16. The output from Strategic Alignment 27d09, Strategic alignments 27d13, and the output from Strategic Direction 27d10, Strategic Recommendations 27d14, both serve as inputs to the Rationalization Selection 27d17 and Best Practice Identification 27d18. These two processes, Rationalization Selection 27d17 and Best Practice Identification 27d18, have three different outputs: Investment for Realization 27d19, Rationalization Model 27d20 and Best Practices 27d21. These same three outputs serve as inputs to the Transformation process 27d1, which outputs a Transformation Plan 27d22.

However, the portfolio rationalization life cycle is not a strictly linear process. Each of these processes may run continuously and independently. In addition, downstream processes may provide feedback to upstream processes. In this sense, the portfolio rationalization life cycle is a continuous activity that feeds back on itself. Any process on the chain may prompt an update for a different process. This will start a new cycle of updates to the processes as each dependent process is rerun. If the process is an upstream process, this may cause a temporary halt as previous processes are updated and rerun. Alternatively, execution may continue while the upstream process is updated.

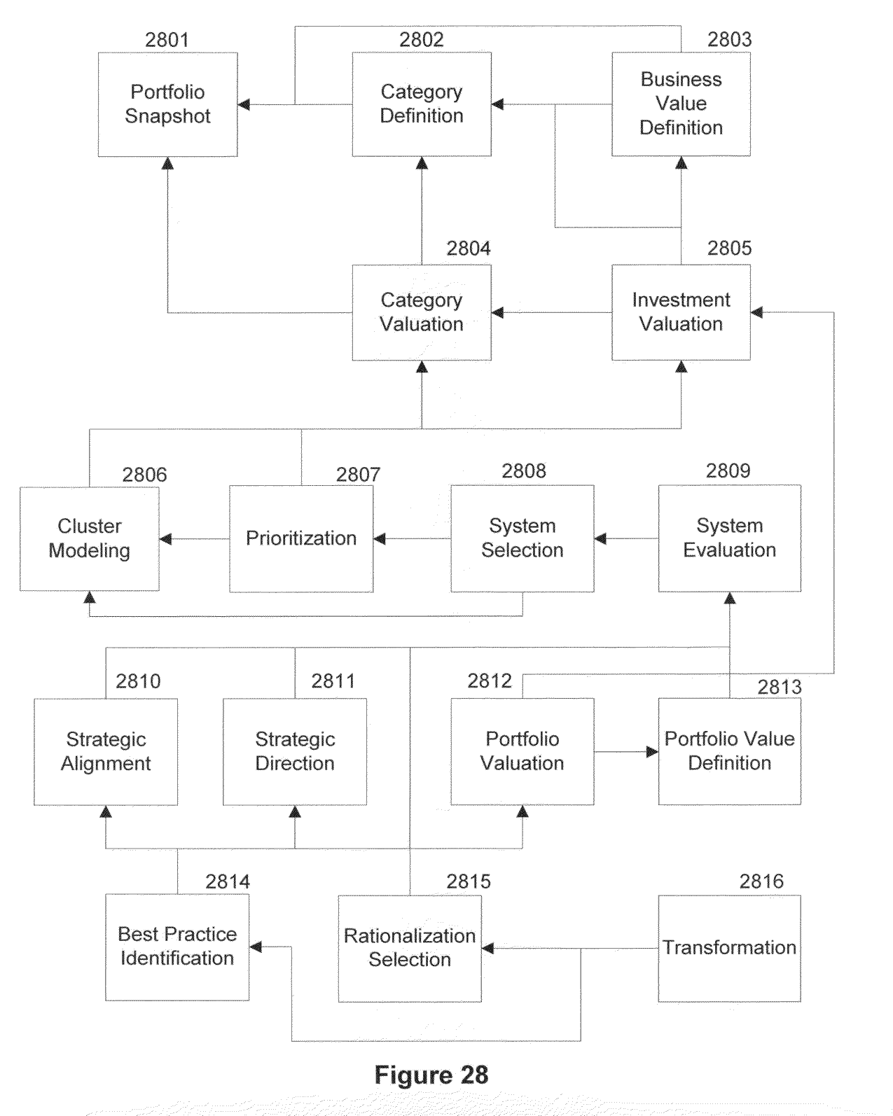

FIG. 28 diagrams the portfolio rationalization process dependencies, with the arrow indicating the process is dependent upon another process. Here, Transformation 2816 is dependent upon Rationalization Selection 2815 and Best Practice Identification 2814. Best Practice Identification 2814 is dependent upon Strategic Alignment 2810, Strategic Direction 2811 and Portfolio Valuation 2812. The Rationalization Selection 2815, Strategic Alignment 2810, Strategic Direction 2811 are all dependent upon the System Evaluation 2809. The Portfolio Valuation 2812 is dependent upon the Portfolio Value Definition 2813 and the Investment Valuation 2805. In return, the Portfolio Value Definition 2813 is also dependent upon the System Evaluation, which depends upon the System Selection 2808, which depends upon both the Prioritization 2807 and the Cluster Modeling 2806. The Prioritization is dependent upon not only the Cluster Modeling 2806. The Prioritization 2807 and Cluster Modeling 2806 are both dependent upon Category Valuation 2804 and Investment valuation 2805. Investment Valuation 2805 is dependent upon the Category Valuation 2804, Business Value Definition 2803 and Category Definition 2802. The Category Valuation is dependent upon both the Portfolio Snapshot 2801 and the Category Definition 2802. Finally, the Business Value Definition 2803 is dependent upon both the Category Definition 2802 and the Portfolio Snapshot 2801.

The interdependency of these processes, together with the fact that each process may run independently and concurrently with the others, make the entire portfolio rationalization lifecycle a dynamic recurrent network. The network is dynamic because each of the processes is able to update and modify the portfolio rationalization process. In addition, the network is recurrent because the processes are interconnected with processes feeding information to each other, making recurrent network connections.

FIG. 1 is a graphical representation of the portfolio rationalization life cycle. This diagram shows the Valuation, Investment, and System phases working in a cycle, while each of these phases feeds the Portfolio phase. Furthermore, the results of the Portfolio phase can feed and update each of the other phases, restarting the cycle. This auto-iterative life cycle provides flexibility to the portfolio rationalization methodology, allowing it to adjust to new situations and the unexpected results which often occur as the Business Strategy and Vision change.

Investment Model

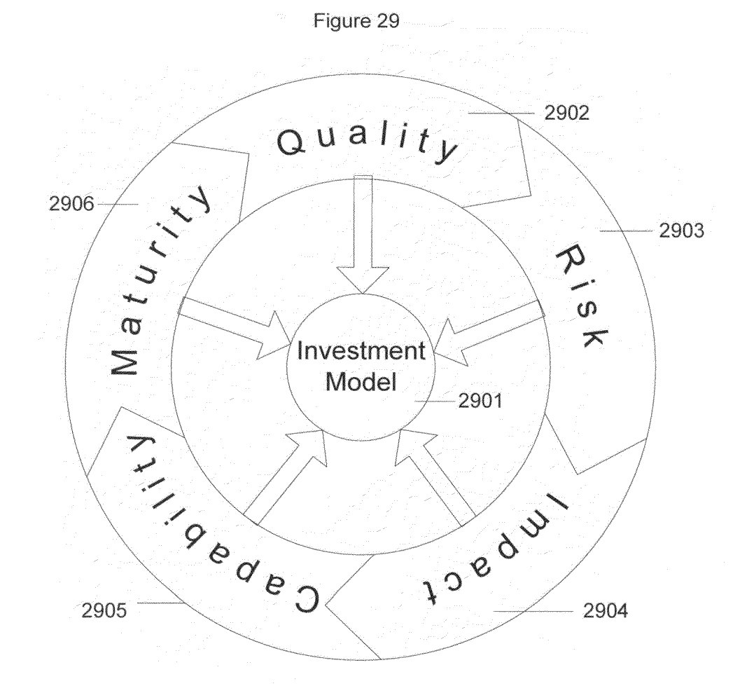

The Investment Model is the means used to assign Business Value to each of the portfolio investments. The model should incorporate the essential factors that make the investment important to the organization, but not contain so much information as to become overburdened and overly complex. In addition, the model should identify values that are comparable between significant numbers of investments. FIG. 29 illustrates how the Investment Model (2901) works. In sum, it is dependent upon the quality (2902), risk (2903), impact (2904), capability (2905) and maturity (2906) of the values.

Assessing business value is a key element to portfolio rationalization. Business value can be difficult to determine for non-financial assets. This section reviews some of the factors that may be considered when assessing business value. Specific factors presented here may not be important for some investments, and it is anticipated that a given portfolio may not use all of the factors listed here. Similarly, these factors are not intended to be an exhaustive list. There are a wide variety of non-financial investments that may be considered under a portfolio rationalization operation. Certain investments may lend themselves to additional factors not presented here. Again, any particular rationalization operation should tailor the valuation process to the investments in the portfolio at hand.

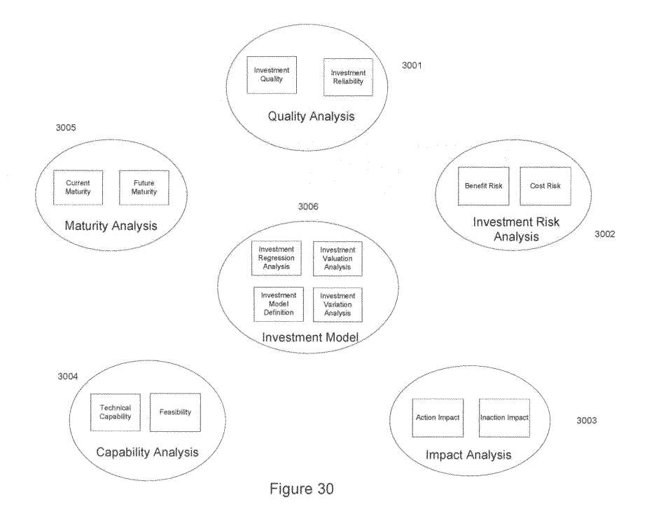

In general, the Investment Model analysis is classified into the following categories: Quality Analysis, Investment Risk Analysis, Impact Analysis, Capability Analysis, Maturity Analysis, and Investment Model Analysis. Each of these categories has sub-areas that should be considered when modeling business value. FIG. 31 shows the categories in relation to the Investment phase of the portfolio rationalization life cycle. Each of these categories contributes to the Investment Model for the Business Value. FIG. 30 illustrates the individual process within each of the six categories of Quality Analysis (3001), Investment Risk Analysis (3002), Impact Analysis (3003), Capability Analysis (3006), Maturity Analysis (3005), and Investment Model Analysis (3004).

FIG. 32 shows the Data Consistency Analysis process. Data Consistency Analysis compares two simultaneous measurements of the same data field. The input to this process (3201) is the Portfolio Snapshot. The output (3202) is the Data Consistency Document. The tools and techniques (3203) are Statistical Techniques, Mathematical Models, and Numerical Techniques.

FIG. 33 shows the Data Stability Analysis process. Data Stability Analysis compares successive Portfolio Snapshots taken over time to estimate the extent and variance of the data. The input to this process (3301) is the Portfolio Snapshot. The output (3302) is the Data Stability Document. The tools and techniques (3303) are Statistical Techniques, Mathematical Models, and Numerical Techniques.

FIG. 34 shows the Data Coverage Analysis process. Data Coverage Analysis measures the percent of investments that have useful information for a specific data field. The input to this process (3401) is the Portfolio Snapshot. The output (3402) is the Data Coverage Document. The tools and techniques (3403) are Statistical Techniques.

FIG. 35 shows the Data Cleansing process. Data Cleansing Identifies and corrects faulty data from the Portfolio Snapshot. The inputs to this process (3501) are the Portfolio Snapshot, Data Quality Document, Data Consistency Document, Data Stability Document, and Data Coverage Document. The output (3502) is an updated Portfolio Snapshot. The tools and techniques (3503) are Statistical Techniques, Mathematical Models, and Numerical Techniques.

B) Investment Risk

There are two types of risk: Benefit Risk and Cost Risk. The Benefit Risk is the uncertainty in the valuation of the asset benefit, while the Cost Risk is the uncertainty in the valuation of the asset cost. Both of these variances can be useful in computing the variance of the Investment Valuation.

i) Benefit Risk

The Benefit Risk is a measure of the uncertainty of the value of the benefit of the investment. In many non-financial investments, it is common to ignore this uncertainty and assume it is zero. However, if a variance is available, it may be used to further estimate the uncertainty in the underlying investment value.

The Benefit Risk is one contributor to the overall uncertainty in the value of an investment. This error should be quantified as some ΔV against an investment with value V. This error may be combined with other risk errors to formulate an overall uncertainty in the investment value.

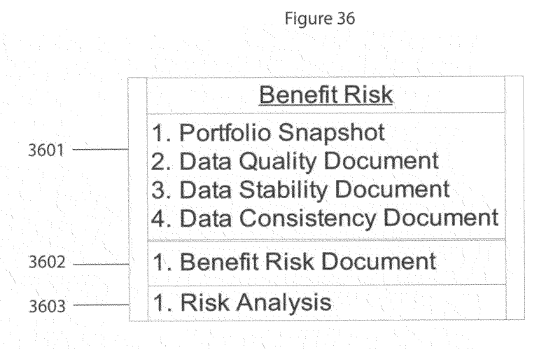

FIG. 36 shows the Benefit Risk Process. Benefit Risk is a measure of uncertainty of the value of the benefit of the investment. The Benefit Risk Process has the following inputs: Portfolio Snapshot, Data Quality Document, Data Stability Benefit Risk Document (3601) and the output of Benefit Risk Document (3602). The tool and technique associated with this process is Risk Analysis (3602).

ii) Cost Risk

Cost Risk is similar to Benefit Risk, except the uncertainty is in the investment cost rather than in the benefit. Again, many non-financial investments ignore the Cost Risk and assume that it is zero. However, if a Cost Risk is available, it should be used to assist with the computation of the uncertainty in the Investment Valuation.

The Cost Risk is another contributor to the overall uncertainty in the value of an investment. Similar to the Benefit Risk, the error associated with the Cost Risk should be quantified as some ΔV against an investment with value V. This error may be combined with other risk errors to formulate an overall uncertainty in the investment value.

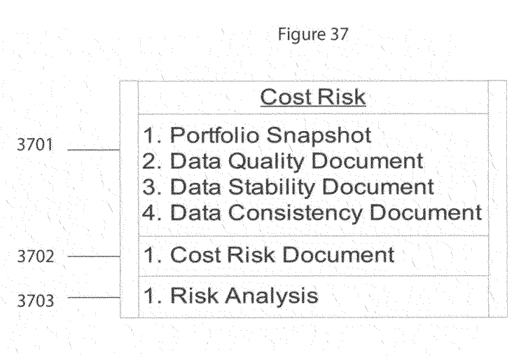

FIG. 37 shows the Cost Risk Process. Cost Risk is a measure of uncertainty of the value of the cost of the investment. The Cost Risk Process has the following inputs: Portfolio Snapshot, Data Quality Document, Data Stability Document, and Data Consistency Document (3701). It also has the following output: Cost Risk Document (3702). The tool and technique associated with this process is Risk Analysis (3703).

C) Impact Analysis

Impact Analysis quantifies the impact the investment has on the overall portfolio, and what impact changes the investment may have. Some investments may be underperforming, but may present a desirable diversification of assets. Eliminating these assets may at first appear to be warranted, but removal of these assets can lead to a less stable portfolio.

Impact Analysis examines both the impact of taking action and not taking action with the investment. In this respect, a value may be computed to associate with each of these possibilities, and these values can assist in determining if the investment should be modified.

i) Action Impact

The Action Impact attempts to quantify how a specific investment action may affect the Investment Value, Portfolio Value, investment uncertainty, and portfolio uncertainty. In addition, the Action Impact may be used to examine the impact to Investment Clusters or other aspects of the portfolio.

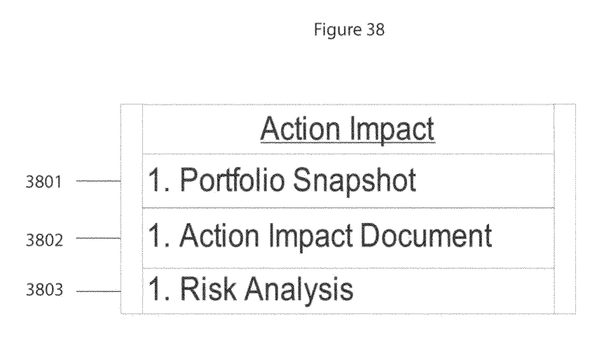

FIG. 38 shows the Action Impact Process. The Action Impact attempts to quantify how a specific investment action may affect the investment value, portfolio value, investment uncertainty, and portfolio uncertainty. The Action Impact Process has the following input: Portfolio Snapshot (3801). It also has the following output: Action Impact Document (3802). The tool and technique associated with this process is Risk Analysis (3803).

ii) Inaction Impact

The Inaction Impact is similar to the Action Impact, except with a quantitative estimate of what one may gain or lose by not taking action. This is in part a measure of opportunity cost for the particular investment action in question.

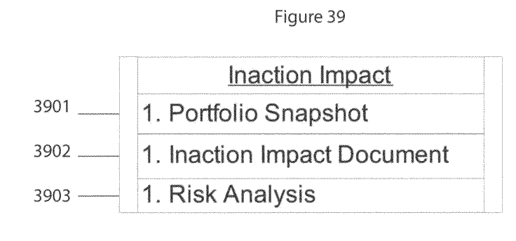

FIG. 39 shows the Inaction Impact Process. The Inaction Impact attempts to quantify how inaction may affect the investment value, portfolio value, investment uncertainty, and portfolio uncertainty. The Inaction Impact Process has the following input: Portfolio Snapshot (3901). It also has the following output: Inaction Impact Document (3902). The tool and technique associated with this process is Risk Analysis (3903).

D) Capability Analysis

Capability Analysis quantifies the overall capability of an investment. Some investments can be measured according to their ability to deliver a useful result. This analysis attempts to quantify this concept and use it to update the Investment Value. For example, for a portfolio containing two different word processing applications, by itself, this seems like a waste of resources because economies of scale are not maximized. However, it may be the case that one application is generally useful and inexpensive, while the other application is used to produce highly specialized marketing materials. It may be better to keep both applications rather than eliminating one. Capability Analysis attempts to capture and quantify these situations.

i) Technical Capability

Technical Capability examines the technical aspects of the investment capability. Creating some measure can be beneficial. Even a basic model will allow Investment Valuations the flexibility to reach situations like the example above. However, when there is no easy method to quantify Technical Capability, one needs to be careful not to use this to arbitrarily modify the portfolio rationalization results. Subjective valuations of Technical Capability can lead to abusive manipulation of the results to favor or disfavor a specific investment.

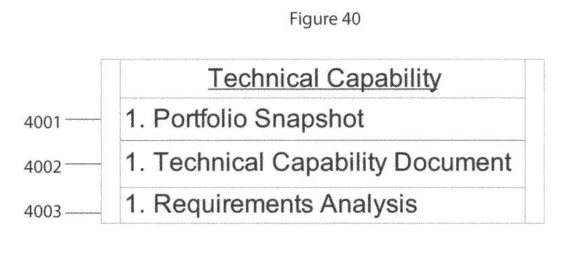

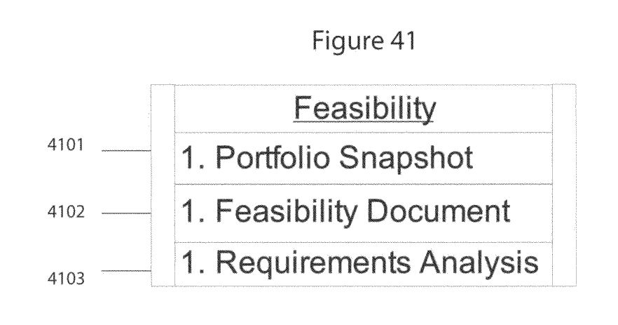

FIG. 40 shows the Technical Capability Process. Technical Capability examines the technical aspects of the investment capability. The Technical Capability Process has the following input: Portfolio Snapshot (4001). It also has the following output: Technical Capability Document (4002). The tool and technique associated with this process is Requirements Analysis (4003).

ii) Feasibility

While Technical Capability measures the current capability of an asset, Feasibility measures the future capability of the investment. Feasibility has the same drawbacks and problems as Technical Capability. However, Feasibility has the added element that the future capability is even more difficult to quantify than present capability.

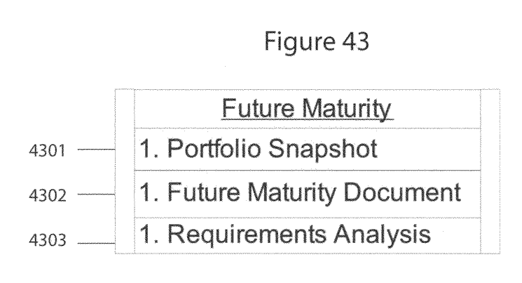

FIG. 43 shows the Feasibility Process. Feasibility examines the future capability of the investment. The Feasibility Process has the following input: Portfolio Snapshot (4101). It also has the following output: Feasibility Document (4102). The tool and technique associated with this process is Requirements Analysis (4103).

E) Maturity Analysis

Maturity Analysis quantifies an investment's level of maturity. Many non-financial investments move through various phases over the life cycle of the asset. This analysis attempts to measure and incorporate this information into the Investment Model.

i) Current maturity

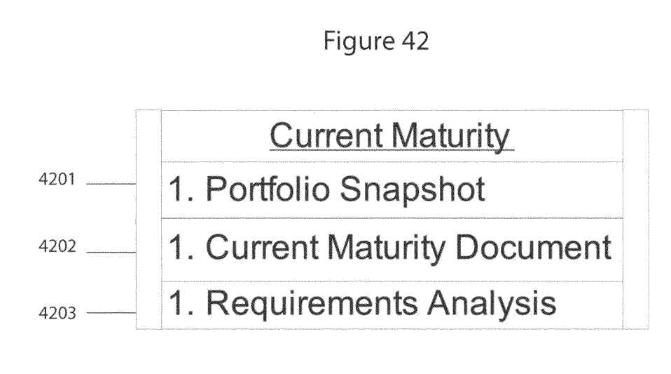

The Current Maturity measures the current maturity state of the asset and incorporates this information into the Investment Model. FIG. 42 shows the Current Maturity Process. Current Maturity measures the current maturity state of the asset and incorporates this information into the Investment Model. The Current Maturity Process has the following input: Portfolio Snapshot (4201). It also has the following output: Current Maturity Document (4202). The tool and technique associated with this process is Requirements Analysis (4203).

ii) Future Maturity

The Future Maturity measures the future maturity state of the asset and incorporates this information into the Investment Model. FIG. 43 shows the Future Maturity Process. Future Maturity measures the future maturity state of the asset and incorporates this information into the Investment Model. The Future Maturity Process has the following input: Portfolio Snapshot (4301). It also has the following output: Future Maturity Document (4302). The tool and technique associated with this process is Requirements Analysis (4303).

F) Model Analysis

Model Analysis is the determination and specification of a particular model or models to assess the Business Value of an investment based on the data fields available and the other factors analyzed in this section. The main purpose of the model is to create one or more values that allow different assets to be compared. The model should be tailored for each specific portfolio. Different portfolios may require different valuation of the investments. As such, two different portfolios may have vastly different models even though they have similar investments. The different models values, since the method of computing the values is different, the values are not comparable.

i) Investment Regression Analysis

Investment Regression Analysis is a common technique used to analyze multi-dimensional data sets. Regression Analysis can readily incorporate both values and uncertainties. Investment Regression Analysis can be used to determine optimal weights to put against category values. This can be used to create a simple linear model for the Investment Value. Alternatively, Investment Regression Analysis can be part of the Model itself. In this manner, the Investment Value may be determined by performing an Investment Regression Analysis against some of the data fields. In this respect, the Investment Regression Analysis is incorporated into the model itself.

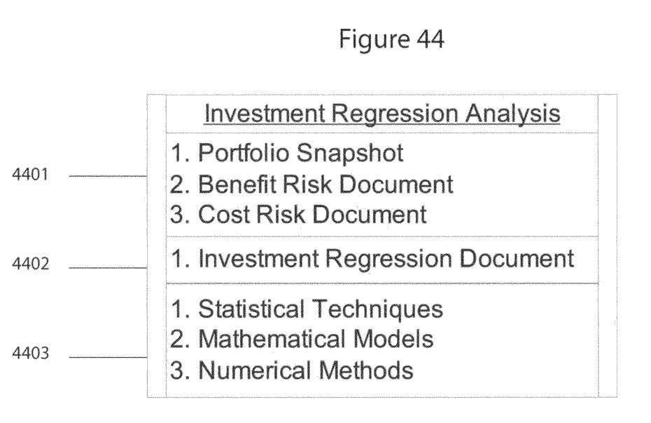

FIG. 44 shows the Investment Regression Analysis Process. Investment Regression Analysis is a common technique used to analyze multi-dimensional data sets. Regression Analysis can readily incorporate both values and uncertainties. The Investment Regression Analysis Process has the following inputs: Portfolio Snapshot, Benefit Risk Document, and Cost Risk Document (4401). It also has the following output: Investment Regression Document (4402). The tools and techniques associated with this process are Statistical Techniques, Mathematical Models, and Numerical Methods (4403).

ii) Investment Variation Analysis

Investment Variation Analysis is used to compute the uncertainty of the Investment Value. This section has presented several measures of uncertainty in the fields. These may be combined together to compute the overall uncertainty for the Investment Value. Uncertainties may be combined and propagated using the standard error propagation analysis. For example, let x±Δx and y±Δy be two fields. Let f(x,y) be the Investment Model. The error in the Investment Value is

$$Δ {f}^{2} = {( \frac{\partial f}{\partial x} )}^{2} Δ {x}^{2} + {( \frac{\partial f}{\partial y} )}^{2} Δ {y}^{2}$$

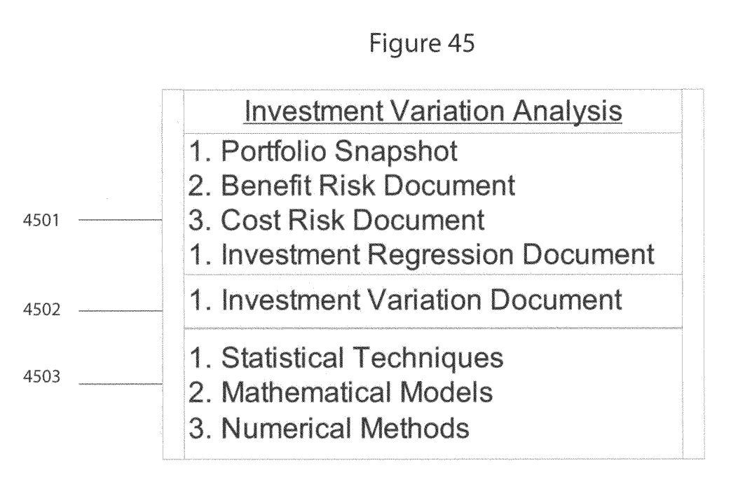

FIG. 45 shows the Investment Variation Analysis Process. Investment Variation Analysis is used to compute the uncertainty of the Investment Value. The Investment Variation Analysis Process has the following inputs: Portfolio Snapshot, Benefit Risk Document, Cost Risk Document, and Investment Regression Document (4501). It also has the following output: Investment Variation Document (4502). The tools and techniques associated with this process are Statistical Techniques, Mathematical Models, and Numerical Methods (4503).

iii) Investment Model Definition

Investment Model Definition is the specific mathematical model or function used to compute the Investment Value for each asset. This model incorporates all of the information discussed in this section. For each investment, the model will compute one or more Investment Values and their associated uncertainties or errors.

There are many potential models that may be used to compute Investment Value. The particular model used for a given portfolio may be custom tailored to reflect the factors important to the portfolio.

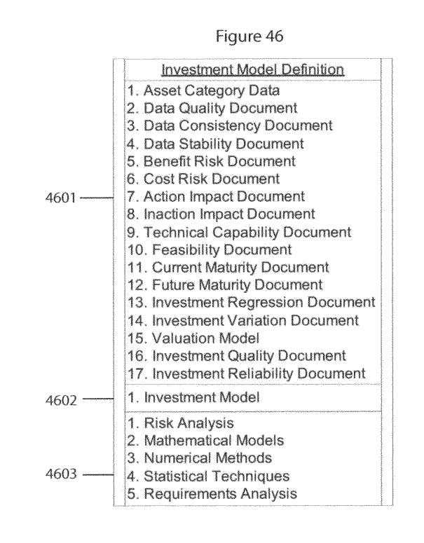

FIG. 46 shows the Investment Model Definition Process. Investment Model Definition is the determination and specification of a particular model or models to assess the Business Value of an Investment based on the data available. The Investment Model Definition Process has the following inputs: Portfolio Snapshot, Data Quality Document, Data Consistency Document, Data Stability Document, Benefit Risk Document, Cost Risk Document, Action Impact Document, Inaction Impact Document, Technical Capability Document, Feasibility Document, Current Maturity Document, Future Maturity Document, Investment Regression Document, and Investment Variation Document (4601). It also has the following output: Investment Model Definition (4602). The tools and techniques associated with this process are Risk Analysis, Statistical Techniques, Mathematical Models, Requirements Analysis, and Numerical Methods (4603).

Portfolio Model

The Portfolio Model is a model used to quantify the value, uncertainty, and performance of the portfolio as a whole. Just as with Business Value, there may be several values assigned to the portfolio, each of which measures a different aspect of the portfolio. The Portfolio Model examines four main areas: Compliance, Risk, Cost, and Return. These are the main ingredients to understanding the value, uncertainty, and performance of the portfolio as a whole. Each of these areas is further segmented into individual sub-areas. These sub-areas are not intended to represent an exhaustive list of related knowledge; rather, they are intended to specify common elements used to evaluate their corresponding area. One or more of these processes may be used at one time.

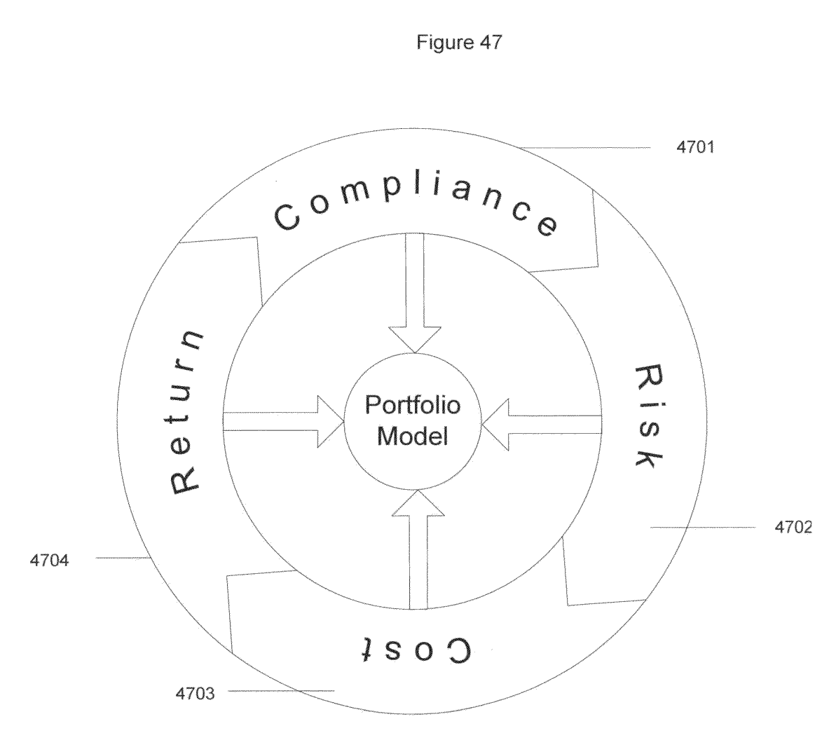

The Portfolio Model (See 4701 of FIG. 47) is a model used to quantify the value, uncertainty, and performance of the portfolio as a whole. Just as with Business Value, there may be several values assigned to the portfolio, each of which measures a different aspect of the portfolio. By evaluating different aspects of the portfolio separately, we can better understand the multi-dimensional nature typical of non-financial portfolios.

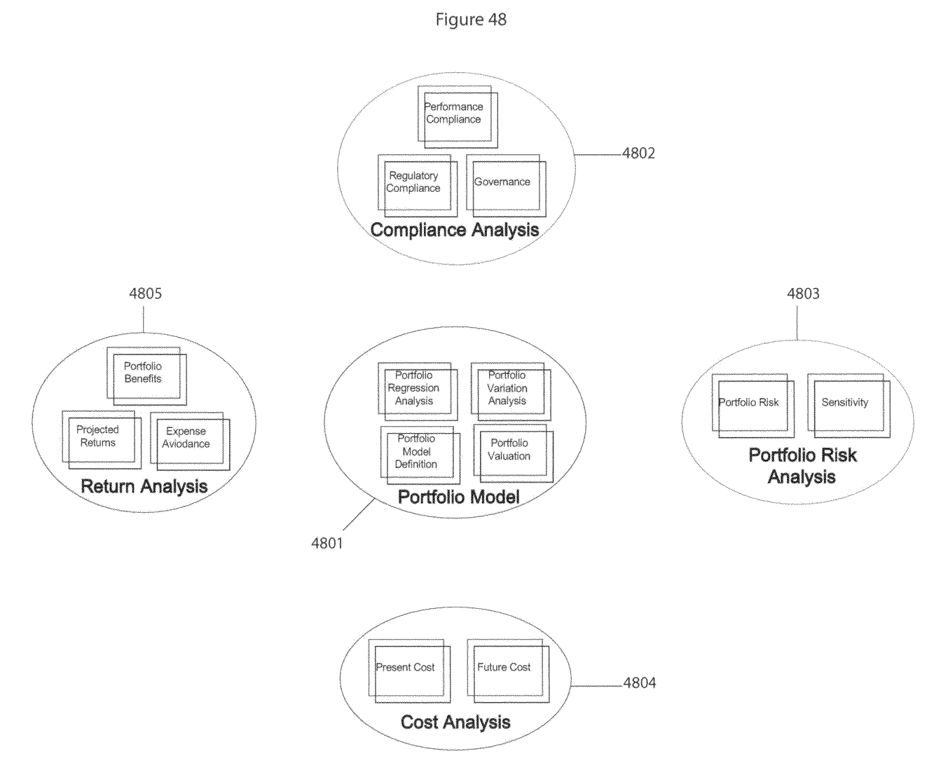

The Portfolio Model examines four main areas: Compliance (4702), Risk (4703), Cost (4704) and Return (4705). One or more of these areas are used to understand the value, uncertainty, and performance of the portfolio as a whole. Each of these areas is further segmented into individual sub-areas. These sub-areas are not intended to represent an exhaustive list of related knowledge; rather, they are intended to specify common elements used to evaluate their corresponding area. FIG. 48 further breaks down the processes within each analysis.

The Portfolio Model (4801) is dependent upon Portfolio Regression Analysis, Portfolio Variation Analysis, Portfolio Model Definition and Portfolio Valuation.

Compliance Analysis (4802) addresses how well the portfolio conforms to expectations. Compliance is measured in terms of the overall Portfolio Performance, regulatory issues, and portfolio governance. Compliance measures help to identify where the portfolio diverges from expectations.

Portfolio Risk Analysis (4803) examines the uncertainties associated with the values from the Portfolio Model. This group examines the overall portfolio risk as well as the sensitivity of the risk. Portfolio Sensitivity analysis is important in determining the potential impact of uncertainties in the portfolio values.

Portfolio Cost Analysis (4804) examines the present and future costs associated with the portfolio. These processes account for the time value of money to better understand the present value of future portfolio returns.

Portfolio Return Analysis (4805) quantifies the portfolio return. Return may be measured in two ways. First, return may be measured as direct benefit to the portfolio. Second, return may be measured as avoidance of expense. Understanding these cost savings realized through reduction of expenses is an important aspect of portfolio rationalization.

A) Compliance

Compliance Analysis examines how well the portfolio is conforming to expectations. There are many different potential measures of compliance. Three common compliance measures are the overall Performance Compliance, Regulatory Compliance, and Governance. These three measures of the compliance of a portfolio to expectations provide a basis for an overall evaluation of the compliance health of the portfolio.

i) Performance Compliance

Performance Compliance measures how the portfolio has performed with respect to an expected or projected value. Past examinations of the portfolio produced expected costs from the Future Cost process. Current examinations measure the actual costs incurred. These past predictions can be measured against actual performance to determine how well the actual performance has aligned with the projections.

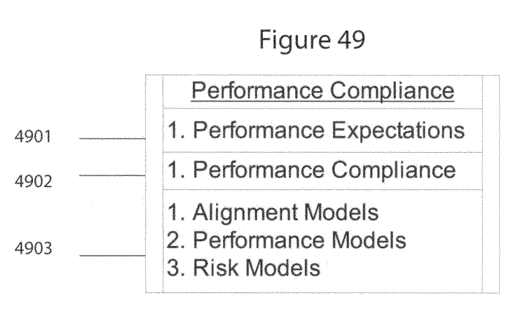

FIG. 49 shows the Performance Compliance Process. Performance Compliance measures how the portfolio has performed as compared to prior expectations. The Performance Compliance Process has the following input: Performance Expectations (4901). It also has the following output: Performance Compliance Document (4902). The tools and techniques associated with this process are Alignment Models, Performance Models, and Risk Models (4903).

ii) Governance

Regulatory Compliance is a fundamental issue in portfolio rationalization. Unlike financial portfolios, regulatory issues often drive strategy and portfolio management decisions. Compliance with Federal, State, and Local regulations is a critical issue for many organizations. This process examines the compliance of the portfolio with these regulations to determine if course corrections are warranted. In addition, this process reviews regulations to determine if they still apply to the portfolio investments.

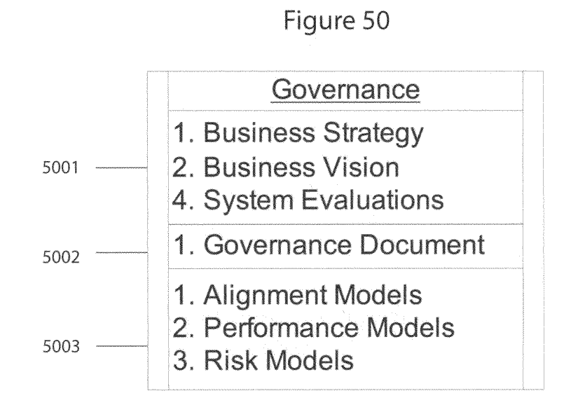

FIG. 50 shows the Governance Process. The Governance subarea of Compliance Analysis measures how the portfolio has performed as compared to the governance expectations of the organization. The Governance Process has the following inputs: Business Strategy, Business Vision, and System Evaluations (5001). It also has the following output:

Governance Document (5002). The tools and techniques associated with this process are Alignment Models, Performance Models, and Risk Models (5003).

iii) Regulatory Compliance

Portfolio Governance addresses the compliance of the portfolio management with the governance strategy of the organization. Compliance with the governance strategy is essential in order to assure that the portfolio remains aligned with the strategy of the organization. The Portfolio Rationalization Process cannot reliably produce good recommendations if the Portfolio Rationalization Process itself is not compliant with the organizational strategy.

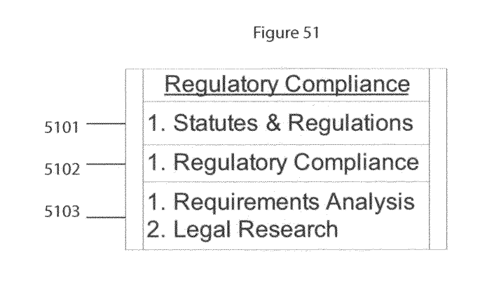

FIG. 51 shows the Regulatory Compliance Process. Regulatory Compliance measures how the portfolio has performed as compared to Federal, State, and Local regulations. The Regulatory Compliance Process has the following input: Statutes and Regulations (5101). It also has the following output: Performance Compliance Document (5102). The tool and technique associated with this process is Requirements Analysis (5103).

B) Portfolio Risk Analysis

Portfolio Risk Analysis examines and quantifies the uncertainties associated with the values from the Portfolio Model. This group examines the overall portfolio risk as well as the sensitivity of the risk. Sensitivity analysis is important in determining the potential impact of uncertainties in the portfolio values.

i) Portfolio Risk

The Portfolio Risk process quantifies the uncertainties in the Portfolio Values. These uncertainties are computed using similar error propagation models as in the Investment Model. The uncertainties are used to specify the Portfolio Value with an associated error such as $1.52M±0.02M. The nature of the uncertainties is that the true value lies on some probability distribution characterized by the value and uncertainty. For example, if the value is $1.52M±0.02M, this indicates that the true value lies on a Gaussian distribution, centered on the value $1.52M, and with standard deviation 0.02M.

Analysis of stochastic variables may be effective to Portfolio Risk. A stochastic process is a process that incorporates a random element. The model of a stochastic process will contain one or more stochastic variables. Monte Carlo simulations can be used effectively to analyze potential outcomes of the model based on evolving the present values of the variables. In financial portfolio analysis, these techniques lead to models such as the Black and Scholes option pricing model.

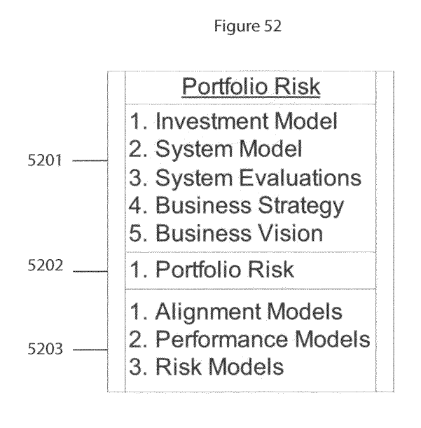

FIG. 52 shows the Portfolio Risk Process. Portfolio Risk Analysis examines the uncertainties and sensitivities for the portfolio values. The Portfolio Risk Process has the following inputs: Investment Model, System Evaluations, Business Strategy, Business Vision (5201). It also has the following output: Portfolio Risk Document (5202). The tools and techniques associated with this process are Alignment Models, Performance Models, and Risk Models (5203).

ii) Portfolio Sensitivity

Portfolio Sensitivity analysis examines how sensitive the values and predictions are with respect to perturbations in their values. For instance, a Portfolio Model may make several performance predictions based on the Portfolio Values and their uncertainties. However, a model combining several of these uncertain values together may be sensitive to small perturbations.

Portfolio Sensitivity analysis is important in portfolio rationalization as it identifies when the portfolio is sensitive to uncertainties in the Investment Values. Predictions based on models that are highly sensitive to the Investment Values may lead to unpredictable results. When a model is identified as sensitive, additional care should be taken to assure that predictions from the model are reliable.

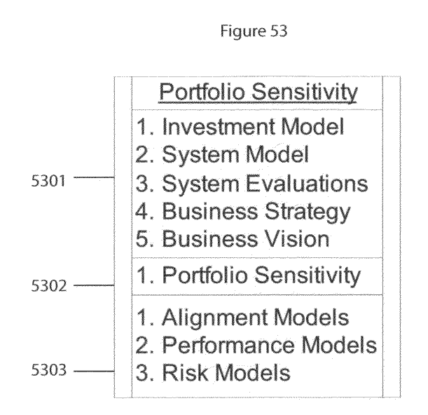

FIG. 53 shows the Portfolio Sensitivity Process. Sensitivity analyzes how sensitive the portfolio values are with respect to perturbations in their values. The Sensitivity Process has the following inputs: Investment Model, System Evaluations, Business Strategy, and Business Vision (5301). It also has the following output: Sensitivity Document (5302). The tools and techniques associated with this process are Alignment Models, Performance Models, and Risk Models (5303).

C) Cost Analysis

Cost Analysis in the Portfolio Model examines the present and anticipated costs of the investments. These costs are an important factor when evaluating the benefits of the investment to the portfolio. The results of Cost Analysis are factored into the Portfolio Model in order to properly understand the value of each investment to the portfolio.

i) Portfolio Present Cost

Portfolio Present Cost reviews the current and past cost of the investments. This analysis includes both fixed and variable costs to evaluate the present cost of the investment. The present cost is useful to the Portfolio Model for later computations of ROI. Portfolio Present Costs are usually readily computed as many of these are investment costs that have been realized.

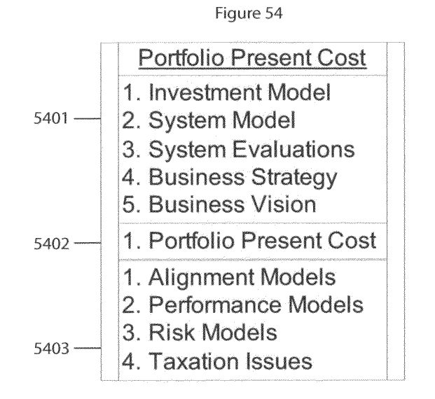

FIG. 54 shows the Portfolio Present Cost Process. Present Cost reviews the present and past cost of the investments. The Present Cost Process has the following inputs: Investment Model, System Evaluations, Business Strategy, and Business Vision (5401). It also has the following output: Present Cost Document (5402). The tools and techniques associated with this process are Alignment Models, Performance Models, Risk Models and Taxation Issues (5403).

ii) Portfolio Future Cost

Portfolio Future Cost addresses the present value of future costs of an investment. Due to the time value of money, future costs are typically discounted when computing their present value. Future Cost examines known costs, potential costs, and estimates unknown costs. Future Cost also examines disposition effects as well as taxation issues.

Portfolio Future Costs are not as easy to compute as Present Costs. Future Costs have not been realized and there may be some degree of speculation as to whether the cost will be incurred at all. In addition, Future Cost addresses unknown issues such as the cost an investment may incur due to an increase in oil prices. Because it is impossible to know if oil prices will increase and if so, to what degree, Future Cost analysis does not present precise values. Instead, Future Cost examines potential scenarios and their impact.

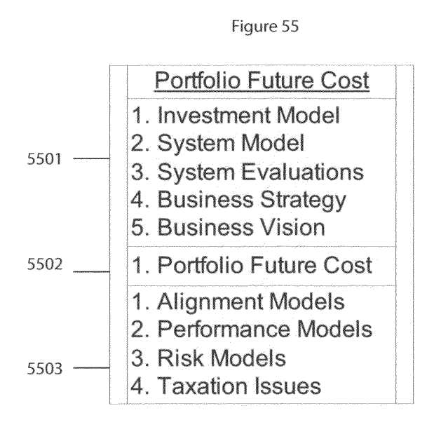

FIG. 55 shows the Portfolio Future Cost Process. Future Cost estimates the present value of the future cost of the investments. The Future Cost Process has the following inputs: Investment Model, System Evaluations, Business Strategy, and Business Vision (5501). It also has the following output: Future Cost Document (5502). The tools and techniques associated with this process are Alignment Models, Performance Models, Risk Models, and Taxation Issues (5503).

D) Return Analysis

Return Analysis examines the potential returns that the portfolio may receive from the investments. The returns may be in the form of Portfolio Benefits, Expense Avoidance, or Projected Returns. Returns do not need to be financially quantifiable. For example, Portfolio Benefits may include the benefits of regulatory compliance or improved worker retention.

i) Portfolio Benefits

Portfolio Benefits reviews the benefits that each investment brings to the overall portfolio. This does not necessarily need to align with the purpose or product of the investment itself. For example, a tree planting program in a portfolio of green initiatives benefits the portfolio because this program is aligned with the strategic purpose of the portfolio. However, the same program in a portfolio for employee satisfaction may benefit the portfolio by increasing morale. In the first case, the primary product of the program, newly planted trees, is aligned with the purpose of the portfolio. In the second case, the newly planted trees are not aligned with the primary, but the investment still adds value to the overall portfolio.

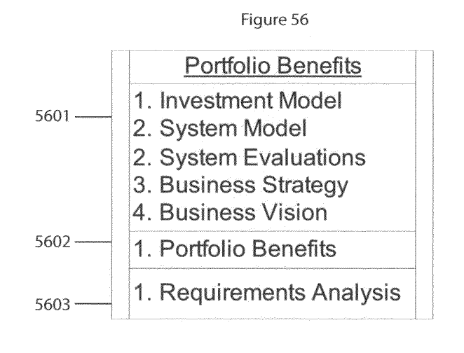

FIG. 56 shows the Portfolio Benefits Process. Portfolio Benefits examines the benefits that each investment brings to the portfolio. The Portfolio Benefits Process has the following inputs: Investment Model, System Evaluations, Business Strategy, and Business Vision (5601). It also has the following output: Portfolio Benefits Document (5602). The tool and technique associated with this process is Requirements Analysis (5603).

ii) Portfolio Expense Avoidance

Portfolio Expense Avoidance is another way that an investment may benefit the overall portfolio. Here, an investment may incur a cost while preventing another cost. For example, a regulatory compliance project may cost $1M annually, but this compliance may prevent $5M in fines. The investment does not generate positive value by itself, but may add value to the portfolio by avoiding other costs. These potential cost savings may be viewed as a return on the investment.

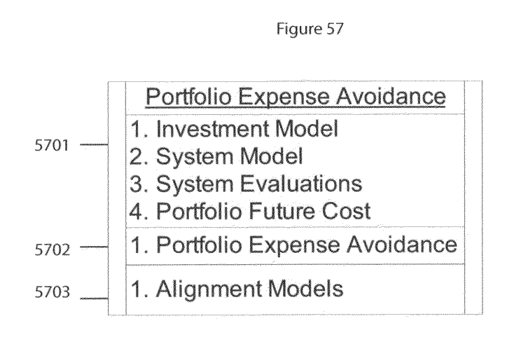

FIG. 57 shows the Portfolio Expense Avoidance Process. Portfolio Expense Avoidance identifies potential cost savings from the portfolio investments. These cost savings may be viewed as a return on the investment. The Expense Avoidance Process has the following inputs: Investment Model, System Evaluations, and Future Cost Document (5701). It also has the following output: Expense Avoidance Document (5702). The tool and technique associated with this process is Alignment Models (5703).

iii) Projected Portfolio Returns

Projected Portfolio Returns allow for flexibility in estimating the potential value of an investment. This process may be used in cases when the value is hard to measure or in cases where the value is simply unknown at present. For instance, the sales of a newly developed product are not known at present, but will be known in the future. Projected Returns may be used to estimate the return from this investment and inserted into the Portfolio Model.

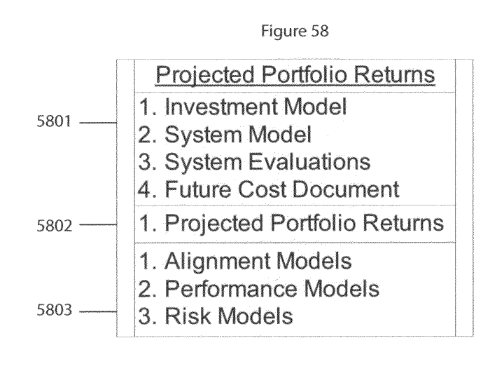

FIG. 58 shows the Projected Portfolio Returns Process. Projected Returns estimates the present value of potential future returns for the portfolio investments. The Projected Returns Process has the following inputs: Investment Model, System Evaluations, and Future Cost Document (5801). It also has the following output: Projected Returns Document (5802). The tools and techniques associated with this process are Alignment Models, Performance Models, and Risk Models (5803).

E) Portfolio Model Analysis

The Portfolio Model Analysis is the meeting of these analyses to form a model of the overall portfolio. The model begins with an understanding of the cost, return, uncertainty, and compliance. From these ingredients, the Rationalization Manager formulates the Portfolio Model. This model is intended to quantify the value(s) of the overall portfolio. The model may be as simple as the sum of the values of each of the constituent investments. However, typically the Portfolio Model is not this simple and the value of the whole is different than the sum of its parts.

The Portfolio Model can use a wide variety of techniques. Specific situations may require tailoring the process to meet the individual requirements of the organization. However, many cases commonly use these processes to complete the task. Portfolio Regression Analysis is often used to create basic Mathematical Models that can be used to extrapolate Investment Values over time, cost, return, or other variables. These models are then used to perform a Portfolio Valuation Analysis that identifies the potential value(s) that may be used to measure the Portfolio Performance. Finally, Portfolio Model Definition uses these value(s) to specify a particular computational model for the portfolio.

i) Portfolio Regression Analysis

Regression analysis is a statistical technique for creating models from data in a scatter-plot. As an example, the daily closing price of a stock may be plotted over some period of time. The data is a scatter plot of individual data points. From this the least-squares best-fit of the data to a straight line is found and then used to attempt to predict the future values of the stock. The process of taking the original data and producing the best-fit straight line is a form of regression analysis.

Regression analysis may be used to model the values of the investments. It may also be used to extrapolate values over other variables such as cost, return, or even compliance. In each case a scatter plot of the investment data is created and then compute a best-fit curve. What values are chosen and what type of curve it is fit to (line, parabola, sinusoid) are up to the skill, art, and experience of one of skill in the art.

The raw data for Portfolio Regression Analysis comes from the results of Compliance Analysis, Portfolio Risk Analysis, Cost Analysis, and Return Analysis. These analyses are not simply performed in isolation. Rather, each of these is conducted with the purpose of gathering fundamental data as an input to the Portfolio Regression Analysis process.

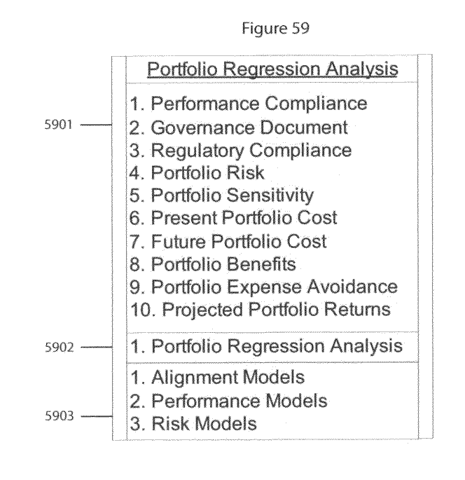

FIG. 59 shows the Portfolio Regression Analysis Process. Portfolio Regression Analysis examines the portfolio investment data and creates one or more models to extrapolate the data characteristics. The Portfolio Regression Analysis Process has the following inputs: Performance Compliance Document, Governance Document, Regulatory Compliance Document, Portfolio Risk Document, Sensitivity Document, Present Cost Document, Future Cost Document, Portfolio Benefits Document, Expense Avoidance Document, and Projected Returns Document (5901). It also has the following output: Projected Returns Document (5902). The tools and techniques associated with this process are Alignment Models, Performance Models, and Risk Models (5903).

ii) Portfolio Variation Analysis

Portfolio Variation Analysis examines sensitivity concerns of the models produced from the Portfolio Regression Analysis. Some of these sensitivity concerns were examined in the Sensitivity process. Here, the Sensitivity in the particular Portfolio Models identified from regression analysis is examined. This is important because the value of the predictions from the regression models is dependent on how sensitive these models are to perturbations. The regression models are formulated based on the Investment Values. However, these values are subject to uncertainties. These uncertainties may lead to unreliable models if the models are highly sensitive to perturbations in the values of the investments.

In particular, Monte Carlo techniques may be used to generate investment data sets where the Investment Values are determined from a probability distribution based on the investment value and uncertainty. Regression analysis may be performed on each of these generated data sets, yielding different regression models. The various models may be analyzed together to determine how sensitive the models are to perturbations in the underlying investment data values.

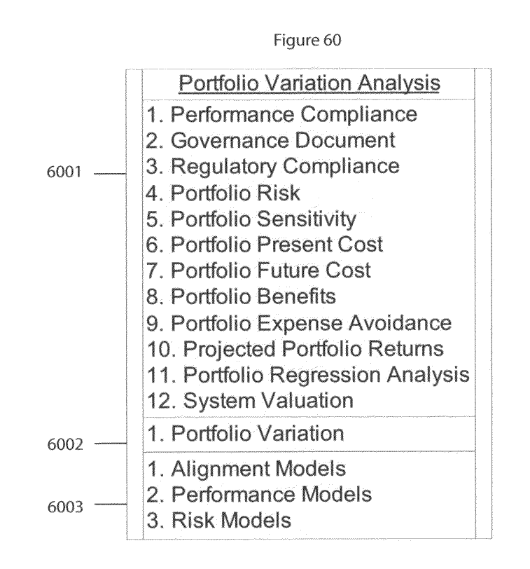

FIG. 60 shows the Portfolio Variation Analysis Process. Portfolio Variation Analysis examines how sensitive the regression models are to perturbations in the investment values. The Portfolio Variation Analysis Process has the following inputs: Performance Compliance Document, Governance Document, Regulatory Compliance Document, Portfolio Risk Document, Sensitivity Document, Present Cost Document, Future Cost Document, Portfolio Benefits Document, Expense Avoidance Document, Projected Returns Document, and Portfolio Regression Document (6001). It also has the following output: Portfolio Variation Document (6002). The tools and techniques associated with this process are Alignment Models, Performance Models, and Risk Models (6003).

iii) Portfolio Valuation Analysis

Portfolio Valuation Analysis examines the Mathematical Models from the Portfolio Regression Analysis to identify potential values that may make good measures of portfolio value. For example, Portfolio Regression Analysis may identify a model for the ‘number of users’ for a wide range of investments. Based on this, Portfolio Valuation Analysis may identify ‘total number of users’ as a potential portfolio value.

Portfolio Valuation Analysis may identify several potential values for the portfolio. The values do not need to have any relation to one another. For instance, there may have a value for ‘total number of users’ and another value for ‘total workdays without injury’ for the same portfolio. However, the values may also be combined to generate new values such as ‘total workdays without injury/total number of users’.

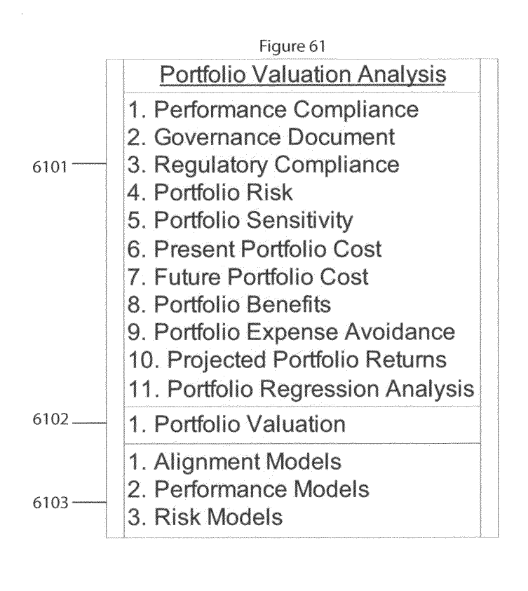

FIG. 61 shows the Portfolio Valuation Analysis Process. Portfolio Valuation Analysis examines the regression models and variations to identify potential values that may be used to measure portfolio performance. The Portfolio Valuation Analysis Process has the following inputs: Performance Compliance Document, Governance Document, Regulatory Compliance Document, Portfolio Risk Document, Sensitivity Document, Present Cost Document, Future Cost Document, Portfolio Benefits Document, Expense Avoidance Document, Projected Returns Document, and Portfolio Regression Document (6101). It also has the following output: Portfolio Valuation Document (6102). The tools and techniques associated with this process are Alignment Models, Performance Models, and Risk Models (6103).

iv) Portfolio Model Analysis

Based on the results of the Portfolio Valuation Analysis, the Portfolio Model Definition identifies a set of values intended to measure the performance of the portfolio. The Rationalization Manager may simply select values straight from the Portfolio Valuation Analysis, or may use these as inputs for a more complicated model. The model may incorporate some form of Computational Intelligence to adapt to changing situations, automatically incorporate new variables, or even modify the underlying model.

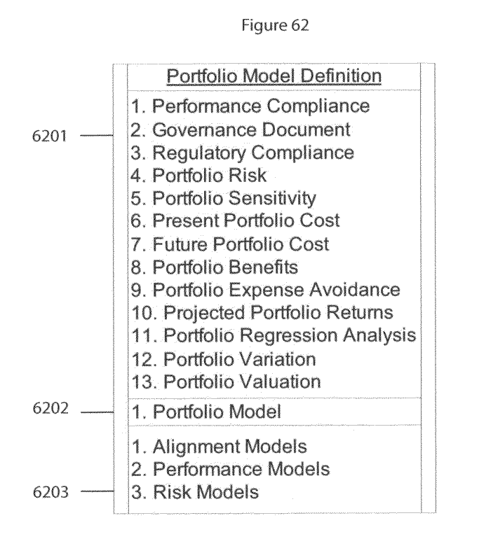

FIG. 62 shows the Portfolio Model Definition Process. Portfolio Model Definition identifies the set of values used to quantify portfolio performance. The Portfolio Model Definition Process has the following inputs: Performance Compliance Document, Governance Document, Regulatory Compliance Document, Portfolio Risk Document, Sensitivity Document, Present Cost Document, Future Cost Document, Portfolio Benefits Document, Expense Avoidance Document, Projected Returns Document, Portfolio Regression Document, and Portfolio Variation Document (6201). It also has the following output: Portfolio Model (6202). The tools and techniques associated with this process are Alignment Models, Performance Models, and Risk Models (6203).

Rationalization Model

The Rationalization Model is a model is used to identify investments that are appropriate targets for rationalization. This model may be a mathematical model, or it may be a manual process. In either case, the Rationalization Model reviews the performance of the investments and portfolio in conjunction with the System Requirements to determine which investments are best suited for rationalization.

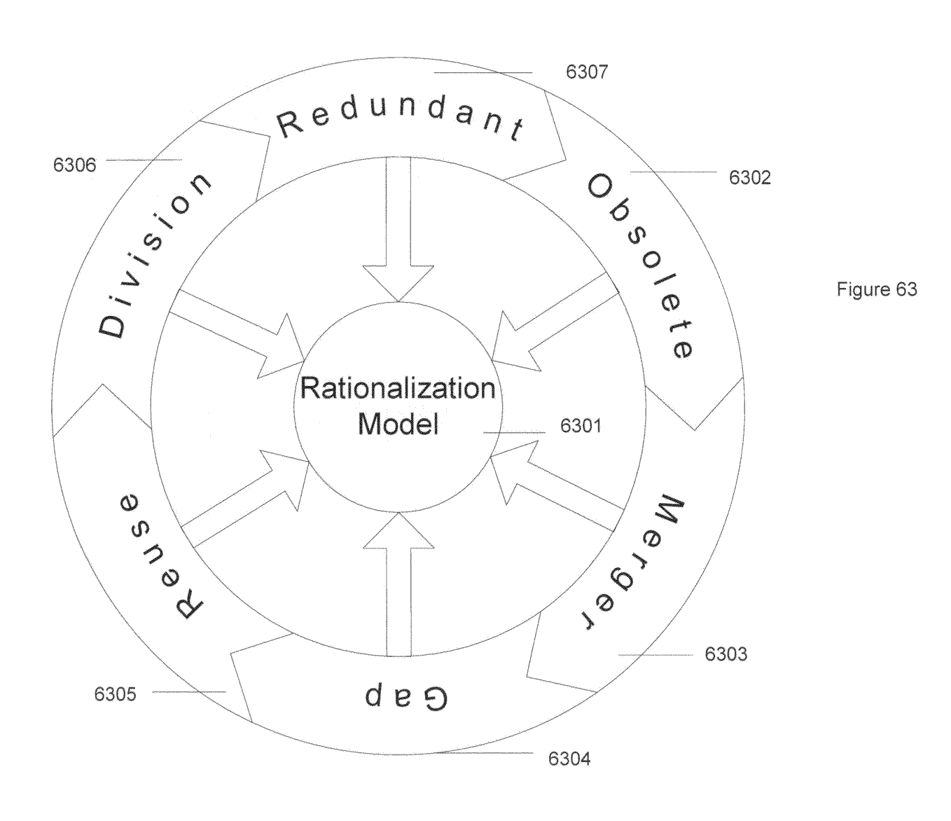

As shown in FIG. 63, the Rationalization Model (6301) is broken down by system, requirements, and resource categories into three pairs: redundant (6307) v. gap (6304), obsolete (6302) v. reuse (6305), and merger (6303) v. division (6303). Each of these pairs is opposite in effect and each presents an opportunity to migrate the portfolio in different directions.

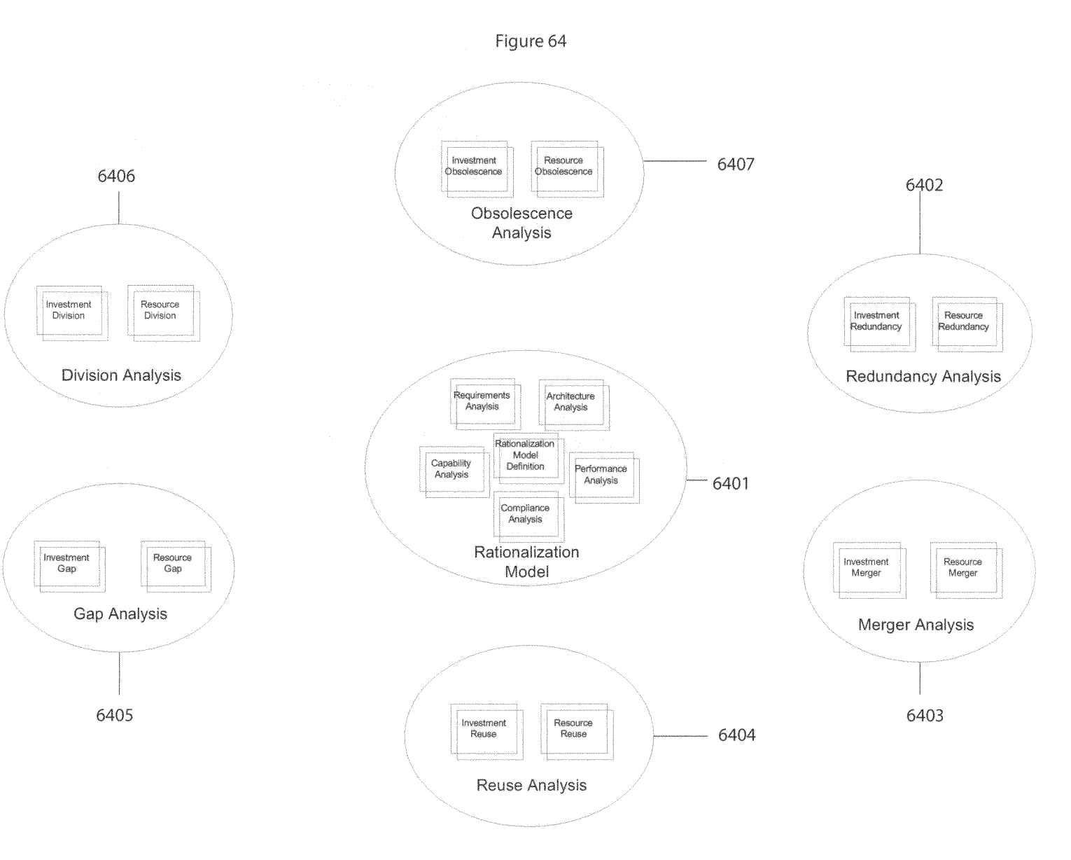

The Rationalization Model is formed from one or more of the following analyses: the Requirements Analysis, Architecture Analysis, Capability Analysis, Rationalization Model Definition, Performance Analysis and Compliance Analysis. See (6401) of FIG. 64. Further, within each of the six paired categories (redundant, gap, obsolete, reuse, merger and division, one must consider both the investment and the resource (6402-6406).

Investment

Each of the three pairs of processes, redundant v. gap, obsolete v. reuse, and merger v. division, examines aspects of investments. Investments may be examined in terms of individual projects or programs. Here, the project/program requirements, purpose, and functionality may be examined. This is done for the entire project/program, but the individual sub-units of the project/program are also examined.

Investments may be examined for the products, processes, or services the investment produces. These may be the result of a project or program, or they may be part of an ongoing operation. In either case, these results are examined by each of the six processes mentioned above to identify potential rationalization targets.

Vendors may also be examined by these processes. There may be opportunities to consolidate or eliminate vendors and achieve cost savings through preferred customer discounts. Alternatively, one may find that adding new vendors is appropriate in order to relieve supply chain problems. In any case, vendor relationships may be reviewed by each of these processes.

The investments may have contractual obligations tied to them. This is another potential source for rationalization targets. Here, contractual obligations may be reviewed under the above processes to identify potential savings. Contractual obligations are typically not as easy to modify as they may require permission of the contracting parties. However, they may still be examined as potential rationalization targets.

Resources

Each of the three pairs of processes, redundant v. gap, obsolete v. reuse, and merger v. division, examines aspects of resources.

Investments are often supported by company personnel. The rationalization process should examine the personnel requirements to determine if there are opportunities to reduce the workforce. For example, in a software portfolio, one may find several database developers on each project in the portfolio. One may be able to achieve savings by consolidating all database developers into a single data development unit and requiring each software project to matrix with this unit for data developers.

Equipment is another source of rationalization targets. Investments often have equipment resources required for their operation. It may be the case that there is extra equipment available from one investment that can be used in another. Savings may be achieved by better distributing this equipment across the investments.

Investments may have substantial infrastructure that may be a target for rationalization. Computer networks, routers, databases, roads, water supply, power, and telecommunications are just a few examples of infrastructures that may support an investment. Any of these may be reviewed by these six processes to identify potential rationalization targets.

Licenses are also a source of rationalization targets. This is particularly true in the IT arenas where software licenses are abundant and may be transferrable between different units within the same organization. However, not all software licenses are reusable in this way and care should be taken to consult the actual license agreement to determine if these are proper rationalization targets. Facilities may be rationalization targets as well. Manufacturing portfolios may have several facilities and some may be underutilized. In these cases the above processes can examine the facility resources and identify potential rationalization targets.

A) Obsolete v Reuse

One may need to check the portfolio for obsolete investments. Investments may become obsolete for a wide variety of reasons. Investments may be obsolete because they are no longer needed (old products that have been retired), they no longer serve their intended purpose (regulatory project where the underlying regulation is repealed), or simply no longer fit with the strategic direction of the organization.

It may be that the entire investment is not either obsolete or reused. This analysis examines the components making up the investment to determine if there is opportunity. Because of this, an investment may be marked as obsolete because there are some obsolete components, while at the same time marked as reusable because some components may be reused elsewhere.

i) Investment and Resource Obsolescence

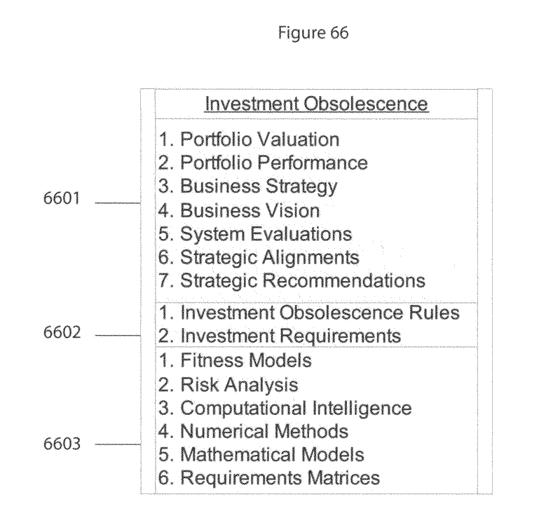

FIG. 66 shows the Investment Obsolescence Process. Investment Obsolescence reviews requirements, purpose, and functionality of the investments to identify projects, programs, processes, services, products, vendors, or contracts that may be obsolete. The Investment Obsolescence Process has the following inputs: Portfolio Valuation, Portfolio Performance, Business Strategy, Business Vision, System Evaluations, Strategic Alignments, and Strategic Recommendations (6601). It also has the following outputs: Investment Obsolescence Rules and Investment Requirements (6602). The tools and techniques associated with this process are Fitness Models, Risk Analysis, Computational Intelligence, Numerical Methods, Mathematical Methods, and Requirements Matrices (6603).

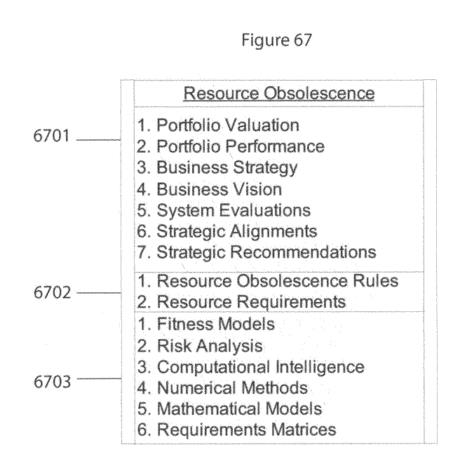

FIG. 67 shows the Resource Obsolescence Process. Resource Obsolescence reviews requirements, purpose, and functionality of resources to identify personnel, equipment, infrastructure, facilities, or licenses that may be obsolete. The Resource Obsolescence Process has the following inputs: Portfolio Valuation, Portfolio Performance, Business Strategy, Business Vision, System Evaluations, Strategic Alignments, and Strategic Recommendations (6701). It also has the following outputs: Resource Obsolescence Rules and Resource Requirements (6702). The tools and techniques associated with this process are Fitness Models, Risk Analysis, Computational Intelligence, Numerical Methods, Mathematical Methods, and Requirements Matrices (6703).

ii) Investment and Resource Reuse

Reuse is especially important in software systems as these are often designed with reuse in mind. Cost savings may be achieved by constructing a single component and sharing this system across several investments.

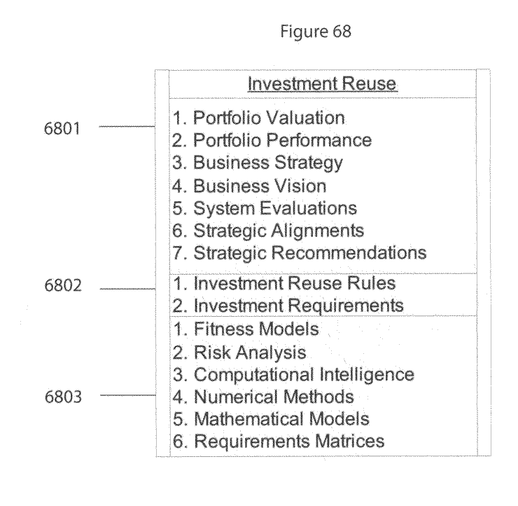

FIG. 68 shows the Investment Reuse Process. Investment Reuse reviews requirements, purpose, and functionality of the investments to identify projects, programs, processes, services, products, vendors, or contracts that may be reused. The Investment Reuse Process has the following inputs: Portfolio Valuation, Portfolio Performance, Business Strategy, Business Vision, System Evaluations, Strategic Alignments, and Strategic Recommendations (6801). It also has the following outputs: Investment Reuse Rules and Investment Requirements (6802). The tools and techniques associated with this process are Fitness Models, Risk Analysis, Computational Intelligence, Numerical Methods, Mathematical Methods, and Requirements Matrices (6803).

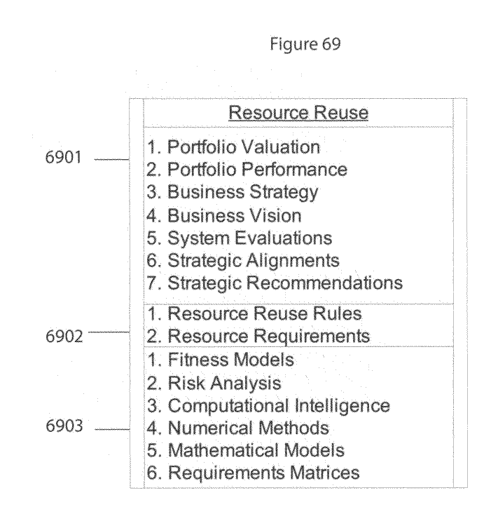

FIG. 69 shows the Resource Reuse Process. Resource Reuse reviews requirements, purpose, and functionality of resources to identify personnel, equipment, infrastructure, facilities, or licenses that may be reused. The Resource Reuse Process has the following inputs: Portfolio Valuation, Portfolio Performance, Business Strategy, Business Vision, System Evaluations, Strategic Alignments, and Strategic Recommendations (6901). It also has the following outputs: Resource Reuse Rules and Resource Requirements (6902). The tools and techniques associated with this process are Fitness Models, Risk Analysis, Computational Intelligence, Numerical Methods, Mathematical Methods, and Requirements Matrices (6903).

B) Redundant v Gap

Each of the investments in a portfolio has some set of underlying requirements, purpose, or functionality. This analysis examines the combined effect of all of these across the entire portfolio. An investment does not need to be completely redundant to benefit from rationalization. For instance, there may be two investments have different purposes but have some degree of overlap. It is this overlap that one of skill in the art may wish to rationalize by eliminating the redundant component from one of the investments. Alternatively, one of skill in the art might remove the overlap from both investments and create a new investment that focuses only on the overlapping area. Moreover, a practitioner may find that the redundancy is desired and leave the investments as is.

i) Investment and Resource Redundancy

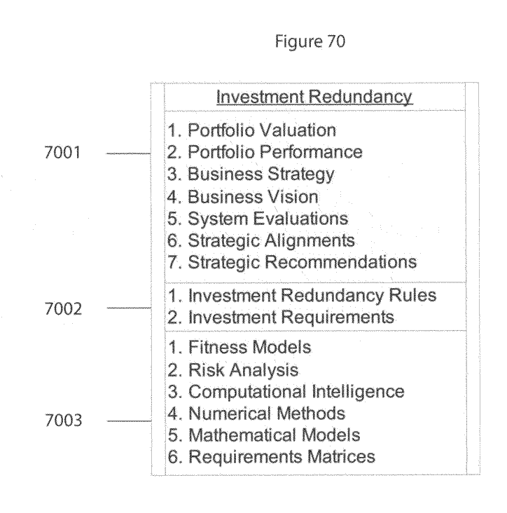

FIG. 70 shows the Investment Redundancy Process. Investment Redundancy reviews requirements, purpose, and functionality of the investments to identify projects, programs, processes, services, products, vendors, or contracts that may be redundant. The Investment Redundancy Process has the following inputs: Portfolio Valuation, Portfolio Performance, Business Strategy, Business Vision, System Evaluations, Strategic Alignments, and Strategic Recommendations (7001). It also has the following outputs: Investment Redundancy Rules and Investment Requirements (7002). The tools and techniques associated with this process are Fitness Models, Risk Analysis, Computational Intelligence, Numerical Methods, Mathematical Methods, and Requirements Matrices (7003).

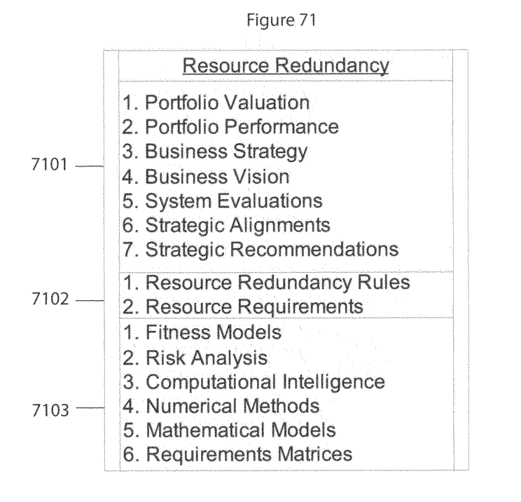

FIG. 71 shows the Resource Redundancy Process. Resource Redundancy reviews requirements, purpose, and functionality of resources to identify personnel, equipment, infrastructure, facilities, or licenses that may be redundant. The Resource Redundancy Process has the following inputs: Portfolio Valuation, Portfolio Performance, Business Strategy, Business Vision, System Evaluations, Strategic Alignments, and Strategic Recommendations (7101). It also has the following outputs: Resource Redundancy Rules and Resource Requirements (7102). The tools and techniques associated with this process are Fitness Models, Risk Analysis, Computational Intelligence, Numerical Methods, Mathematical Methods, and Requirements Matrices (7103).

ii) Investment and Resource Gap

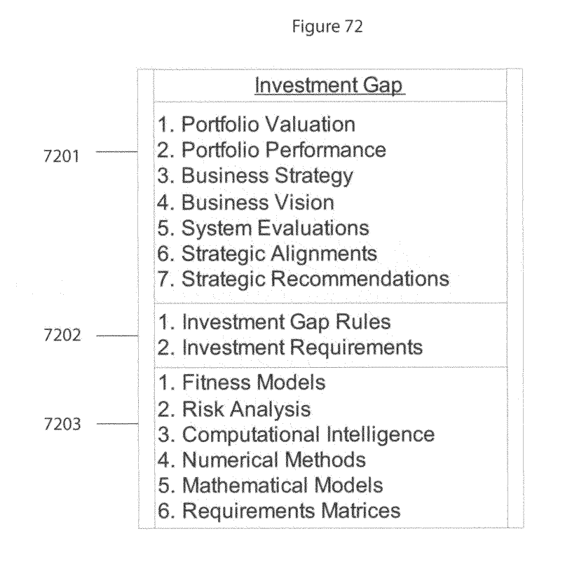

FIG. 72 shows the Investment Gap Process. Investment Gap reviews requirements, purpose, and functionality of the investments to identify projects, programs, processes, services, products, vendors, or contracts that may have gaps. The Investment Gap Process has the following inputs: Portfolio Valuation, Portfolio Performance, Business Strategy, Business Vision, System Evaluations, Strategic Alignments, and Strategic Recommendations (7201). It also has the following outputs: Investment Gap Rules and Investment Requirements (7202). The tools and techniques associated with this process are Fitness Models, Risk Analysis, Computational Intelligence, Numerical Methods, Mathematical Methods, and Requirements Matrices (7203).

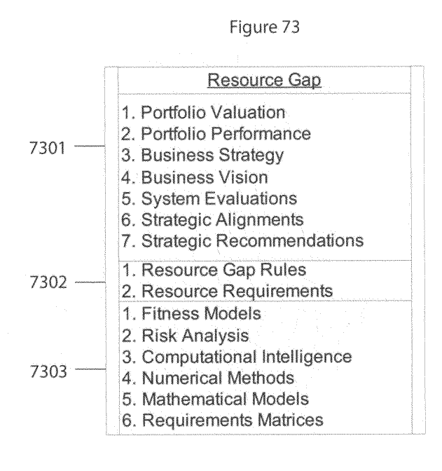

FIG. 73 shows the Resource Gap Model. Resource Gap reviews requirements, purpose, and functionality of resources to identify personnel, equipment, infrastructure, facilities, or licenses that may have gaps. The Resource Gap Model has the following inputs: Portfolio Valuation, Portfolio Performance, Business Strategy, Business Vision, System Evaluations, Strategic Alignments, and Strategic Recommendations (7301). It also has the following outputs: Resource Gap Rules and Resource Requirements (7302). The tools and techniques associated with this process are Fitness Models, Risk Analysis, Computational Intelligence, Numerical Methods, Mathematical Methods, and Requirements Matrices (7303).

C) Merger v Division

The Merger and Division processes examine the portfolio investments and identify opportunities to realize savings through economies of scale. These processes are especially important during a company merger where different portfolios are combined together.

i) Investment and Resource Merger

Investment Mergers may achieve economies of scale by combining multiple investments into a single unit. This can reduce overhead costs by eliminating underused elements. For example, merging two similar projects may eliminate the need for one of the project managers, or some of the project staff. Alternatively, merging the projects may require less equipment resources.

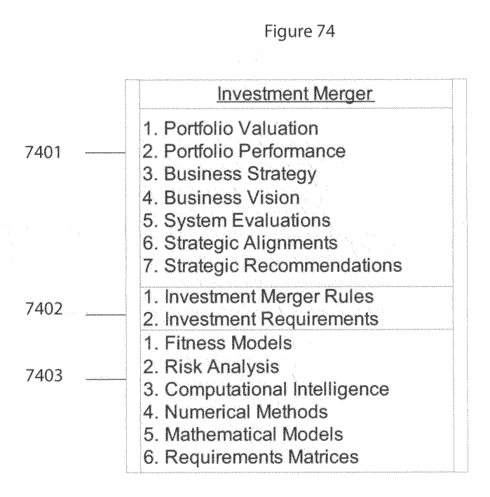

FIG. 74 shows the Investment Merger Process. Investment Merger reviews requirements, purpose, and functionality of the investments to identify projects, programs, processes, services, products, vendors, or contracts that may be merged. The Investment Merger Process has the following inputs: Portfolio Valuation, Portfolio Performance, Business Strategy, Business Vision, System Evaluations, Strategic Alignments, and Strategic Recommendations (7401). It also has the following outputs: Investment Merger Rules and Investment Requirements (7402). The tools and techniques associated with this process are Fitness Models, Risk Analysis, Computational Intelligence, Numerical Methods, Mathematical Methods, and Requirements Matrices (7403).

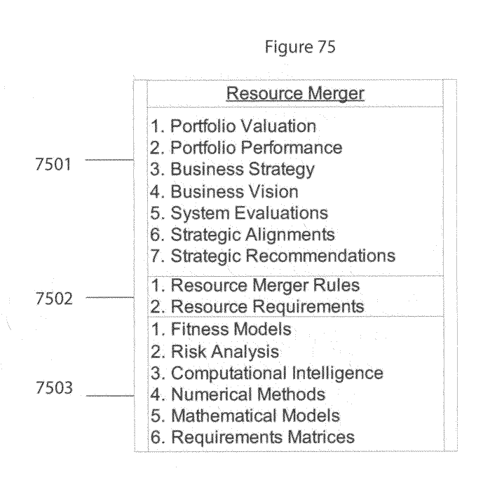

FIG. 75 shows the Resource Merger Process. Resource Merger reviews requirements, purpose, and functionality of resources to identify personnel, equipment, infrastructure, facilities, or licenses that may be placed together on an investment. The Resource Merger Process has the following inputs: Portfolio Valuation, Portfolio Performance, Business Strategy, Business Vision, System Evaluations, Strategic Alignments, and Strategic Recommendations (7501). It also has the following outputs: Resource Merger Rules and Resource Requirements (7502). The tools and techniques associated with this process are Fitness Models, Risk Analysis, Computational Intelligence, Numerical Methods, Mathematical Methods, and Requirements Matrices (7503).

ii) Investment and Resource Division

Division is useful when there are diseconomies of scale. In some situations there may be a savings achieved by dividing a larger unit into smaller units. For example, the number of communication lines in a project with n people is

$$\frac{n ( n + 1 )}{2} .$$

By dividing this into two projects, each of the new projects has fewer communication lines. This may increase the overall efficiency of the effort, especially when the project is made up of distinct, independent components.

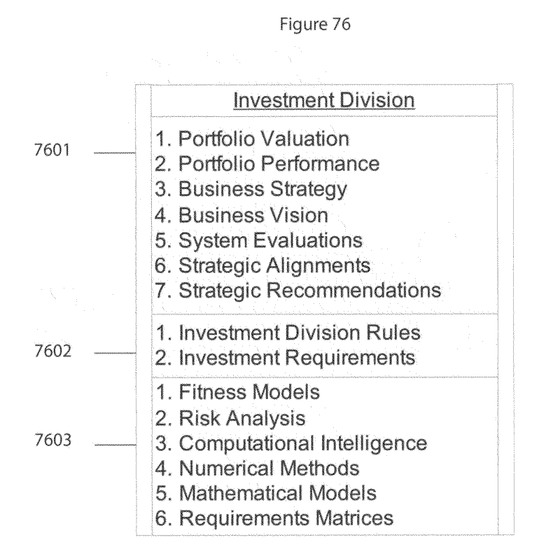

FIG. 76 shows the Investment Division Process. Investment Division reviews requirements, purpose, and functionality of the investments to identify projects, programs, processes, services, products, vendors, or contracts that may be divided over multiple investments. The Investment Division Process has the following inputs: Portfolio Valuation, Portfolio Performance, Business Strategy, Business Vision, System Evaluations, Strategic Alignments, and Strategic Recommendations (7601). It also has the following outputs: Investment Division Rules and Investment Requirements (7602). The tools and techniques associated with this process are Fitness Models, Risk Analysis, Computational Intelligence, Numerical Methods, Mathematical Methods, and Requirements Matrices (7603).

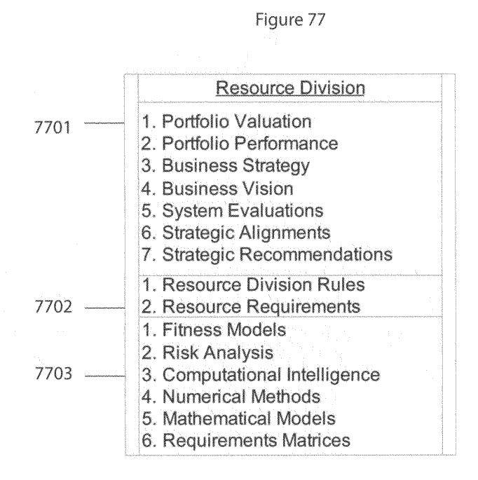

FIG. 77 shows the Resource Division Process. Resource Division reviews requirements, purpose, and functionality of resources to identify personnel, equipment, infrastructure, facilities, or licenses that may be used on multiple investments. The Resource Division Process has the following inputs: Portfolio Valuation, Portfolio Performance, Business Strategy, Business Vision, System Evaluations, Strategic Alignments, and Strategic Recommendations (7701). It also has the following outputs: Resource Division Rules and Resource Requirements (7702). The tools and techniques associated with this process are Fitness Models, Risk Analysis, Computational Intelligence, Numerical Methods, Mathematical Methods, and Requirements Matrices (7703).

Rationalization Model Processes

The Rationalization Model accumulates the information gathered on Redundancy, Gap, Obsolescence, Reuse, Merger, and Division and analyzes it further to formulate a model that is used to make rationalization decisions. The requirements, purpose, and functionality of the investments are analyzed along with IT architecture, investment performance, and capability. These inputs drive the formulation of the Rationalization Model.

Each of the processes in the Rationalization Model examines different aspects of the investments and proposes rules that may be used to identify rationalization targets. These proposed rules are inputs to the Rationalization Model Definition.

A) Requirements Analysis

Requirements Analysis examines the investment requirements, purpose and functionality. This information is gathered in the Redundancy, Gap, Obsolescence, Reuse, Merger, and Division processes leading up to the Rationalization Model.

Requirements Analysis reviews and compiles the requirements, purpose and functionality of the investments in the portfolio. This information is gathered during the Redundancy, Gap, Obsolescence, Reuse, Merger, and Division processes. The Requirements Analysis process analyzes all of this information together in context to identify potential rules that may be incorporated into the Rationalization Model.

The Rationalization Manager determines the appropriate level of detail used in Requirements Analysis. Too much detail and the rationalization process may become mired in a sea of requirements without hope of understanding the overall picture. Too little detail and the model will not be able to identify rationalization targets because not enough information is present to make informed decisions. Part of the art of portfolio rationalization lies in the ability of the Rationalization Manager to choose the right amount of information to examine.

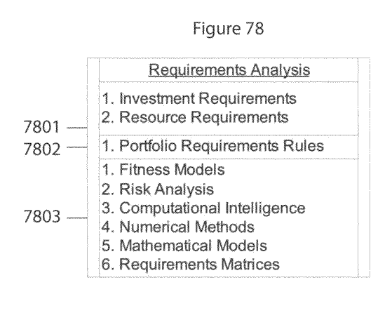

FIG. 78 shows the Requirements Analysis Process. Requirements Analysis reviews and compiles the requirements, purpose, and functionality of the portfolio investments. The Requirements Analysis Process has the following inputs: Investment Requirements and Resource Requirements (7801). It also has the following output: Portfolio Requirements Rules (7802). The tools and techniques associated with this process are Fitness Models, Risk Analysis, Computational Intelligence, Numerical Methods, Mathematical Methods, and Requirements Matrices (7803).

B) Architecture Analysis

IT projects are particularly concerned with the software, database, deployment, and network architectures. Portfolios containing IT investments will want to examine these architecture concerns separately. These architecture concerns influence rationalization decisions and should be reflected in the model.

Architecture Analysis is particular to IT portfolios. Architecture reviews to the structure and design of software, databases, networks, and deployment. IT architectures typically are designed to adhere to some set of design principles that are specific to the situation at hand. Because of these concerns, the system architectures may be examined for rationalization impacts.

Architecture impacts to rationalization come in two flavors. First, the architectures themselves may be targets for rationalization. In these cases the architectures are analyzed in the six surrounding processes. Second, rationalizing these architectures may have some unintended and undesirable consequences. In both cases, IT architectures should be handled carefully in the rationalization process.

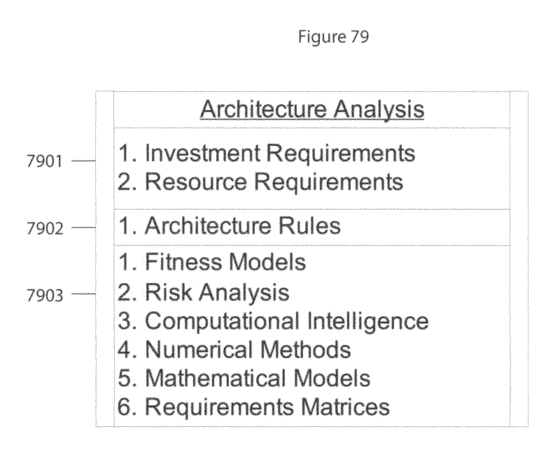

FIG. 79 shows the Architecture Analysis Process. Specific to IT portfolios, the Architecture Analysis process reviews the structure and design of software, databases, networks, and deployment in IT systems. The Architecture Analysis Process has the following inputs: Investment Requirements and Resource Requirements (7901). It also has the following output: Architecture Rules (7902). The tools and techniques associated with this process are Fitness Models, Risk Analysis, Computational Intelligence, Numerical Methods, Mathematical Methods, and Requirements Matrices (7903).

C) Performance Analysis

Performance Analysis examines the performance of the investments as they relate to the overall portfolio. The Rationalization Model may use these performance measures in determining rationalization decisions.

Performance Analysis examines the contribution of each investment to the overall performance of the portfolio. It may be desirable to formulate rules for the Rationalization Model to rationalize underperforming investments. However, some investments have variable performance by nature. This year's underperformer may be next year's superstar. Overall, performance may be a factor in the rationalization decision. If so, rationalization rules are proposed in this process that may be later incorporated into the Rationalization Model.

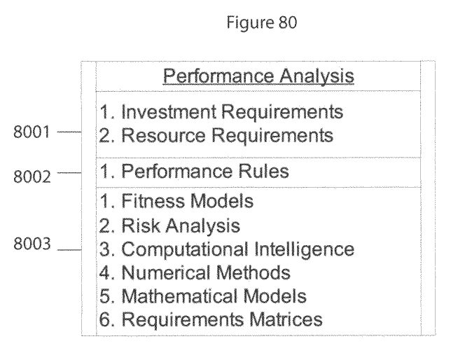

FIG. 80 shows the Performance Analysis Process. Performance Analysis examines the contribution of each investment to the overall performance of the portfolio. The Performance Analysis Process has the following inputs: Investment Requirements and Resource Requirements (8001). It also has the following output: Performance Rules (8002). The tools and techniques associated with this process are Fitness Models, Risk Analysis, Computational Intelligence, Numerical Methods, Mathematical Methods, and Requirements Matrices (8003).

D) Compliance Analysis

Compliance is another contributor to the Rationalization Model. Compliance Analysis develops potential rules to identify rationalization targets based on compliance criteria. This process is performed in a similar fashion to the previous processes but with a focus on compliance issues.

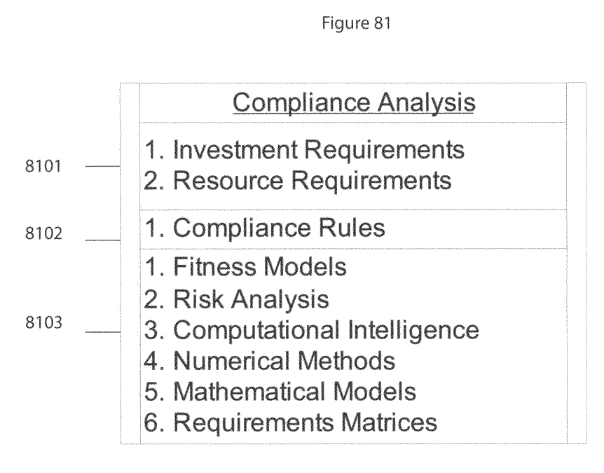

FIG. 81 shows the Compliance Analysis Process. Compliance Analysis develops potential rules to identify rationalization targets based on compliance criteria. The Compliance Analysis Process has the following inputs: Investment Requirements and Resource Requirements (8001). It also has the following output: Compliance Rules (8002). The tools and techniques associated with this process are Fitness Models, Risk Analysis, Computational Intelligence, Numerical Methods, Mathematical Methods, and Requirements Matrices (8003).

E) Capability Analysis

Capability Analysis examines the individual capabilities brought by each of the investments. The Rationalization Model may use this information to formulate decisions on which investments to rationalize and which to leave intact.

Investment capability is another factor that may be incorporated into the Rationalization Model. Capability Analysis examines the various capabilities brought by the investments to the portfolio. Similar to the previous processes, rules may be proposed to identify rationalization targets based on their capabilities. Capability Analysis is particularly concerned with gaps and redundancies. Redundant capabilities may provide rationalization targets. However, gaps may indicate areas where additional capabilities may be useful. This process can identify areas of expansion of the business as opportunities to provide products and services previously overlooked.

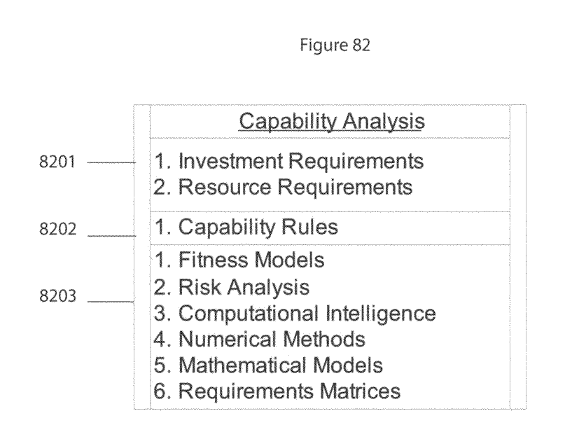

FIG. 82 shows the Capability Analysis Process. Capability Analysis examines the capabilities of the portfolio investments and identifies potential rules to identify rationalization targets based on investment capabilities. The Capability Analysis Process has the following inputs: Investment Requirements and Resource Requirements (8201). It also has the following output: Capability Rules (8202). The tools and techniques associated with this process are Fitness Models, Risk Analysis, Computational Intelligence, Numerical Methods, Mathematical Methods, and Requirements Matrices (8203).

F) Rationalization Model Definition

Finally, the Rationalization Model Definition process formalizes the Rationalization Model. This process examines all of the information brought to bear and creates a decision process that is used to determine which investments should be rationalized and which should be left. The Rationalization Model is this decision process. This may be as simple as a set of cutoff criteria where assets falling on one side of the cutoff are rationalized, or the process may be more complicated involving intelligent software systems and mathematical analysis.

Rationalization Model Definition formalizes the rules used to identify rationalization targets. These rules form a decision process which is the Rationalization Model. The other processes in Rationalization Model Analysis propose rules addressing a particular aspect of interest. Rationalization Model Definition examines each of these rules and may accept, reject, or combine rules. Furthermore, this process may formulate entirely new rules to accommodate situations that were not anticipated from examining individual investment aspects.

Each process in the Rationalization Model analyzes a different investment aspect and formulates decision rules that may be incorporated into the Rationalization Model. These processes identify key measures, examine the investments, and formulate potential rules. The Rationalization Model Definition combines these results to create the overall rationalization rule set which is the Rationalization Model.

The Rationalization Model is the key model of the Portfolio Rationalization Process. It is this model that identifies specific investments as targets for rationalization. These rationalization targets are the output of the Rationalization Selection process and are put into the Transformation Plan.

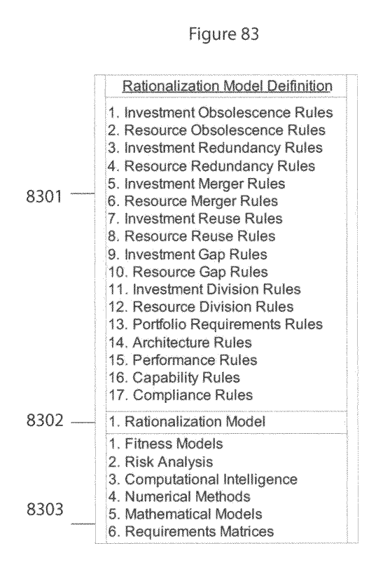

FIG. 83 shows the Rationalization Model Definition Process. The Rationalization Model Definition formalizes the rules from Requirements Analysis, Architecture Analysis, Performance Analysis, Compliance Analysis, and Capability Analysis to create a comprehensive rule set that is used to identify rationalization targets. The Rationalization Model Definition Process has the following inputs: Investment Obsolescence Rules, Resource Obsolescence Rules, Investment Redundancy Rules, Resource Redundancy Rules, Investment Merger Rules, Resource Merger Rules, Investment Reuse Rules, Resource Reuse Rules, Investment Gap Rules, Resource Gap Rules, Investment Division Rules, Resource Division Rules, Portfolio Requirements Rules, Architecture Rules, Performance Rules, Capability Rules, and Compliance Rules (8301). It also has the following output: Rationalization Model (8302). The tools and techniques associated with this process are Fitness Models, Risk Analysis, Computational Intelligence, Numerical Methods, Mathematical Methods, and Requirements Matrices (8303).

Portfolio Rationalization Process

The Portfolio Rationalization Process first begins by Evaluating Strategy & Value in order to obtain the Business Strategy and Vision. This information is used to Identify Statutes and Regulations applicable to the portfolio under consideration. The Business Strategy, Vision, and the Statutes and Regulations are used to assess organizational needs for rationalization. Based on this, a business case for implementing a Portfolio Rationalization Process is created. First Asset Information for the Portfolio Snapshot needs to be gathered and System Requirements obtained during the process execution. The Portfolio Rationalization Process can reach back to this initial setup process to get this information when needed. Finally, some embodiments include an external Monitor & Control process that observes the Portfolio Rationalization Process and updates the process. One or more of the following steps may be utilized in the Portfolio Rationalization Process

1) Identify Strategy & Vision

Identify Strategy & Vision identifies the Business Strategy and Business Vision documentation. Organizations typically have these documents prepared, but often the Business Vision is a part of the Business Strategy document. If these documents are not prepared, then a preliminary document may be created. The Vision and Strategy provide the organizational direction and the Portfolio Performance is measured according to this strategy.

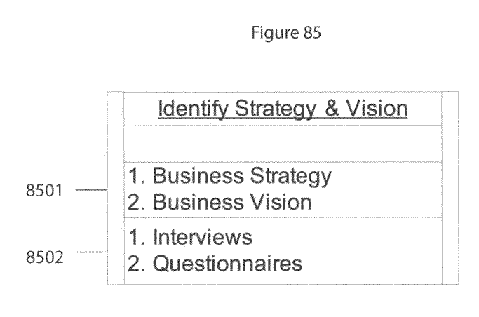

FIG. 85 shows the Identify Strategy and Vision Setup. Evaluate Strategy & Vision identifies the Business Strategy and Business Vision documentation. The Identify Strategy and Vision Setup has the following inputs: Business Strategy and Business Vision (8501). The tools and techniques associated with this process are Interviews and Questionnaires (8502).

2) Identify Statutes and Regulations

Identify Statutes and Regulations determines how the portfolio is affected by Federal, State, and Local laws. Many portfolios are not affected by laws in any way. In these cases, this process may be skipped. There are some portfolios which are heavily influenced by laws and regulations. In these cases, this process is used to better understand these laws and determine what affect the laws may have on the portfolio investments. This process aims to interpret these laws and provide insight to the goals of the portfolio. This step may include attorneys or a Legal Opinion prepared by an attorney, stating how the statutes and regulations are interpreted by the courts and what the organization needs to do in order to comply. The Legal Opinion may provide guidance on what needs to be done with the portfolio investments to attain or maintain regulatory and statutory compliance.

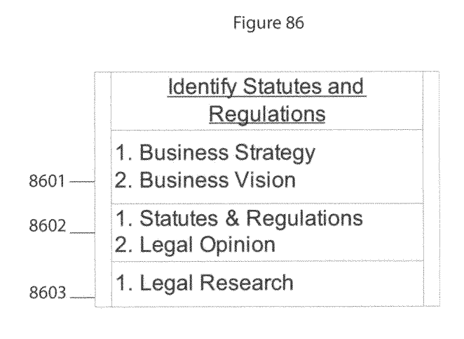

FIG. 86 shows the Identify Statutes and Regulations Setup. Identify Statutes and Regulations determines how the portfolio is affected by Federal, State, and Local laws. The Identify Statutes and Regulations Setup has the following inputs: Business Strategy and Business Vision (8601). It also has the following outputs: Statutes and Regulations and Legal Opinion (8602). The tool and technique associated with this process is Legal Research (8603).

3) Assess Organizational Needs

This process uses the Business Strategy, Business Vision, Statutes & Regulations, and Legal Opinions to create a business case for implementing Portfolio Rationalization. This is a go/no-go phase gate in the Portfolio Rationalization Setup process.

The Business Case may examine the needs of the organization in light of the current investments to determine if Portfolio Rationalization adds value. Small portfolios and/or small organizations may not be able to receive a net benefit from the Portfolio Rationalization Process. It may be the case that the cost of implementing the rationalization process actually exceeds the potential value.

The Business Case may also identify an overall purpose for the portfolio and a potential set of investments under consideration. These investments are candidates for the portfolio but are not necessarily part of the portfolio. Final decision on the portfolio investments occurs later in the Identify Portfolio Investments process.

The Business Case may examine these factors and make recommendations for proceeding or not proceeding with the implementation of a Portfolio Rationalization Process. In either case, the results may be documented and sent to Executive leadership for consideration and review.

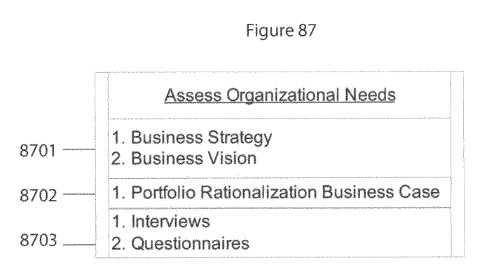

FIG. 87 shows the Assess Organizational Needs Setup. Organizational Needs uses the Business Strategy, Business Vision, Statutes & Regulations, and Legal Opinions to create a business case for implementing Portfolio Rationalization. The Assess Organizational Needs Setup has the following inputs: Business Strategy and Business Vision (8701). It also has the following output: Portfolio Rationalization Business Case (8702). The tools and techniques associated with this process are Interviews and Questionnaires (8703).

4) Program Approval

Executive leaders may then review the Business Case presented and decide if there is sufficient justification to proceed with the implementation of a Portfolio Rationalization Process. Formal approval comes in the form of a Program Charter.

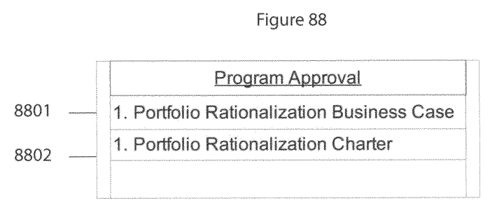

FIG. 88 shows the Program Approval Setup. Program Approval identifies the formal approval of the implementation of Portfolio Rationalization. The Program Approval Setup has the following input: Portfolio Rationalization Business Case (8801). It also has the following output: Portfolio Rationalization Charter (8802).

5) Identify Portfolio Investments

Once Portfolio Rationalization is formally approved, a more detailed investigation of candidates for investments for the portfolio can begin. As there may be a wide range of investments, it is usually better to first obtain permission to move forward with the Portfolio Rationalization Process before starting a detailed investigation of investments for the portfolio.

The appropriate investments for the portfolio are chosen while accounting for the Business Strategy, Business Vision, Statutes & Regulations, Legal Opinions, and recommendations from the Executives approving the Program Charter. The investments do not need to have a single coherent purpose. Investments may be grouped together simply for convenience. However, portfolios with a unified purpose are preferred.

The final selection of investments for the portfolio may be reviewed and approved by Executive leadership. This will help to reduce conflicts between Portfolio Managers and will help to assure that investments are not analyzed through multiple Portfolio Rationalization Processes.

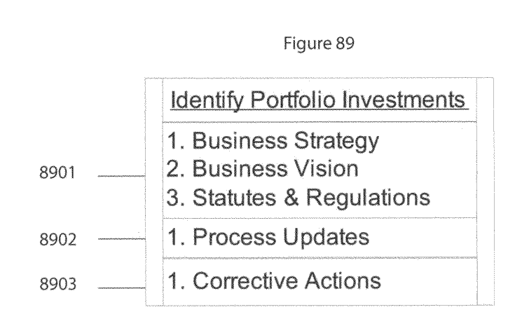

FIG. 89 shows the Identify Portfolio Investments Setup. Identify Portfolio Investments specifies the particular investments for a portfolio. The Identify Portfolio Investments Setup has the following inputs: Business Strategy, Business Vision, Statutes and Regulations, and Performance Expectations (8901). It also has the following outputs: Process Updates (8902). The tool and technique associated with this process is Corrective Actions (8903).

6) Formulate Performance Expectations

Performance Expectations for the portfolio are an input to the Portfolio Rationalization Process. Some portfolios may be able to have these expectations specified before picked the investments. Portfolios for regulatory compliance may be able to set expectations without considering the underlying investments.

In other cases the portfolio investments must be identified before specifying the Performance Expectations. Performance Expectations may be set as a relative improvement in total performance of the group of investments. In these cases the expectations for the future are set based on the investments present performance.

In any case, the output of this process is some set of Performance Expectations for the portfolio. The rationalization process will evaluate the performance of the portfolio against these expectations and identify opportunities for improvements based on the information specified in this process.

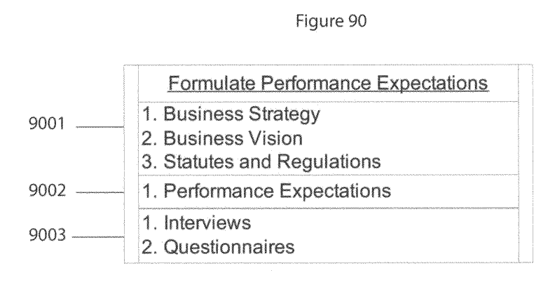

FIG. 90 shows the Formulate Performance Expectations Setup. Formulate Performance Expectations determines and documents the performance expectations for the portfolio. The Formulate Performance Expectations Setup has the following inputs:

Business Strategy, Business Vision, and Statutes and Regulations (9001). It also has the following output: Performance Expectations (9002). The tools and techniques associated with this process are Interviews and Questionnaires (9003).

7) Asset Information Procedure

The Asset Information Procedure process specifies how Asset Information and System Requirements are identified. Asset Information is essential for the Portfolio Snapshot, and System Requirements are a critical input to the Rationalization Model.

Here the sources of data (people, documents, databases, data warehouses, etc.), are examined to determine the best process for gathering the necessary information. The recommended process may differ depending on what information is needed and when its needed.

The Asset Information Procedure document specifies how to plan to gather the information needed for the Portfolio Rationalization Process. This document includes a list of stakeholders, communications requirements, available data, the preferred methods of obtaining the data, alternative methods of obtaining data, and any other factors that may be considered when requesting data for an investment.

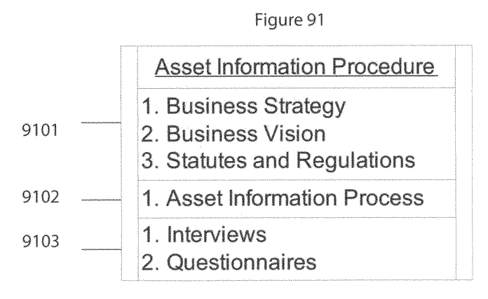

FIG. 91 shows the Asset Information Procedure Setup. The Asset Information Procedure process specifies how Asset Information and System Requirements are identified. The Asset Information Procedure Setup has the following inputs: Business Strategy, Business Vision, and Statutes and Regulations (9101). It also has the following output: Portfolio Rationalization Process (9102). The tools and techniques associated with this process are Interviews and Questionnaires (9103).

8) Tailor the Process Procedure

Tailor the Process identifies the processes and techniques that are implemented in the Portfolio Rationalization Process. This process examines the Business Strategy, Business Vision, Statutes and Regulations, Legal Opinions, Performance Expectations, and Asset Information Procedures to determine which processes are good candidates for inclusion and which should be left out for the moment.

An initial Portfolio Rationalization Process may be as simple as possible while achieving the organizational objectives. This provides an opportunity for the users and Executives to evaluate the process and see the benefits that the process provides.

Overly complex processes may be detrimental in the early implementation of Portfolio Rationalization. Users may see the processes as difficult to understand and interrupting the way they do their jobs. Executives may see complex processes as costly and not returning value in proportion to the cost of maintaining the processes.

For these reasons it is recommended that initial Portfolio Rationalization implementations use only a few processes that immediately add value rather than attempting to apply a full-blown Portfolio Rationalization. In addition, initial implementations may focus on producing immediate and identifiable returns to the organization as opposed to spending significant time and effort on creating a fully automated rationalization process.

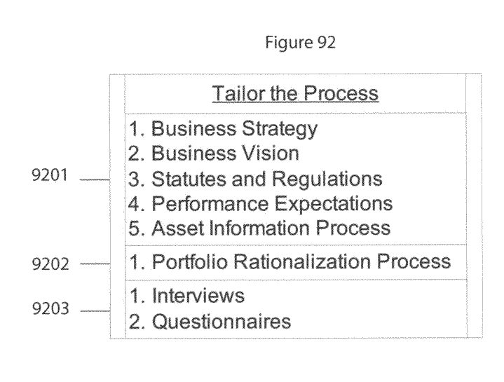

FIG. 92 shows the Tailor the Process Setup. Tailor the Process identifies the processes and techniques that are implemented in the Portfolio Rationalization process. The Tailor the Process Setup has the following inputs: Business Strategy, Business Vision, Statutes and Regulations, Performance Expectations, and Asset Information Procedure (9201). It also has the following output: Portfolio Rationalization Process (9202). The tools and techniques associated with this process are Interviews and Questionnaires (9203).

9) Gather Asset Information

The Gather Asset Information process implements all or part of the Asset Information Procedure to obtain a specific set of data. This is required for the Portfolio Snapshot and during the formulation of the Rationalization Model.

The process of gathering the data is executed according to the process specified in the Asset Information Procedure. This document details the various information available, stakeholder contact information, and how to obtain updates. This process is loosely coupled to the Portfolio Rationalization Process even though it is external to the rationalization process. The rationalization process may need to regularly call back to this process for new information, updates, or additional detail.

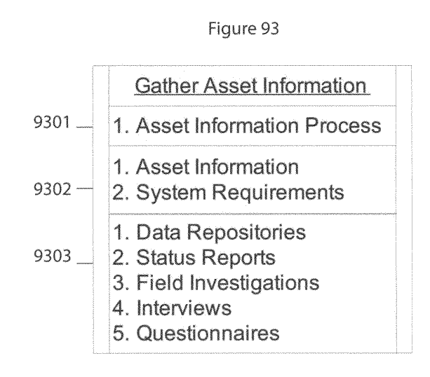

FIG. 93 shows the Gather Asset Information Setup. Gather Asset Information implements all or part of the Asset Information Procedure to obtain a specific set of data. The Gather Asset Information Setup has the following inputs: Asset Information Procedure (9301). It also has the following outputs: Asset Information and System Requirements (9302). The tools and techniques associated with this process are Data Repositories, Status Reports, Field Investigations, Interviews, and Questionnaires (9303).

10) Monitor & Control

Monitor & Control functions as quality assurance and quality control for the Portfolio Rationalization Process. Any of the Portfolio Rationalization Processes or models can be subject to review by a monitor/control process.

There are two main goals for Monitor and Control: 1) Assure the process is running to specifications and 2) Identify opportunities to enhance the process. The first goal may be achieved via standard quality assurance and quality control procedures. The second goal requires the evaluation of the process by the Rationalization Manager to identify opportunities for process improvement, automation, or tuning.

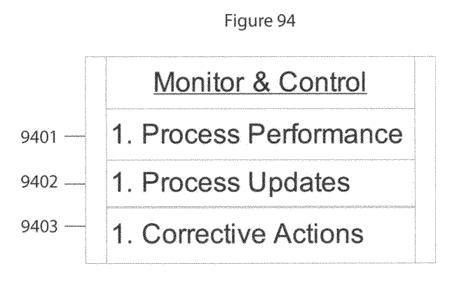

FIG. 94 shows the Monitor and Control Setup. Monitor & Control functions as process improvement, quality control, and quality assurance for the Portfolio Rationalization process. The Monitor and Control Setup has the following input: Process Performance (9401). It also has the following output: Process Updates (9402). The tool and technique associated with this process is Corrective Actions (9403).

Rationalization Maturity Model

Organizations desiring to improve their portfolio rationalization capabilities may use the list below to determine how efficient portfolio rationalization is in their environment. This list of levels moves from a state with no portfolio rationalization at all, through a manual rationalization process, to a semi-automated process, and finally to a fully-integrated process.

Level 0—No Portfolio Rationalization Process.

Level 1—At this level the basic foundation of a Portfolio Rationalization Process is achieved. Portfolio Rationalization is accomplished via manual operations. Executives, directors, and Portfolio Managers typically perform rationalization operations without a formalized process.

The achievements at this level are:

Portfolio Investments Defined—The portfolio is defined in terms of a specific set of investments. Typically, an investment belongs to a single portfolio. Otherwise, different Portfolio Managers may choose to treat the same investment in different ways, leading to conflict between the managers and an unclear direction for the investment.

Portfolio Manager Identified—A Portfolio Manager is identified to manage the portfolio. Instead of a single individual, a committee may be identified to manage the portfolio. In either case, management authority should be clearly laid out and communicated to all stakeholders.

Rationalization Process Defined—A specific Portfolio Rationalization Process should be defined and documented. A well documented process should specify the steps of the rationalization process, what is to be accomplished in each step, who is responsible, who is accountable, who will be consulted, and who is informed.

Data Collection Process Defined—Portfolio Rationalization depends on accurate data for the Portfolio Snapshot. The Portfolio Snapshot is the foundation for the rest of the Portfolio Rationalization Processes. Because the snapshot data is essential to the Portfolio Rationalization Process, it is important to clearly define the data collection process.

Identify Investment Owners—The Portfolio Manager must work with the Investment Owners in order to gather accurate investment information, determine requirements, and identify opportunities for rationalization. It is important to document who the Investment Owners are and who is the primary point of contact for each investment.

Level 2—Portfolio Rationalization is accomplished using automated means. At this stage, some automated processes are in place to assist with the rationalization process.

Portfolio Management System—The Portfolio Management System is used to collect portfolio information in a central data repository. Investment Owners may independently and continuously update this repository, providing continuous data acquisition to the Portfolio Rationalization Process.

Portfolio Analysis Tools—Portfolio Analysis Tools are used to analyze portfolio data to determine the health of the investments. These tools may be used to assist with any of the Portfolio Rationalization Processes. Tools may be generic such as spreadsheet applications or may be specifically developed for Portfolio Rationalization.

Investment Model Defined—An Investment Model should be documented for the portfolio. The documentation should specify the activities of the Investment Model, inputs and outputs that are created, and the tools and techniques used.

Portfolio Model Defined—A Portfolio Model should be documented for the portfolio. The documentation should specify the activities of the Portfolio Model, inputs and outputs that are created, and the tools and techniques used.

Rationalization Model Defined—A Rationalization Model should be documented for the portfolio. The documentation should specify the activities of the Rationalization Model, inputs and outputs that are created, and the tools and techniques used.

Rationalization Process Tailored for the Organization—The rationalization process is tailored to the needs of the organization. The documentation for the tailored process should specify the activities of the Portfolio Rationalization Process, inputs and outputs that are created, and the tools and techniques used.

Level 3—Portfolio Rationalization uses the information collected from automated processes to affect a formal rationalization process. At this stage, the organization has a formalized rationalization process with some automation tools in place to feed information between processes.

Feed-forward Information—One process feeds a subsequent process. This is the norm for process flows as information is inputted, processed, and then outputted to another process.

Feedback Information—One process feeds a previous process. Feedback or recurrent information flows are typical. However, feedback information flows are effective for updating the process as new information becomes available. In many cases, it is important in portfolio rationalization to allow new information from one process to update a prior process.

Ongoing Portfolio Rationalization—Portfolio rationalization should be an ongoing operation, not a year-to-year process. Small, static investment portfolios may not need continuous rationalization. However, many portfolios need continuous monitoring. Without continuous review, rationalization opportunities may be lost and efficiencies unrealized.

Automated Data Collection—Automating the Portfolio Rationalization Process requires an automated data collection system. This may be accomplished as part of the Portfolio Management System, or through other means. Automated data collection provides regular, continuous data acquisition for the Portfolio Rationalization Process.

Automated Investment Model Computation—The Investment Model is automatically recomputed. Here, the Investment Model is specified to the point where it can be programmatically implemented and computed. The Investment Model may be automatically computed as result of an external trigger (new investment data, process adjustments, etc.) or may be regularly scheduled.

Automated Portfolio Model Computation—This is similar to the Investment Model above, but applied to the Portfolio Model. The Portfolio Model is specified to the degree that it can be programmatically implemented and automatically computed.

Automated Rationalization Model Computation—Similar to the Investment and Portfolio Models above, the Rationalization Model is specified to the point where it may be programmatically implemented and computed automatically based on available data.

Automated Prioritization—The Prioritization process may be automatically completed from available information. Automation of this process automatically identifies potential rationalization targets. The prioritized investments are sent to the Rationalization Manager for consideration.

Automated System Selection—The System Selection process is automated. The Selected Systems are automatically identified and presented to the Rationalization Manager. Automation of this process also identifies systems that may be used to identify Organizational Best Practices.

It is important to distinguish the feedback and feed-forward information flows. A mature organization will likely have portfolio rationalization as a continual process while a less mature organization will perform rationalization sequentially on occasion. When an organization is using feedback information, this is an indicator that the organization has reached a level of maturity where portfolio rationalization is treated as an ongoing operation rather than a one-off project.

Automation of the Portfolio Rationalization Process is a significant achievement. As the process becomes more automated, reliable, consistent results are achieved. This allows Executives to play a larger role in the process as the automation of the results provides them the opportunity to specify the operating parameters of the process without needing to regularly monitor the process activities.

Level 4—Portfolio Rationalization uses external information to determine how well past predictions corresponded with actual results. Part of the Portfolio Rationalization Process is to make investment and Portfolio Performance predictions. It is important to see how well these predictions matched with reality.

This helps not only to determine how accurate the predictions were, but also to make better predictions in the future. When we have the opportunity of hindsight to see how our predictions compared with reality, we can make adjustments to future predictions to become more accurate.

Comparison of Results with Predictions—The Portfolio Rationalization Process makes predictions of future performance of investments and the portfolio. These predictions can be later matched up against the actual outcomes. By comparing the predictions with the actual results, we can identify potential problems with the models. Recommendations for improvement are provided to the Rationalization Manager.

Set Model Quality/Performance Goals—Overall performance and/or quality goals are set for the Investment Model, Portfolio Model, and the Rationalization Model. The actual results of the models are measured over time and compared with the performance/quality goals. Recommendations for improvement are made and provided to the Rationalization Manager.

Set Activity Quality/Performance Goals—Performance and/or quality goals are specified for each of the model activities. Actual results of the processes are compared to the goals, and recommendations for improvement are provided to the Rationalization Manager.

Model Adjustment Based on Comparisons—The Investment Model, Portfolio Model, or Rationalization Model is adjusted based on results of comparing prior predictions with actual results.

Level 5—Portfolio Rationalization uses predictive analysis based on actual results to make rationalization recommendations. At this level, the predictions of the portfolio Rationalization Model are not only checked against actual results, but this information is used to modify the Portfolio Rationalization Process itself. New processes may be added and obsolete processes removed. In a sense, the Portfolio Rationalization Process itself undergoes an automatic rationalization.

Measure the Effectiveness of the Rationalization Process—Actual results are used to make predictive analysis on the rationalization process. The predictions and actual results are compared, and the overall effectiveness of the Rationalization Process is evaluated. Recommendations to improve the Rationalization Process are given to the Rationalization Manager.

Set Rationalization Quality Goals—Overall performance and/or quality goals are specified for the Portfolio Rationalization Process. Actual results are measured against the goals, and recommendations for improvement are sent to the Rationalization Manager.

Set Process Quality Goals—Performance and/or quality goals are specified for each Portfolio Rationalization Process. Actual results are measured against the goals and recommendations for improvement and given to the Rationalization Manager.

Modify the Rationalization Process Based on Comparisons—The Portfolio Rationalization Process is modified by the Rationalization Manager based on the results of the comparisons.

Determining the Rationalization Maturity Level for a given organization/portfolio is done by reviewing the above achievements and determining which are currently met. A particular Portfolio Rationalization Process may meet achievements over a number of levels. We may describe an organization as RMM 3, meaning that all level three achievements are met. Alternatively, we may say that a rationalization process is level 3-4 meaning all of three and parts of four are implemented.

The list of levels and achievements provide a basis for comparing the maturity of the rationalization process between organizations or portfolios. With increasing levels of maturity, we have an increasing degree of process automation and increasing ability to adjust the rationalization process.

At the final level, portfolio rationalization achieves a degree of Computational Intelligence by self-adjusting the process according to changing conditions. At this point, the process runs automatically with the Rationalization Manager reviewing the results and making manual adjustments when necessary.

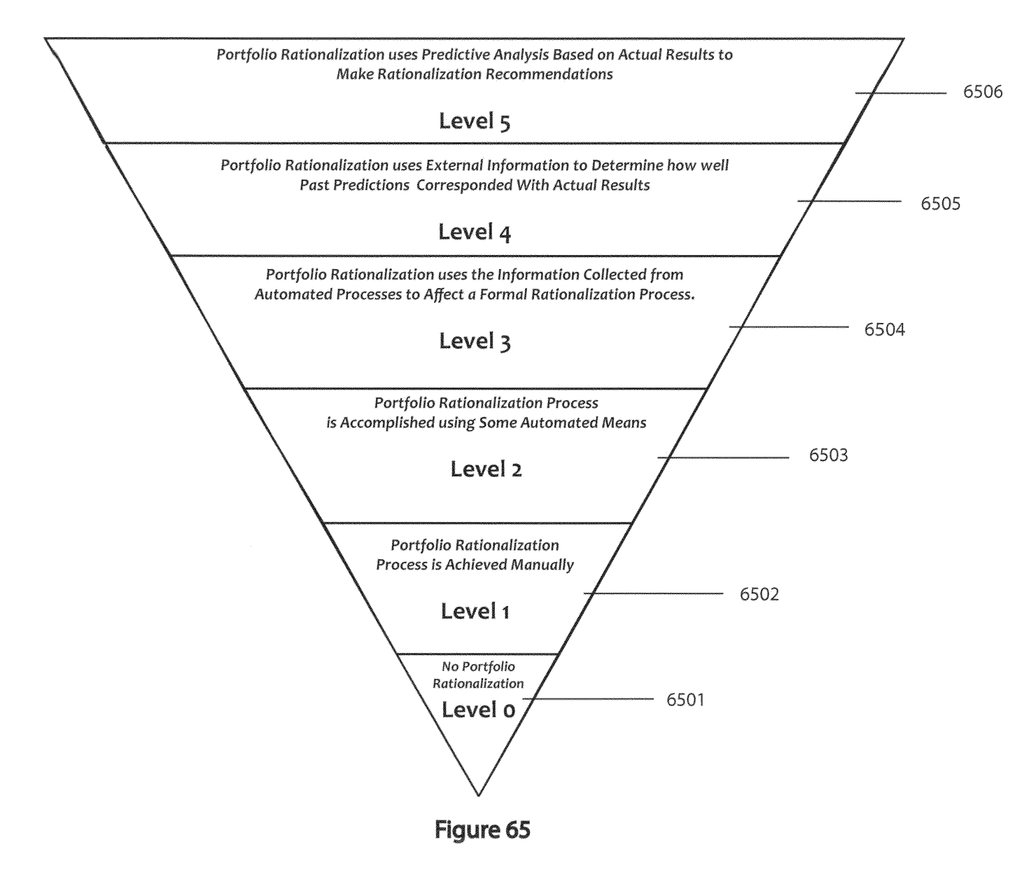

FIG. 65 shows the levels of the Rationalization Maturity Model. The Rationalization Maturity Model is used to measure the maturity of an organizations portfolio rationalization process. There are six levels identified in the Rationalization Maturity Model:

Rationalization Maturity Model Level 0 (6501)—No portfolio Rationalization.

Rationalization Maturity Model Level 1 (6502)—No Portfolio Rationalization accomplished via manual operations.

Rationalization Maturity Model Level 2 (6503)—Portfolio Rationalization is accomplished using some automated mechanisms.

Rationalization Maturity Model Level 3 (6504)—Portfolio Rationalization uses the information collected from automated processes to affect a formal rationalization process.

Rationalization Maturity Model Level 4 (6505)—Portfolio Rationalization uses external information to determine how well predictions correspond to actual results.

Rationalization Maturity Model Level 5 (6506)—Portfolio Rationalization uses predictive analysis based on actual results to make rationalization recommendations.

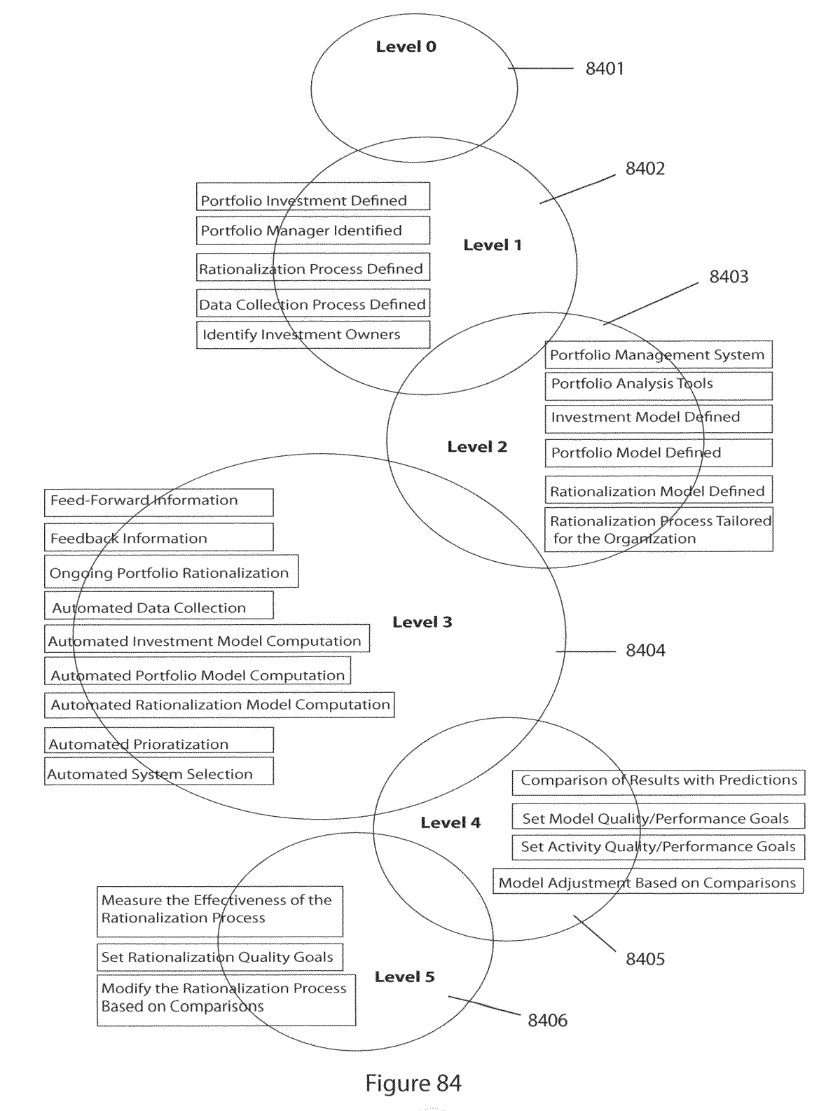

FIG. 84 shows some characteristics of each level of the rationalization maturity model.

Rationalization Maturity Model Level 0 (8401)—No portfolio Rationalization.

Rationalization Maturity Model Level 1 (8402)—Identifies characteristics of RMM1.

Rationalization Maturity Model Level 2 (8403)—Identifies characteristics of RMM2.

Rationalization Maturity Model Level 3 (8404)—Identifies characteristics of RMM3.

Rationalization Maturity Model Level 4 (8405)—Identifies characteristics of RMM4.

Rationalization Maturity Model Level 5 (8406)—Identifies characteristics of RMM5.

Tools and Techniques

For all embodiments above, various tools and techniques are available to assist in the portfolio rationalization process. For instance, evolutionary computing may be used. Evolutionary computing uses an iterative procedure to evolve some system in response to new information. Typically, these systems are used to solve combinatorial optimization problems. These are particularly difficult problems and are usually approached with specialized techniques. Another technique is use of fuzzy systems or artificial neural network. Other techniques include backpropagation, a technique used to create an artificial neural network. Another technique is use of genetic algorithms, which are optimization algorithms modeled on the DNA reproduction/replication. Another technique is genetic programming. Genetic programming is a method of constructing computer based programs that use genetic algorithms to find an optimal program structure. This field includes evolvable hardware solutions, quantum computing, and evolutionary game strategy. Genetic programs are the application of genetic algorithms to programming, but they often have an external source of feedback allowing the program to evolve their behavior in response to external stimuli.

Further, the numerical analysis may include computations to approximate or model a system. The type of analysis is non-limiting, but may include one or more of the following: random number generator, simulations, Monte Carlo analysis, and stochastic analysis.

It should be apparent from the foregoing that an invention having significant advantages has been provided. While the invention is shown in only a few of its forms, it is not just limited but is susceptible to various changes and modifications without departing from the spirit thereof.

We claim:

1. A method of rationalizing a non-financial portfolio which comprises the steps of:
generating a Valuation Model as a result of one or more processes of a Valuation Phase wherein said Valuation Model does not include the market value of the asset, or includes the market value and at least one additional non-financial value;
generating an Investment Model as a result of one or more processes of a Investment Phase;
generating a System Model as a result of one or more processes of a System Phase;
generating a Portfolio Model as a result of one or more processes of a Portfolio Phase;
generating a Rationalization Model as a result of one or more processes of the Portfolio Phase;
wherein said Valuation Model, Investment Model, System Model, Portfolio Model and the Rationalization Model are used to produce a transformation plan report.

2. The method of claim 1, wherein said generating a Valuation Model comprises one or more processes selected from the following process groups:
a. Data Analysis
b. Category Analysis
c. Valuation Model Analysis
d. Valuation Risk Analysis and
e. Mapping Analysis.

3. The method of claim 1, wherein said generating an Investment Model comprises one or more processes selected from the following process groups:
a. Quality Analysis
b. Impact Analysis
c. Capability Analysis
d. Maturity Analysis
e. Investment Model Analysis and
f. Investment Risk Analysis

4. The method of claim 1, wherein said generating a System Model comprises one or more processes selected from the following process groups:
a. System Cost Analysis;
b. System Model Analysis;
c. System Risk Analysis and
d. System Return Analysis.

5. The method of claim 1, wherein said generating a Portfolio Model comprises one or more processes selected from the following process groups:
a. Compliance Analysis;
b. Portfolio Risk Analysis
c. Portfolio Cost Analysis;
d. Portfolio Return Analysis; and
e. Portfolio Model Analysis.

6. The method of claim 1, wherein said generating a Rationalization Model comprises one or more processes selected from the following process groups:
a. Obsolescence Analysis;
b. Redundancy Analysis;
c. Merger Analysis;
d. Reuse Analysis;
e. Gap Analysis;
f. Division Analysis; and
g. Rationalization Model Analysis.
